(19) United States
(12) Patent Application Publication
(10) Pub. No.: US 2021/0307042 A1
(43) Pub. Date: Sep. 30, 2021

(54) METHOD FOR TRANSMITTING/RECEIVING SIGNAL AND CHANNEL IN NARROWBAND WIRELESS COMMUNICATION SYSTEM, AND APPARATUS THEREFOR

(71) Applicant: LG ELECTRONICS INC., Seoul (KR)

(72) Inventors: Seokmin SHIN, Seoul (KR); Jaehyung KIM, Seoul (KR); Seonwook KIM, Seoul (KR); Changhwan PARK, Seoul (KR); Joonkui AHN, Seoul (KR); Suckchel YANG, Seoul (KR); Seunggye HWANG, Seoul (KR)

(73) Assignee: LG ELECTRONICS INC., Seoul (KR)

(21) Appl. No.: 17/257,810

(22) PCT Filed: Jul. 8, 2019
(86) PCT No.: PCT/KR2019/008363

§ 371 Date: Jan. 4, 2021

Related U.S. Application Data
(60) Provisional application No. 62/716,941, filed on Aug. 9, 2018.

(30) Foreign Application Priority Data
Jul. 6, 2018 (KR) 10-2018-0078463
Sep. 21, 2018 (KR) 10-2018-0114452
Feb. 14, 2019 (KR) 10-2019-0017095

(51) Int. Cl. H04W 72/12; H04W 72/04

(52) U.S. Cl. CPC H04W 72/1273; H04W 72/1289; H04W 72/0453

(57) ABSTRACT

The present specification provides a method for transmitting/receiving a signal and a channel in a narrowband wireless communication system, and an apparatus therefor. Specifically, a method for transmitting/receiving a signal and a channel by a terminal in a narrowband wireless communication system that coexists with other wireless communication systems comprises the steps of: receiving a synchronization signal from a base station on the basis of a predetermined channel raster; receiving, from the base station, information on a channel raster offset through a physical broadcast channel (PBCH); and performing transmission and reception of the signal and the channel with the base station in a narrowband in which a center frequency is adjusted by applying the channel raster offset, wherein a specific subcarrier of a plurality of subcarriers included in the narrowband may be punctured or rate-matched.

### TECHNICAL FIELD

The present disclosure relates to a method for transmitting and receiving a signal and a channel in a narrowband wireless communication system and a device therefor.

### BACKGROUND ART

Mobile communication systems have been developed to provide voice services, while ensuring the activity of users. However, coverage of the mobile communication systems has extended up to data services, as well as voice service. Today, an explosive increase in traffic has caused the shortage of resources. Accordingly, an advanced mobile communication system is necessary because users want relatively high speed services.

Requirements for a next-generation mobile communication system include the accommodation of explosive data traffic, a significant increase in the transfer rate per user, the accommodation of the number of considerably increased connection devices, very low end-to-end latency, and high energy efficiency. To this end, research of various technologies, such as dual connectivity, massive multiple input multiple output (MIMO), in-band full duplex, non-orthogonal multiple access (NOMA), super wideband, and device networking, is carried out.

### DISCLOSURE

### Technical Problem

The present disclosure provides a method of transmitting and receiving a signal and a channel in a narrowband wireless communication system.

Specifically, the present disclosure provides a method of transmitting and receiving a signal and/or a channel in consideration of match or mismatch of resource grids (e.g., resource block grids) when a narrowband wireless communication system coexists with other wireless communication systems.

Technical objects to be achieved in the disclosure are not limited to the above-described technical objects, and other technical objects not described above may be evidently understood by a person having ordinary skill in the art to which the disclosure pertains from the following description.

### Technical Solution

In a method for a terminal to transmit and receive a signal and a channel in a narrowband wireless communication system coexisting with other wireless communication systems according to an embodiment of the present disclosure, the method includes receiving a synchronization signal from a base station based on a preset channel raster; receiving information for channel raster offset from the base station through a physical broadcast channel (PBCH); and performing transmission and reception of the signal and the channel to and from the base station in a narrowband in which a center frequency is adjusted by applying the channel raster offset, wherein a specific subcarrier of a plurality of subcarriers included in the narrowband is punctured or rate-matched.

Further, in the method according to the present disclosure, the specific subcarrier may be determined according to a position of a direct current subcarrier (DC subcarrier) of the narrowband.

Further, in the method according to the present disclosure, when the position of the DC subcarrier is mapped to that of a 0th subcarrier of a physical resource block constituting a system bandwidth of the other wireless communication system, the specific subcarrier may be a subcarrier having a last index among the plurality of subcarriers.

Further, in the method according to the present disclosure, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, in the method according to the present disclosure, when the specific subcarrier is punctured, coded bit generation and resource element mapping for the signal and the channel may be performed for all of the plurality of subcarriers.

Further, in the method according to the present disclosure, when the specific subcarrier is rate-matched, coded bit generation and resource element mapping for the signal and the channel may be performed for subcarriers except for the specific subcarrier in the plurality of subcarriers.

Further, in the method according to the present disclosure, the narrowband may be configured with 73 subcarriers including the DC subcarrier.

In a device for transmitting and receiving a signal and a channel in a narrowband wireless communication system coexisting with other wireless communication systems according to an embodiment of the present disclosure, the device includes a radio frequency (RF) module for transmitting and receiving a radio signal; and a processor for controlling the RF module, wherein the processor is configured to control to receive a synchronization signal from a base station based on a preset channel raster; to receive information for channel raster offset from the base station through a physical broadcast channel (PBCH); and to transmit and receive the signal and the channel to and from the base station in a narrowband in which a center frequency is adjusted by applying the channel raster offset, wherein a specific subcarrier of a plurality of subcarriers included in the narrowband is punctured or rate-matched.

Further, in the device according to the present disclosure, the specific subcarrier may be determined according to a position of a direct current subcarrier (DC subcarrier) of the narrowband.

Further, in the device according to the present disclosure, when the position of the DC subcarrier is mapped to that of a 0th subcarrier of a physical resource block constituting a system bandwidth of the other wireless communication system, the specific subcarrier may be a subcarrier having a last index among the plurality of subcarriers.

Further, in the device according to the present disclosure, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, in the device according to the present disclosure, when the specific subcarrier is punctured, coded bit generation and resource element mapping for the signal and the channel may be performed for all of the plurality of subcarriers.

Further, in the device according to the present disclosure, when the specific subcarrier is rate-matched, coded bit generation and resource element mapping for the signal and the channel may be performed for subcarriers except for the specific subcarrier in the plurality of subcarriers.

Further, in the device according to the present disclosure, the narrowband may be configured with 73 subcarriers including the DC subcarrier.

In a device for transmitting and receiving a signal and a channel in a narrowband wireless communication system coexisting with other wireless communication systems according to an embodiment of the present disclosure, the device includes a radio frequency (RF) module for transmitting and receiving a radio signal; and a processor for controlling the RF module, wherein the processor is configured to control to transmit a synchronization signal to the terminal based on a preset channel raster; to transmit information for channel raster offset to the terminal through a physical broadcast channel (PBCH); and to transmit and receive the signal and the channel to and from the terminal in a narrowband in which a center frequency is adjusted by applying the channel raster offset, wherein a specific subcarrier among a plurality of subcarriers included in the narrowband is punctured or rate-matched.

### Advantageous Effects

A method proposed in the present disclosure has an effect of being able to adjust channel raster offset that may occur, even if a narrowband wireless communication system coexists on a system band of another wireless communication system.

Further, the method proposed in the present disclosure has an effect of capable of efficiently using resources and minimizing an influence on transmission and reception of a signal and/or a channel in relation to mismatch of a resource grid that may occur as a narrowband wireless communication system coexists with other wireless communication systems.

Effects which may be obtained in the disclosure are not limited to the above-described effects, and other technical effects not described above may be evidently understood by a person having ordinary skill in the art to which the disclosure pertains from the following description.

### BRIEF DESCRIPTION OF DRAWINGS

The accompanying drawings, which are included to provide a further understanding of the disclosure and constitute a part of the detailed description, illustrate embodiments of the disclosure and together with the description serve to explain the principle of the disclosure.

FIG. 1 illustrates the structure of a radio frame in a wireless communication system to which the disclosure may be applied.

FIG. 2 illustrates a resource grid for one downlink slot in a wireless communication system to which the disclosure may be applied.

FIG. 3 illustrates the structure of a downlink subframe in a wireless communication system to which the disclosure may be applied.

FIG. 4 illustrates the structure of an uplink subframe in a wireless communication system to which the disclosure may be applied.

FIG. 5 illustrates an example of an overall structure of a NR system to which a method proposed in the disclosure may be applied.

FIG. 6 illustrates a relation between an uplink frame and a downlink frame in a wireless communication system to which a method proposed in the disclosure may be applied.

FIG. 7 illustrates an example of a frame structure in a NR system.

FIG. 8 illustrates an example of a resource grid supported in a wireless communication system to which a method proposed in the disclosure may be applied.

FIG. 9 illustrates examples of a resource grid per antenna port and numerology to which a method proposed in the disclosure may be applied.

FIG. 10 illustrates an example of a narrowband operation and frequency diversity.

FIG. 11 is a diagram illustrating physical channels that may be used for MTC and a general signal transmission method using the physical channels.

FIG. 12 illustrates an example of an operation and configuration related to system information of an MTC system.

FIG. 13 is a diagram illustrating an example of scheduling for each of MTC and legacy LTE.

FIGS. 14 and 15 illustrate examples of an NR-IoT frame structure.

FIG. 16 illustrates an example of a resource grid for an NB-IoT uplink.

FIG. 17 is a diagram illustrating an example of physical channels that may be used for NB-IoT and a general signal transmission method using the physical channels.

FIG. 18 illustrates an example of signaling related to transmission and reception of channel raster offset information.

FIG. 19 illustrates an example of a center frequency in an NR system.

FIG. 20 illustrates an example of calculating channel raster offset of an NB-IoT system when an NR system and the NB-IoT system coexist.

FIG. 21 illustrates an example of signaling related to transmission and reception of information on frequency offset applied to an NR system.

FIG. 22 illustrates examples of alignment of subcarrier spacing grids between an LTE NB-IoT system and an NR system.

FIG. 23 illustrates an example of rate-matching in non-total RE levels.

FIG. 24 illustrates an example of calculating channel raster offset of an eMTC system when an NR system and the eMTC system coexist.

FIG. 25 illustrates another example of calculating channel raster offset of an eMTC system when an NR system and the eMTC system coexist.

FIG. 26 illustrates another example of calculating channel raster offset of an eMTC system when an NR system and the eMTC system coexist.

FIG. 27 illustrates an example of a bandwidth and a narrowband for a synchronization signal.

FIG. 28 illustrates an example of a method of configuring regions for a PSS, an SSS, and a PBCH when a plurality of NBs for an eMTC system are configured.

FIG. 29 illustrates an example of an operation flowchart of a terminal for transmitting and receiving a signal and/or a channel in a narrowband wireless communication system coexisting with another wireless communication system to which a method proposed in the present disclosure can be applied.

FIG. 30 illustrates an example of an operation flowchart of a base station for transmitting and receiving a signal and/or a channel in a narrowband wireless communication system coexisting with another wireless communication system to which a method proposed in the present disclosure can be applied.

FIG. 31 is a block diagram of a wireless communication device to which methods proposed in the present disclosure can be applied.

FIG. 32 illustrates another example of a block diagram of a wireless communication device to which methods proposed in the present disclosure can be applied.

FIG. 33 illustrates an AI device 3300 according to an embodiment of the present disclosure.

FIG. 34 illustrates an AI server 3400 according to an embodiment of the present disclosure.

FIG. 35 illustrates an AI system 3500 according to an embodiment of the present disclosure.

### MODE FOR DISCLOSURE

Hereafter, preferred embodiments of the disclosure will be described in detail with reference to the accompanying drawings. A detailed description to be disclosed hereinafter together with the accompanying drawing is to describe embodiments of the disclosure and not to describe a unique embodiment for carrying out the disclosure. The detailed description below includes details in order to provide a complete understanding. However, those skilled in the art know that the disclosure can be carried out without the details.

In some cases, in order to prevent a concept of the disclosure from being ambiguous, known structures and devices may be omitted or may be illustrated in a block diagram format based on core function of each structure and device.

In the disclosure, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the disclosure and the use of the specific terms may be modified into other forms within the scope without departing from the technical spirit of the disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for mobile communications (GSM)/general packet radio service (GPRS)/enhanced data rates for GSM evolution (EDGE). The OFDMA may be implemented as radio technology such as IEEE 802.11(Wi-Fi), IEEE 802.16 (WiMAX), IEEE 802-20, evolved UTRA (E-UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the disclosure may be based on standard documents disclosed in at least one of IEEE 802, 3GPP, and 3GPP2 which are the wireless access systems. That is, steps or parts which are not described to definitely show the technical spirit of the disclosure among the embodiments of the disclosure may be based on the documents. Further, all terms disclosed in the document may be described by the standard document.

3GPP LTE/LTE-A (New RAT) is primarily described for clear description, but technical features of the disclosure are not limited thereto.

General LTE system to which the present disclosure can be applied

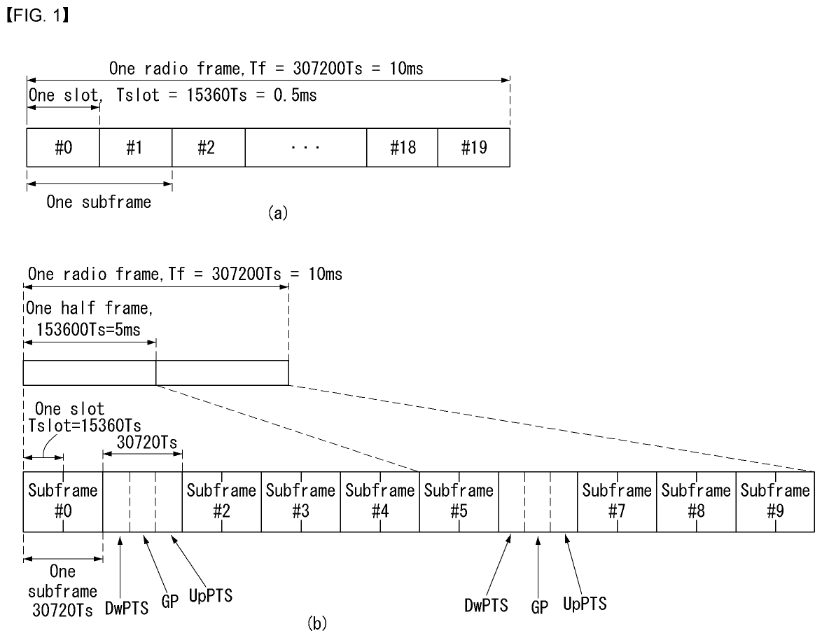

FIG. 1 illustrates the structure of a radio frame in a wireless communication system to which the disclosure may be applied.

3GPP LTE/LTE-A supports radio frame structure type 1 applicable to frequency division duplex (FDD) and radio frame structure Type 2 applicable to time division duplex (TDD).

In FIG. 1, the size of a radio frame in a time domain is represented as a multiple of a time unit of T_s=1/(15000*2048). Downlink and uplink transmissions are organized into radio frames with a duration of T_f=307200*T_s=10 ms.

FIG. 1(a) illustrates radio frame structure type 1. The radio frame structure type 1 may be applied to both full duplex FDD and half duplex FDD.

A radio frame consists of 10 subframes. One radio frame consists of 20 slots of T_slot=15360*T_s=0.5 ms length, and indexes of 0 to 19 are given to the respective slots. One subframe consists of two consecutive slots in the time domain, and subframe i consists of slot 2i and slot 2i+1. A time required to transmit one subframe is referred to as a transmission time interval (TTI). For example, the length of one subframe may be 1 ms, and the length of one slot may be 0.5 ms.

The uplink transmission and the downlink transmission in the FDD are distinguished in the frequency domain. Whereas there is no restriction in the full duplex FDD, a UE cannot transmit and receive simultaneously in the half duplex FDD operation.

One slot includes a plurality of orthogonal frequency division multiplexing (OFDM) symbols in the time domain and includes a plurality of resource blocks (RBs) in a frequency domain. Since 3GPP LTE uses OFDMA in downlink, OFDM symbols are used to represent one symbol period. The OFDM symbol may be called one SC-FDMA symbol or a symbol period. The resource block is a resource allocation unit and includes a plurality of consecutive subcarriers in one slot.

FIG. 1(b) illustrates frame structure type 2.

The radio frame type 2 consists of two half-frames of 153600*T_s=5 ms length each. Each half-frame consists of five subframes of 30720*T_s=1 ms length.

In the frame structure type 2 of a TDD system, uplink-downlink configuration is a rule indicating whether uplink and downlink are allocated (or reserved) to all subframes.

Table 1 represents uplink-downlink configuration.

TABLE 1

| | Downlink- | | | | | | | | | | |
|---|---|---|---|---|---|---|---|---|---|---|---|
| Uplink- | to-Uplink | | | | | | | | | | |
| Downlink | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 1, in each subframe of the radio frame, ‘D’ represents a subframe for downlink transmission, ‘U’ represents a subframe for uplink transmission, and ‘S’ represents a special subframe consisting of three types of fields including a downlink pilot time slot (DwPTS), a guard period (GP), and an uplink pilot time slot (UpPTS). The DwPTS is used for an initial cell search, synchronization or channel estimation in a UE. The UpPTS is used for channel estimation in a base station and uplink transmission synchronization of the UE. The GP is a period for removing interference generated in uplink due to multi-path delay of a downlink signal between uplink and downlink.

Each subframe i consists of slot 2i and slot 2i+1 of T_slot=15360*T_s=0.5 ms length each.

The uplink-downlink configuration may be classified into 7 types, and a location and/or the number of a downlink subframe, a special subframe and an uplink subframe are different for each configuration.

A point of time at which switching from downlink to uplink or switching from uplink to downlink is performed is referred to as a switching point. A switch-point periodicity refers to a period in which switched patterns of an uplink subframe and a downlink subframe are equally repeated, and both 5 ms and 10 ms switch-point periodicity are supported. In case of 5 ms downlink-to-uplink switch-point periodicity, the special subframe S exists in every half-frame. In case of 5 ms downlink-to-uplink switch-point periodicity, the special subframe S exists in a first half-frame only.

In all the configurations, subframes 0 and 5 and a DwPTS are reserved for downlink transmission only. An UpPTS and a subframe immediately following the subframe are always reserved for uplink transmission.

Such uplink-downlink configurations may be known to both the base station and the UE as system information. The base station may inform the UE of change in an uplink-downlink allocation state of a radio frame by transmitting only indexes of uplink-downlink configuration information to the UE each time the uplink-downlink configuration information is changed. Furthermore, configuration information is a kind of downlink control information and may be transmitted via a physical downlink control channel (PDCCH) like other scheduling information, or is a kind of broadcast information and may be commonly transmitted to all UEs within a cell via a broadcast channel.

Table 2 represents configuration (length of DwPTS/GP/UpPTS) of a special subframe.

TABLE 2

| | Normal cyclic | | | Extended cyclic | | |
|---|---|---|---|---|---|---|
| | prefix in downlink | | | prefix in downlink | | |
| | | UpPTS | | | UpPTS | |
| | | Normal | Extended | | Normal | Extended |
| Special | | cyclic | cyclic | | cyclic | cyclic |
| subframe | | prefix | prefix | | prefix | prefix |
| configuration | DwPTS | in uplink | in uplink | DwPTS | in uplink | in uplink |
| 0 | [symbol] | [symbol] | [symbol] | [symbol] | [symbol] | [symbol] |
| 1 | | | | | | |
| 2 | | | | | | |
| 3 | | | | | | |
| 4 | | | | | | |
| 5 | | | | | | |
| 6 | | | | | | |
| 7 | | _ | | — | — | — |
| 8 | | _ | | — | — | — |

[symbol]

indicates data missing or illegible when filed

The structure of a radio frame according to an example of FIG. 1 is merely an example, and the number of subcarriers included in a radio frame, the number of slots included in a subframe, and the number of OFDM symbols included in a slot may be variously changed.

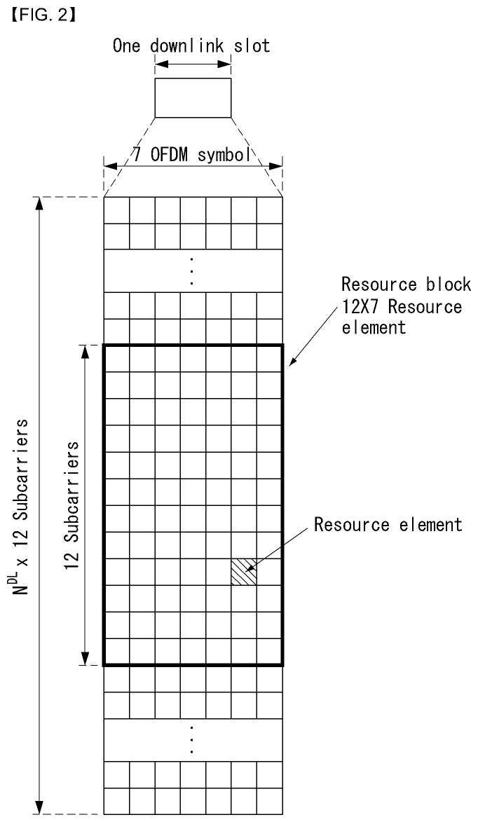

FIG. 2 is a diagram illustrating a resource grid for one downlink slot in the wireless communication system to which the disclosure may be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the disclosure is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

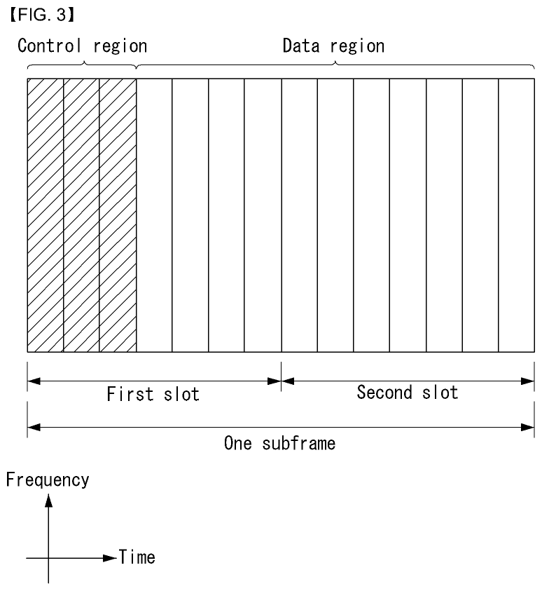

FIG. 3 illustrates the structure of a downlink subframe in the wireless communication system to which the disclosure may be applied.

Referring to FIG. 3, a maximum of three former OFDM symbols in the first slot of the sub frame is a control region to which control channels are allocated and residual OFDM symbols is a data region to which a physical downlink shared channel (PDSCH) is allocated. Examples of the downlink control channel used in the 3GPP LTE include a physical control format indicator channel (PCFICH), a Physical Downlink Control Channel (PDCCH), a Physical Hybrid-ARQ Indicator Channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an Acknowledgement (ACK)/Not-Acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport A resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregate of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

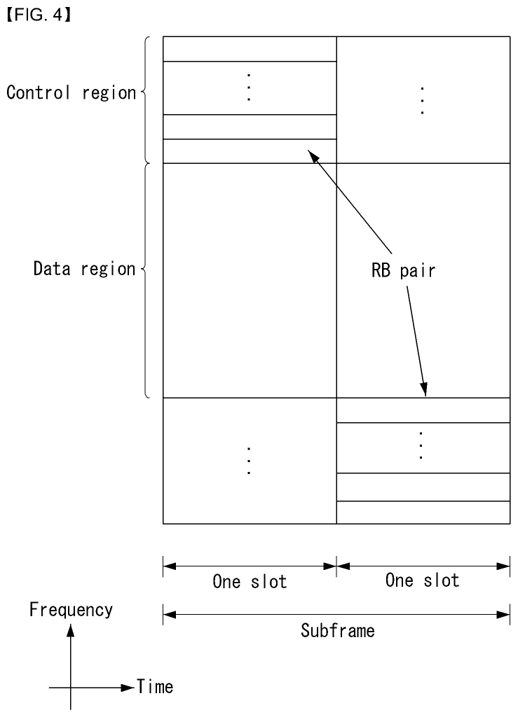

FIG. 4 illustrates the structure of an uplink subframe in the wireless communication system to which the disclosure may be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe is allocated to the PUCCH for one terminal. RBs included in the RB pair occupy different subcarriers in two slots, respectively. The RB pair allocated to the PUCCH frequency-hops in a slot boundary.

General NR system to which the present disclosure can be applied

As more communication devices require a larger communication capacity, there is a need for enhanced mobile broadband communication compared to existing radio access technology. Further, massive machine type communications (MTC), which connects multiple devices and objects to provide various services at any time and place, is one of major issues to be considered in next-generation communication. Further, a communication system design considering a service/terminal sensitive to reliability and latency is being discussed. In this way, the introduction of next-generation radio access technology considering enhanced mobile broadband communication (eMBB), massive MTC (Mmtc), and ultra-reliable and low latency communication (URLLC) is being discussed, and in the present disclosure, for convenience, the technology is referred to as NR. NR is an expression representing an example of 5G radio access technology (RAT).

Three main requirement areas of 5G include (1) an enhanced mobile broadband (eMBB) area, (2) a massive machine type communication (mMTC) area, and (3) an ultra-reliability and low latency communications (URLLC) area.

In some use cases, multiple areas may be required for optimization, and other use cases may be focused on only one key performance indicator (KPI). 5G is to support these various use cases in a flexible and reliable way.

eMBB goes far beyond basic mobile Internet access and covers a rich interactive work and media and entertainment applications in cloud or augmented reality. Data is one of key drivers of 5G, and it may not be possible to see dedicated voice services for the first time in the 5G era. In 5G, a voice is expected to be processed as an application program simply using a data connection provided by a communication system. The main reasons for an increased traffic volume are the increase in content size and the increase in the number of applications requiring high data rates. Streaming services (audio and video), interactive video and mobile Internet connections will become more widely used as more devices connect to the Internet. Many of these application programs require always-on connectivity to push real-time information and notifications to a user. Cloud storage and applications are increasing rapidly in mobile communication platforms, which may be applied to both work and entertainment. Cloud storage is a special use case that drives the growth of an uplink data rate. 5G is also used for a remote work in the cloud and requires much lower end-to-end latency to maintain a good user experience when tactile interfaces are used. Entertainment, for example, cloud gaming and video streaming are another key factor that increases the demand for mobile broadband capabilities. Entertainment is essential in smartphones and tablets at anywhere including high mobility environments such as trains, cars, and airplanes. Another use case is augmented reality and information retrieval for entertainment. Here, augmented reality requires very low latency and an instantaneous amount of data.

Further, one of the most anticipated 5G use cases relates to a function, i.e., mMTC to smoothly connect embedded sensors in all fields. By 2020, potential IoT devices are expected to reach 20.4 billion. Industrial IoT is one of areas where 5G plays a major role in enabling smart cities, asset tracking, smart utilities, and agriculture and security infrastructure.

URLLC includes new services that will transform the industry with ultra-reliable/low latency links such as self-driving vehicles and remote control of major infrastructure. The level of reliability and delay is essential for smart grid control, industrial automation, robotics, drone control and coordination.

Next, a number of use cases will be described in more detail.

5G may complement fiber-to-the-home (FTTH) and cable-based broadband (or DOCSIS) as a means of providing streams rated at hundreds of megabits per second to gigabits per second. Such a high speed is required to deliver streams to TVs in 4K or higher (6K, 8K and higher) resolutions as well as virtual reality and augmented reality. Virtual reality (VR) and augmented reality (AR) applications include almost immersive sports events. A specific application program may require a special network configuration. For example, in the case of VR games, game companies may need to integrate a core server with a network operator's edge network server in order to minimize latency.

An automotive is expected to be an important new driving force in 5G, together with many use cases for mobile communication to vehicles. For example, entertainment for passengers demands a simultaneous high capacity and a high mobility mobile broadband. The reason is that future users will continue to expect high-quality connections regardless of their position and speed. Another use case in an automotive field is an augmented reality dashboard. The augmented reality dashboard identifies an object in the dark on top of what a driver sees through a front window and overlaps and displays information that tells the driver about a distance and movement of the object. In the future, wireless modules enable communication between vehicles, exchange of information between the vehicle and support infrastructure, and exchange of information between the vehicle and other connected devices (e.g., devices carried by a pedestrian). A safety system enables to lower the risk of an accident by guiding alternative courses of an action to a driver in order for the driver to perform safer driving. The next step will be a remote controlled or self-driven vehicle. It requires very reliable and very fast communication between different self-driving vehicles and between the vehicle and the infrastructure. In the future, self-driving vehicles will perform all driving activities, and will enable drivers to focus only on traffic abnormalities that the vehicle itself cannot identify. Technical requirements of self-driving vehicles call for ultra-low latency and ultra-fast reliability in order to increase traffic safety to a level unachievable by humans.

Smart cities and smart homes, referred to as smart society, will be embedded with high density wireless sensor networks. A distributed network of intelligent sensors will identify conditions for cost and energy-efficient maintenance of a city or home. A similar configuration may be performed for each household. Temperature sensors, window and heating controllers, burglar alarms, and home appliances are all wirelessly connected. Many of these sensors are typically low data rates, low power, and low cost. However, for example, real-time HD video may be required in certain types of devices for surveillance.

The consumption and distribution of energy including a heat or gas is highly decentralized, thereby requiring automated control of distributed sensor networks. The smart grid interconnects these sensors using digital information and communication technologies in order to gather information and act accordingly. This information may include the behavior of suppliers and consumers, thereby enabling smart grids to enhance efficiency, reliability, economics, sustainability of production, and distribution of fuels such as electricity in an automated way. The smart grid may also be regarded as another low-latency sensor network.

The health sector has many application programs that can benefit from mobile communication. The communication system may support telemedicine providing clinical care from remote positions. This may help reduce barriers to distance and improve access to medical services that are not consistently available in remote rural areas. It is also used for saving lives in critical care and emergencies. A wireless sensor network based on mobile communication may provide sensors and remote monitoring of parameters such as a heart rate and a blood pressure.

Wireless and mobile communications are becoming increasingly important in an industrial application field. Wiring is expensive to install and maintain. Thus, the possibility of replacing cables with reconfigurable wireless links is an attractive opportunity for many industrial fields. However, achieving this requires that the wireless connection operates with a delay, reliability, and capacity similar to that of the cable and that management thereof is simplified. Low latency and very low error probability are new requirements that need to be connected to 5G.

Logistics and freight tracking are important use cases for mobile communication that enable tracking of inventory and packages from anywhere using position-based information systems. Logistics and freight tracking use cases typically require low data rates, but require a wide range and reliable position information.

Artificial Intelligence (AI)

AI refers to a field of researching AI or the methodology to create AI, and machine learning refers to a field of researching the methodology that defines and solves various problems dealt with in the field of AI. Machine learning is also defined as an algorithm that improves a performance of a task through continuous experience.

An artificial neural network (ANN) is a model used in machine learning, and may refer to an overall model with problem-solving capabilities, which is configured with artificial neurons (nodes) that form a network by combining synapses. The ANN may be defined by a connection pattern between neurons of different layers, a learning process for updating model parameters, and an activation function for generating an output value.

The ANN may include an input layer, an output layer, and optionally one or more hidden layers. Each layer includes one or more neurons, and the ANN may include neurons and synapses connecting neurons. In the ANN, each neuron may output a function value of an activation function for input signals, weights, and biases input through synapses.

Model parameters refer to parameters determined through learning, and include weights of synaptic connections and biases of neurons. A hyper parameter refers to a parameter that should be configured before learning in a machine learning algorithm, and includes a learning rate, repeat count, mini-batch size, and initialization function.

The purpose of learning ANNs can be seen as determining model parameters that minimize a loss function. The loss function may be used as an index for determining an optimal model parameter in a learning process of the ANN.

Machine learning may be classified into supervised learning, unsupervised learning, and reinforcement learning according to a learning method.

Supervised learning refers to a method of training an ANN when a label for learning data is given, and the label may mean a correct answer (or result value) that the ANN should infer when learning data is input to the ANN. Unsupervised learning may mean a method of training an ANN when a label for learning data is not given. Reinforcement learning may mean a learning method that trains an agent defined in a certain environment to select an action or action sequence that maximizes a cumulative reward in each state.

Among ANNs, machine learning implemented by a deep neural network (DNN) including a plurality of hidden layers is sometimes referred to as deep learning, and deep learning is a part of machine learning. Hereinafter, machine learning is used in the sense including deep learning.

Robot

A robot may refer to a machine that automatically processes or operates a given task by its own capabilities. In particular, a robot having a function of recognizing an environment and performing an action by self-determining may be referred to as an intelligent robot.

Robots may be classified into industrial, medical, household, military robots, etc. depending on a purpose or field of use.

The robot may be provided with a driving unit including an actuator or a motor to perform various physical actions such as moving a robot joint. Further, a movable robot includes a wheel, a brake, a propeller, and the like in a driving unit, and may travel on the ground or fly in the air through the driving unit.

Autonomous-Driving (Self-Driving)

Autonomous driving refers to self-driving technology, and an autonomous driving vehicle refers to a vehicle that is driven without a user's manipulation or with a user's minimal manipulation.

For example, autonomous driving may include all of technology that maintains a driving lane, technology that automatically adjusts a speed such as adaptive cruise control, technology that automatically travels along a specified route, technology that automatically configures and travels a route when a destination is configured, etc.

The vehicle includes all of a vehicle including only an internal combustion engine, a hybrid vehicle including both an internal combustion engine and an electric motor, and an electric vehicle including only an electric motor, and may include not only automobiles, but also trains and motorcycles.

In this case, the autonomous driving vehicle may be regarded as a robot having an autonomous driving function.

eXtended Reality (XR)

XR collectively refers to virtual reality (VR), augmented reality (AR), and mixed reality (MR). VR technology provides only CG images of real world objects or backgrounds, AR technology provides virtually created CG images on real object images, and MR technology is computer graphic technology that mixes, combines, and provides virtual objects in the real world.

MR technology is similar to AR technology in that it shows real objects and virtual objects together. However, in AR technology, virtual objects are used in the form that complements real objects, whereas in MR technology, virtual objects and real objects are used with equal characteristics.

XR technology may be applied to a head-mount display (HMD), a head-up display (HUD), a mobile phone, a tablet PC, a laptop PC, a desktop PC, a TV, a digital signage, etc., and a device to which XR technology is applied may be referred to as an XR device.

A new RAT system including NR uses an OFDM transmission scheme or a similar transmission scheme. The new RAT system may follow OFDM parameters different from those of LTE. Alternatively, the new RAT system follows numerology of the existing LTE/LTE-A as it is, but may have a larger system bandwidth (e.g., 100 MHz). Alternatively, one cell may support a plurality of neurology. That is, terminals operating in different neurology may coexist within one cell.

Numerology corresponds to one subcarrier spacing in a frequency domain. By scaling a reference subcarrier spacing to an integer N, different numerology may be defined.

### Definition of Terms

eLTE eNB: eLTE eNB is evolution of an eNB that supports connection to EPC and NGC.

gNB: A node that supports NR as well as connection with NGC.

New RAN: A radio access network that supports NR or E-UTRA or that interacts with NGC.

Network slice: A network slice is a network defined by an operator in order to provide an optimized solution for specific market scenarios that require specific requirements with end-to-end coverage.

Network function: A network function is a logical node within a network infrastructure with well-defined external interfaces and well-defined functional operations.

NG-C: A control plane interface used for an NG2 reference point between a new RAN and NGC.

NG-U: A user plane interface used for an NG3 reference point between a new RAN and NGC.

Non-standalone NR: A deployment configuration in which a gNB requires an LTE eNB as an anchor for control plane connection to EPC or requires an eLTE eNB as an anchor for control plane connection to NGC.

Non-standalone E-UTRA: A deployment configuration in which an eLTE eNB requires a gNB as an anchor for control plane connection to NGC.

User plane gateway: An endpoint of an NG-U interface.

General System

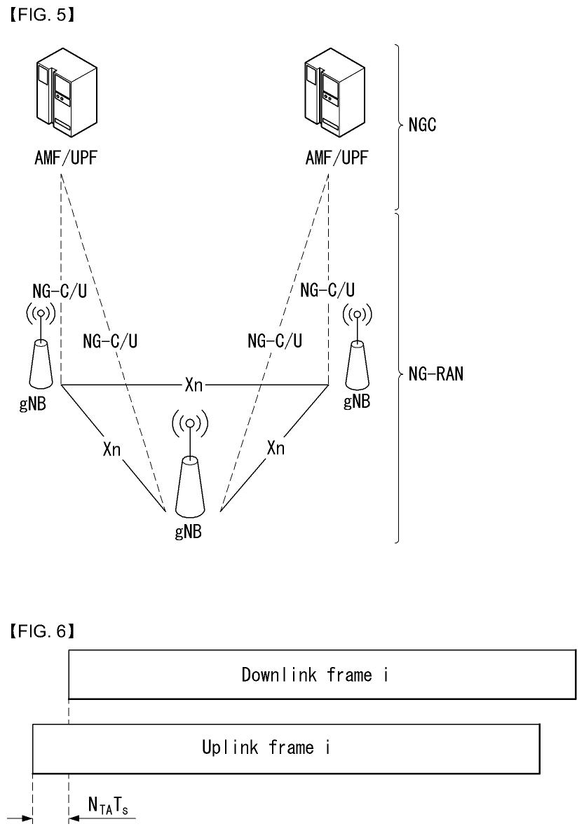

FIG. 5 illustrates an example of an overall structure of a NR system to which a method proposed in the disclosure may be applied.

Referring to FIG. 5, an NG-RAN consists of gNBs that provide an NG-RA user plane (new AS sublayer/PDCP/RLC/MAC/PHY) and control plane (RRC) protocol terminations for a user equipment (UE).

The gNBs are interconnected with each other by means of an Xn interface.

The gNBs are also connected to an NGC by means of an NG interface.

More specifically, the gNBs are connected to an access and mobility management function (AMF) by means of an N2 interface and to a user plane function (UPF) by means of an N3 interface.

New Rat (NR) Numerology and Frame Structure

In a NR system, multiple numerologies can be supported. A numerology may be defined by a subcarrier spacing and a cyclic prefix (CP) overhead. Multiple subcarrier spacings can be derived by scaling a basic subcarrier spacing by an integer N (or). Further, although it is assumed not to use a very low subcarrier spacing at a very high carrier frequency, the numerology used can be selected independently of a frequency band.

In the NR system, various frame structures according to the multiple numerologies can be supported.

Hereinafter, an orthogonal frequency division multiplexing (OFDM) numerology and a frame structure which may be considered in the NR system will be described.

Multiple OFDM numerologies supported in the NR system may be defined as in Table 3.

TABLE 3
Cyclic prefix

| | | |
|---|---|---|
| 0 | 15 | Normal |
| 1 | 30 | Normal |
| 2 | 60 | Normal, Extended |
| 3 | 120 | Normal |
| 4 | 240 | Normal |

In regard to a frame structure in the NR system, a size of various fields in a time domain is expressed as a multiple of a time unit of, where and. Downlink and uplink transmissions are organized into radio frames with a duration of. In this case, the radio frame consists of ten subframes each having a duration of. In this case, there may be a set of frames in the uplink and a set of frames in the downlink. FIG. 6 illustrates a relation between an uplink frame and a downlink frame in a wireless communication system to which a method proposed in the disclosure may be applied.

As illustrated in FIG. 6, uplink frame number i for transmission from a user equipment (UE) shall start before the start of a corresponding downlink frame at the corresponding UE.

Regarding the numerology, slots are numbered in increasing order of within a subframe and are numbered in increasing order of within a radio frame. One slot consists of consecutive OFDM symbols of, and is determined depending on a numerology used and slot configuration. The start of slots in a subframe is aligned in time with the start of OFDM symbols in the same subframe.

Not all UEs are able to transmit and receive at the same time, and this means that not all OFDM symbols in a downlink slot or an uplink slot are available to be used.

Table 4 represents the number of OFDM symbols per slot, the number of slots per radio frame, and the number of slots per subframe in a normal CP. Table 5 represents the number of OFDM symbols per slot, the number of slots per radio frame, and the number of slots per subframe in an extended CP.

TABLE 4

| | | | |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 5

| [symbol] | | | |
|---|---|---|---|
| 2 | 12 | 40 | 4 |

[symbol]

indicates data missing or illegible when filed

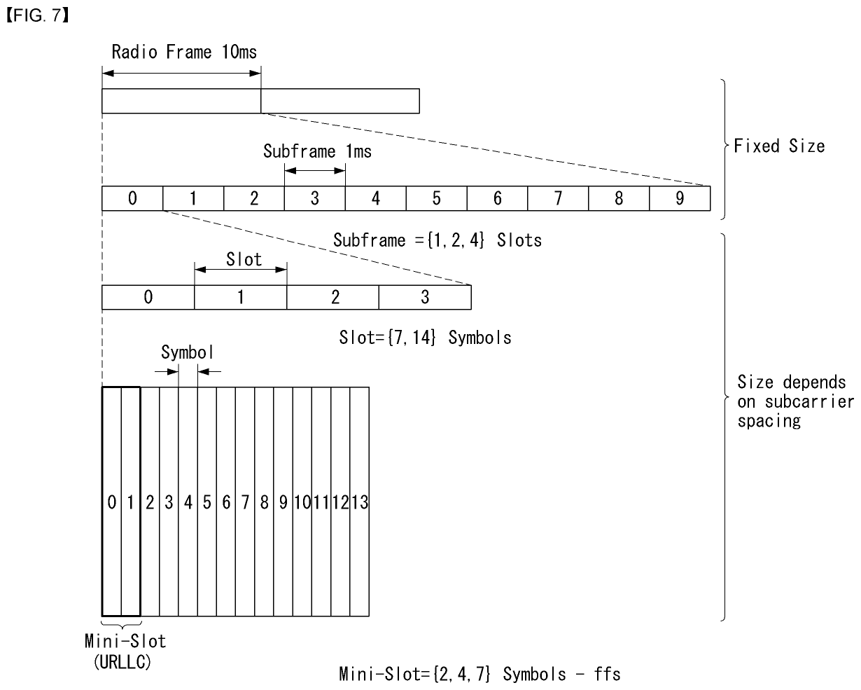

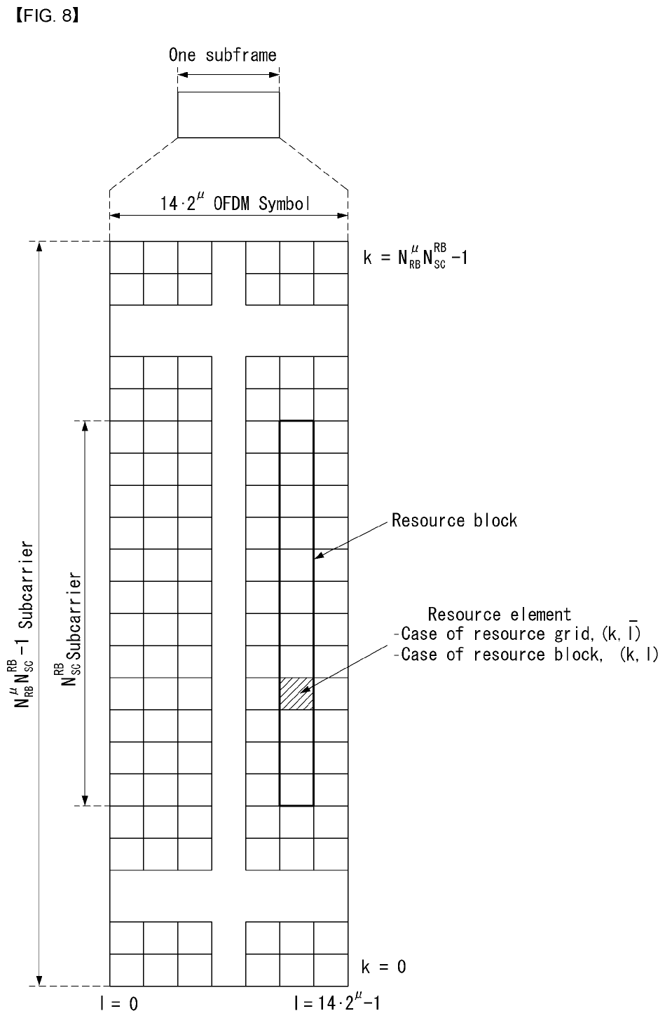

FIG. 7 illustrates an example of a frame structure in a NR system. FIG. 7 is merely for convenience of description and does not limit the scope of the disclosure. In Table 5, in the case of =2, i.e., as an example in which a subcarrier spacing (SCS) is 60 kHz, one subframe (or frame) may include four slots with reference to Table 4, and one subframe={1, 2, 4} slots shown in FIG. 3, for example, the number of slot(s) that may be included in one subframe may be defined as in Table 2.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. may be considered.

Hereinafter, the above physical resources that can be considered in the NR system are described in more detail.

First, in regard to an antenna port, the antenna port is defined so that a channel over which a symbol on an antenna port is conveyed can be inferred from a channel over which another symbol on the same antenna port is conveyed. When large-scale properties of a channel over which a symbol on one antenna port is conveyed can be inferred from a channel over which a symbol on another antenna port is conveyed, the two antenna ports may be regarded as being in a quasi co-located or quasi co-location (QC/QCL) relation. In this case, the large-scale properties may include at least one of delay spread, Doppler spread, frequency shift, average received power, and received timing.

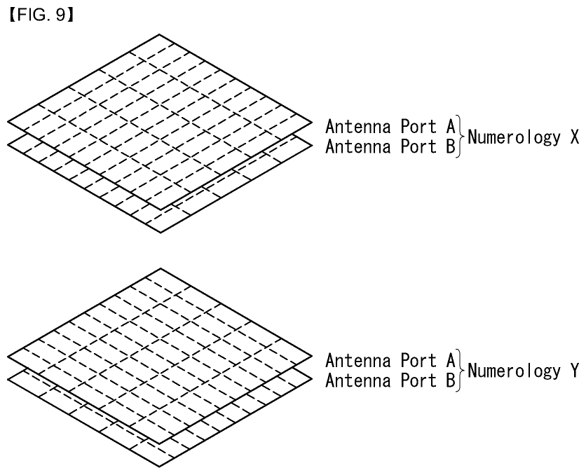

FIG. 8 illustrates an example of a resource grid supported in a wireless communication system to which a method proposed in the disclosure may be applied.

Referring to FIG. 8, a resource grid consists of subcarriers on a frequency domain, each subframe consisting of 14-2μ OFDM symbols, but the disclosure is not limited thereto.

In the NR system, a transmitted signal is described by one or more resource grids, consisting of subcarriers, and OFDM symbols, where. denotes a maximum transmission bandwidth and may change not only between numerologies but also between uplink and downlink.

In this case, as illustrated in FIG. 9, one resource grid may be configured per numerology and antenna port p.

FIG. 9 illustrates examples of a resource grid per antenna port and numerology to which a method proposed in the disclosure may be applied.

Each element of the resource grid for the numerology and the antenna port p is called a resource element and is uniquely identified by an index pair, where is an index on a frequency domain, and refers to a location of a symbol in a subframe. The index pair is used to refer to a resource element in a slot, where.

The resource element for the numerology and the antenna port p corresponds to a complex value. When there is no risk for confusion or when a specific antenna port or numerology is not specified, the indexes p and may be dropped, and as a result, the complex value may be or.

Further, a physical resource block is defined as consecutive subcarriers in the frequency domain.

Point A serves as a common reference point of a resource block grid and may be obtained as follows.
offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2;
absoluteFrequencyPointA represents frequency-location of the point A expressed as in absolute radio-frequency channel number (ARFCN).

The common resource blocks are numbered from 0 and upwards in the frequency domain for subcarrier spacing configuration.

The center of subcarrier 0 of common resource block 0 for the subcarrier spacing configuration coincides with ‘point A’. A common resource block number in the frequency domain and resource elements (k, l) for the subcarrier spacing configuration may be given by the following Equation 1.

$$\text{?} \text{?} \text{indicates text missing or illegible when filed} \qquad [ Equation 1 ]$$

In this case, may be defined relative to the point A so that corresponds to a subcarrier centered around the point A. Physical resource blocks are defined within a bandwidth part (BWP) and are numbered from 0 to, where is No. of the BWP. A relation between the physical resource block in BWP and the common resource block may be given by the following Equation 2.

$$\text{?} \text{?} \text{indicates text missing or illegible when filed} \qquad [ Equation 2 ]$$

In this case, may be the common resource block where the BWP starts relative to the common resource block 0.

A PRB grid of each neurology supported by a carrier, a BWP configuration in each carrier of DL/UL (supports maximum 4 BWP), a code block group (CBG) configuration, a transmission power control (TPC) per cell group, a HARQ process, scrambling/sequence related parameters, etc. may be configured in a carrier level. A control resource set (configured per cell, but associated per BWP), parameters related to resource allocation and DM-RS configuration, CSI-RS related parameters, SRS resource set, HARQ-ACK and schedule request (SR) resources, configured UL grant, etc., may be configured in a BWP stage.

Machine Type Communication (MTC)

MTC is an application that does not require a lot of throughput that can be applied to Machine-to-Machine (M2M) or Internet-of-Things (IoT), and refers to communication technology adopted to meet requirements of an IoT service in a 3rd generation partnership project (3GPP).

MTC may be implemented to satisfy the criteria of (i) low cost and low complexity, (ii) enhanced coverage, and (iii) low power consumption.

In 3GPP, MTC has been applied from release 10, and the features of MTC added for each release of 3GPP will be briefly described.

First, MTC described in 3GPP release 10 and release 11 relates to a load control method.

The load control method is to prevent IoT (or M2M) devices from suddenly loading the base station.

More specifically, in the case of release 10, the method is a method in which the base station controls a load by disconnecting a connection to connected IoT devices when the load occurs, and in the case of release 11, the method is a method in which the base station blocks in advance connection to a terminal by notifying in advance the terminal to connect later through broadcasting such as SIB14.

In the case of release 12, features for low cost MTC were added, and for this purpose, an UE category 0 was newly defined. The UE category is an indicator of how much data a terminal can process in a communication modem.

That is, the UE of the UE category 0 reduces a baseband and RF complexity of the UE by using a half-duplex operation with a reduced peak data rate and a relaxed RF requirement, and a single receiving antenna.

In release 13, enhanced MTC (eMTC) technology was introduced, and by enabling to operate only at 1.08 MHz, which is the minimum frequency bandwidth supported by legacy LTE, a price and power consumption can be further reduced.

A description described below is mainly eMTC-related features, but may be equally applied to MTC, eMTC, and MTC to be applied to 5G (or NR) unless otherwise specified. Hereinafter, for convenience of description, they will be collectively referred to as MTC.

Therefore, MTC to be described later may be referred to as other terms such as enhanced MTC (eMTC), LTE-M1/M2, bandwidth reduced low complexity (BL)/coverage enhanced (CE), non-BL UE (in enhanced coverage), NR MTC, and enhanced BL/CE. That is, the term MTC may be replaced with a term to be defined in the future 3GPP standard.

1) General Characteristics of MTC

(1) MTC Operates Only in a Specific System Bandwidth (or Channel Bandwidth).

The specific system bandwidth may use 6 RBs of legacy LTE, as illustrated in Table 6 below, and may be defined in consideration of a frequency range and subcarrier spacing (SCS) of NR defined in Tables 7 to 9. The specific system bandwidth may be expressed as a narrowband (NB). For reference, legacy LTE refers to a part described in 3GPP standards other than MTC. Preferably, in NR, MTC may operate using RBs corresponding to a lowest system bandwidth of Tables 8 and 9 below, as in legacy LTE. Alternatively, in NR, MTC may operate in at least one bandwidth part (BWP) or may operate in a specific band of BWP.

TABLE 6

| | Channel bandwidth BWChannel [MHz] | | | | | |
|---|---|---|---|---|---|---|
| | 1.4 | 3 | 5 | 10 | 15 | 20 |
| Transmission | 6 | 15 | 25 | 50 | 75 | 100 |
| bandwidth | | | | | | |
| configuration | | | | | | |
| NRB | | | | | | |

Table 7 illustrates a frequency range (FR) defined in NR.

TABLE 7

| Frequency range designation | Corresponding frequency range |
|---|---|
| FR1 | 450 MHz-6000 MHz |
| FR2 | 24250 MHz-52600 MHz |

Table 8 illustrates an example of a maximum transmission bandwidth configuration (NRB) for a channel bandwidth and SCS in FR 1 of NR.

TABLE 8

| SCS | 5 MHz | 10 MHz | 15 MHz | 20 MHz | 25 MHz | 30 MHz | 40 MHz | 50 MHz | 60 MHz | 80 MHz | 90 MHz | 100 MHz |
|---|---|---|---|---|---|---|---|---|---|---|---|---|
| (kHz) | NRB | NRB | NRB | NRB | NRB | NRB | NRB | NRB | NRB | NRB | NRB | NRB |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

Table 9 illustrates an example of a maximum transmission bandwidth configuration (NRB) for a channel bandwidth and SCS in FR 2 of NR.

TABLE 9

| | 50 MHz | 100 MHz | 200 MHz | 400 MHz |
|---|---|---|---|---|
| SCS (kHz) | NRB | NRB | NRB | NRB |
| 60 | 66 | 132 | 264 | N.A |
| 120 | 32 | 66 | 132 | 264 |

An MTC narrowband (NB) will be described in more detail.

MTC follows a narrowband operation to transmit and receive physical channels and signals, and the maximum channel bandwidth is reduced to 1.08 MHz or 6 (LTE) RBs.

The narrowband may be used as a reference unit for resource allocation units of some channels of downlink and uplink, and a physical position of each narrowband in a frequency domain may be defined differently according to a system bandwidth.

A bandwidth of 1.08 MHz defined in MTC is defined in order for an MTC terminal to follow the same cell search and random access procedures as those of a legacy terminal.

MTC may be supported by cells with a much larger bandwidth (e.g., 10 MHz) than 1.08 MHz, but physical channels and signals transmitted/received by MTC are always limited to 1.08 MHz.

A system having a much larger bandwidth may be legacy LTE, an NR system, a 5G system, and the like.

The narrowband is defined as 6 non-overlapping consecutive physical resource blocks in a frequency domain.

If, a wideband is defined as 4 non-overlapping narrowbands in a frequency domain. If and a single wideband are configured with non-overlapping narrowband(s).

For example, in the case of 10 MHz channel (50 RBs), 8 non-overlapping narrowbands are defined.

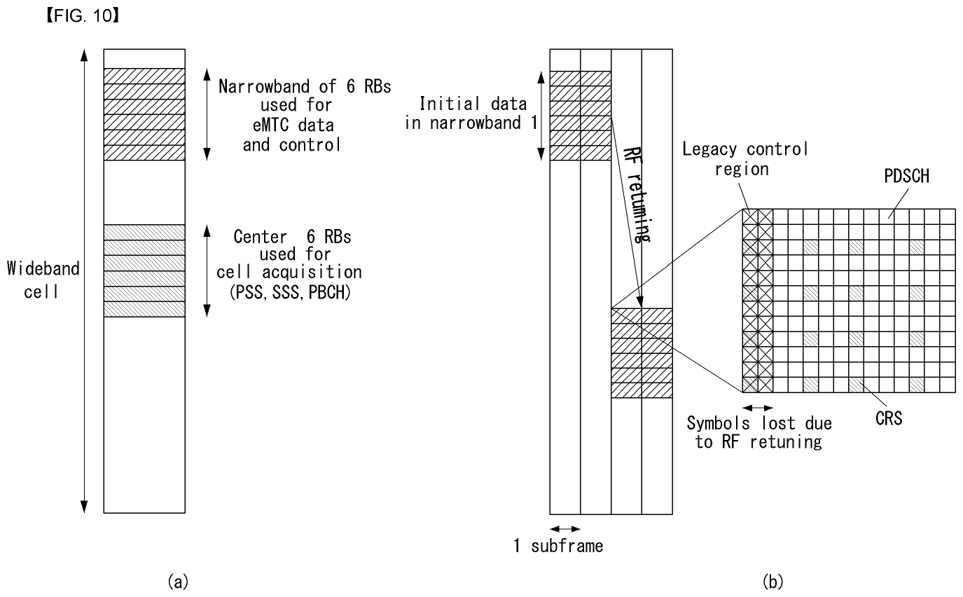

FIG. 10 illustrates an example of a narrowband operation and frequency diversity. FIG. 10(a) is a diagram illustrating an example of a narrowband operation, and FIG. 10(b) is a diagram illustrating an example of repetition with RF retuning.

Referring to FIG. 10(b), frequency diversity by RF retuning will be described.

Due to a narrowband RF, a single antenna, and limited mobility, MTC supports a limited frequency, and spatial and temporal diversity. To reduce effects of fading and outage, frequency hopping is supported between different narrowbands by RF retuning.

Such frequency hopping is applied to different uplink and downlink physical channels when repetition is available.

For example, when 32 subframes are used for PDSCH transmission, first 16 subframes may be transmitted on a first narrowband. In this case, the RF front-end is retuned to another narrowband, and the remaining 16 subframes are transmitted on a second narrowband.

A narrowband of MTC may be configured by system information or downlink control information (DCI).

(2) MTC operates in a half-duplex mode and uses limited (or reduced) maximum transmit power.

(3) MTC does not use a channel (defined in legacy LTE or NR) that should be distributed over the entire system bandwidth of legacy LTE or NR.

For example, legacy LTE channels not used for MTC are a PCFICH, a PHICH, and a PDCCH.

Accordingly, MTC cannot monitor the above channels and thus defines an MTC PDCCH (MPDCCH), which is a new control channel.

The MPDCCH spans maximum 6 RBs in a frequency domain and one subframe in a time domain.

The MPDCCH is similar to an EPDCCH, and additionally supports a common search space for paging and random access.

The MPDCCH is similar to the concept of an E-PDCCH used in legacy LTE.

(4) MTC uses a newly defined DCI format, and may be, for example, DCI formats 6-0A, 6-0B, 6-1A, 6-1B, and 6-2.

(5) MTC may transmit repeatedly a physical broadcast channel (PBCH), a physical random access channel (PRACH), an MTC physical downlink control channel (M-PDCCH), a physical downlink shared channel (PDSCH), a physical uplink control channel (PUCCH), and a physical uplink shared channel (PUSCH). Such MTC repetition transmission may decode an MTC channel even when a signal quality or power is very poor, as in a poor environment such as a basement, thereby increasing a cell radius and effecting signal penetration. MTC may support only a limited number of transmission modes (TM) that can operate in a single layer (or single antenna) or may support a channel or a reference signal (RS) that can operate in a single layer. For example, a transmission mode in which MTC can operate may be (TM) 1, 2, 6, or 9.

(6) HARQ retransmission of MTC is an adaptive and asynchronous scheme and is based on new scheduling assignment received in an MPDCCH.

(7) In MTC, PDSCH scheduling (DCI) and PDSCH transmission occur in different subframes (cross subframe scheduling).

(8) All resource allocation information (subframe, transport block size (TBS), subband index) for SIB1 decoding is determined by parameters of the MIB, and no control channel is used for SIB1 decoding of MTC.

(9) All resource allocation information (subframe, TBS, subband index) for SIB2 decoding is determined by several SIB1 parameters, and no control channel for SIB2 decoding of MTC is used.

(10) MTC supports an extended paging (DRX) cycle.

(11) MTC may use the same primary synchronization signal (PSS)/secondary synchronization signal (SSS)/common reference signal (CRS) as that used in legacy LTE or NR. In the case of NR, the PSS/SSS is transmitted in units of SS blocks (or SS/PBCH blocks or SSBs), and tracking RS (TRS) may be used for the same use as that of the CRS. That is, the TRS is a cell-specific RS and may be used for frequency/time tracking.

2) MTC operating mode and level

Next, the MTC operation mode and level will be described. MTC is classified into two operation modes (first mode and second mode) and four different levels for coverage enhancement, and may be the same as that illustrated in Table 10 below.

The MTC operation mode is referred to as a CE Mode, and in this case, the first mode may be referred to as a CE Mode A, and the second mode may be referred to as a CE Mode B.

TABLE 10

| Mode | Level | Description |
|---|---|---|
| Mode A | Level 1 | No repetition for PRACH |
| | Level 2 | Small Number of Repetition for PRACH |
| Mode B | Level 3 | Medium Number of Repetition for PRACH |
| | Level 4 | Large Number of Repetition for PRACH |

The first mode is defined to enhance small coverage in which complete mobility and channel state information (CSI) feedback are supported, and thus it is a mode of no repetition or a mode of a small number of repetitions. An operation of the first mode may be the same as that in an operation range of an UE category 1. The second mode is defined for UEs with extremely poor coverage conditions supporting CSI feedback and limited mobility, and a large number of repetition transmissions are defined. The second mode provides maximum 15 dB of coverage enhancement based on a range of an UE category 1. Each level of MTC is defined differently in a RACH and paging procedure.

An MTC operation mode and a method in which each level is determined will be described.

The MTC operation mode is determined by the base station, and each level is determined by an MTC terminal. Specifically, the base station transmits RRC signaling including information on the MTC operation mode to the terminal. Here, RRC signaling may be an RRC connection setup message, an RRC connection reconfiguration message, or an RRC connection reestablishment message. Here, the term of the message may be expressed as an information element (IE).

Thereafter, the MTC terminal determines a level within each operation mode and transmits the determined level to the base station. Specifically, the MTC terminal determines a level in an operation mode based on the measured channel quality (e.g., RSRP, RSRQ, or SINR), and notifies the base station of the determined level using PRACH resources (frequency, time, preamble) corresponding to the determined level.

3) MTC guard period

As described above, MTC operates in a narrowband. A position of the narrowband may be different for each specific time unit (e.g., subframe or slot). The MTC terminal tunes to different frequencies in all time units. Therefore, a predetermined time is required for all frequency retuning, and the predetermined time is defined as a guard period of MTC. That is, the guard period is required when transiting from one time unit to the next time unit, and transmission and reception do not occur during the period.

The guard period is defined differently according to whether it is a downlink or an uplink, and is defined differently according to a downlink or uplink situation. First, a guard period defined in the uplink is defined differently according to the characteristics of data carried by a first time unit (time unit N) and a second time unit (time unit N+1). Next, a guard period of the downlink requires a condition that (1) a first downlink narrowband center frequency and a second narrowband center frequency are different and that (2) in TDD, a first uplink narrowband center frequency and a second downlink center frequency are different.

When describing the MTC guard period defined in legacy LTE, guard periods of SC-FDMA symbols are generated at most for Tx-Tx frequency retuning between two consecutive subframes. When an upper layer parameter ce-RetuningSymbols is configured, is the same as ce-RetuningSymbols, otherwise=2. Further, for the MTC terminal configured with an upper layer parameter srs-UpPtsAdd, a guard period of the maximum SC-FDMA symbol is generated for Tx-Tx frequency retuning between a first special subframe and a second uplink subframe for a frame structure type 2.

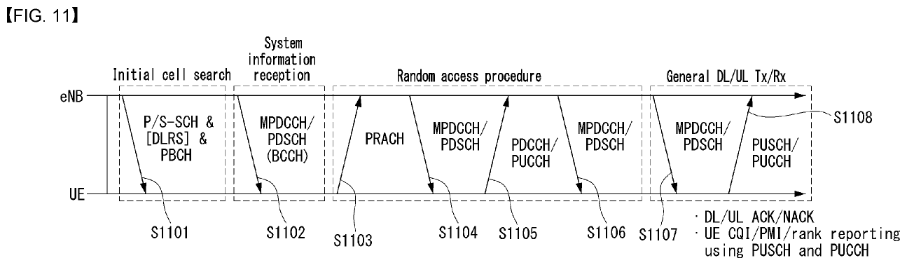

FIG. 11 is a diagram illustrating physical channels that can be used for MTC and a general signal transmission method using the physical channels.

An MTC terminal, which is powered on again while power is turned off, or that newly enters a cell, performs an initial cell search operation such as synchronizing with the base station in step S1101. To this end, the MTC terminal receives a primary synchronization signal (PSS) and a secondary synchronization signal (SSS) from the base station, synchronizes with the base station, and obtains information such as a cell identifier (ID). The PSS/SSS used for an initial cell search operation of MTC may be a PSS/SSS and a resynchronization signal (RSS) of legacy LTE.

Thereafter, the MTC terminal may receive a physical broadcast channel (PBCH) signal from the base station to obtain intra-cell broadcast information.

The MTC terminal may receive a downlink reference signal (DL RS) in an initial cell search step to check a downlink channel state. Broadcast information transmitted through the PBCH is a master information block (MIB), and in MTC, the MIB is repeated in a subframe (subframe #9 for FDD, subframe #5 for TDD) different from a first slot of a subframe #0 of a radio frame.

PBCH repetition is performed by repeating exactly the same constellation point in different OFDM symbols so that it may be used for initial frequency error estimation even before attempting PBCH decoding.

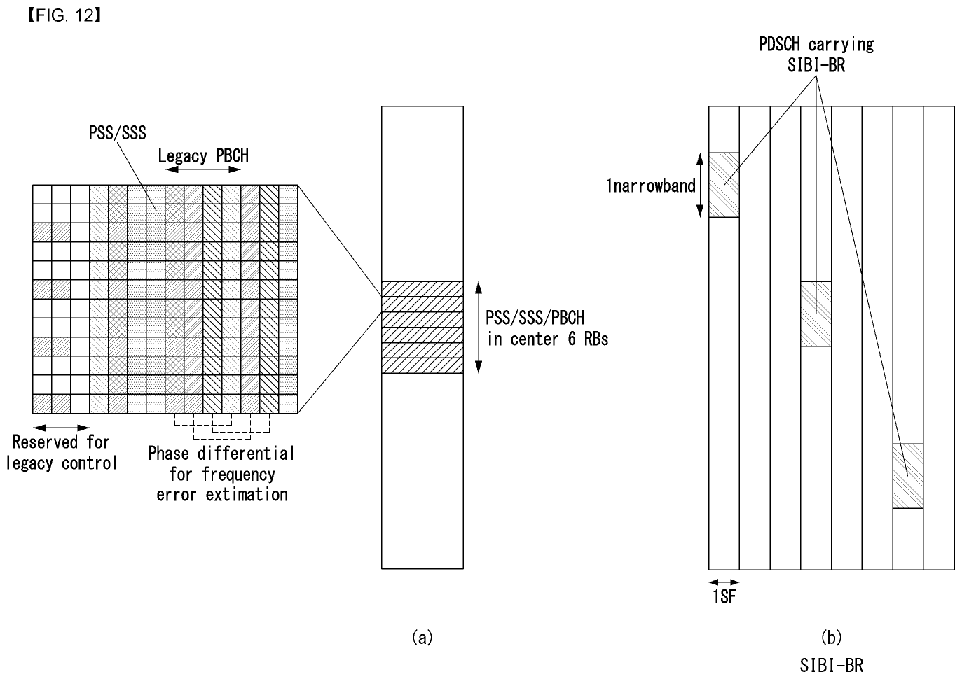

FIG. 12 illustrates an example of an operation and configuration related to system information of an MTC system.

FIG. 12(a) is a diagram illustrating an example of a frequency error estimation method for a repetition pattern for a subframe #0, a general CP, and repeated symbols in FDD, and FIG. 12(b) illustrates an example of transmission of SIB-BR on a broadband LTE channel.

In the MIB, five reserved bits are used in MTC to transmit scheduling information for a new system information block for bandwidth reduced device (SIB1-BR) including a time/frequency position and a transmission block size.

SIB-BR is transmitted directly on a PDSCH without any control channel associated therewith.

SIB-BR remains with unchanged in 512 radio frames (5120 ms) to allow multiple subframes to be combined.

Table 11 illustrates an example of the MIB.

TABLE 11

| | |
|---|---|
| -- ASN1START | |
| MasterInformationBlock ::= | SEQUENCE { |
| dl-Bandwidth | ENUMERATED { |
| | n6, n15, n25, |
| n50, n75, n100}, | |
| phich-Config | PHICH-Config, |
| systemFrameNumber | BIT STRING (SIZE (8)), |
| schedulingInfoSIB1-BR-r13 | INTEGER (0..31), |
| systemInfoUnchanged-BR-r15 | BOOLEAN, |
| spare | BIT STRING (SIZE (4)) |
| } | |
| -- ASN1STOP | |

In Table 11, a schedulingInfoSIB1-BR field represents an index for a table defining SystemInformationBlockType1-BR scheduling information, and a value 0 means that SystemInformationBlockType1-BR is not scheduled. The overall function and information carried by SystemInformationBlockType1-BR (or SIB1-BR) is similar to SIB1 of legacy LTE. The contents of SIB1-BR may be classified into (1) PLMN, (2) cell selection criteria, and (3) scheduling information for SIB2 and other SIBs.

After completing an initial cell search, the MTC terminal may receive an MPDCCH and a PDSCH according to MPDCCH information in step S1102 to obtain more detailed system information. The MPDCCH is (1) very similar to an EPDCCH, carries common and UE specific signaling, (2) may be transmitted once or repeatedly (the number of repetitions is configured by higher layer signaling), (3) multiple MPDCCHs are supported, and the UE monitors the set of MPDCCHs, (4) the MPDCCH is formed by a combination of an enhanced control channel element (eCCE), and each eCCE includes a set of resource elements, and (5) the MPDCCH supports a radio network temporary identifier (RA-RNTI), SI-RNTI, P-RNTI, C-RNTI, temporary C-RNTI, and semi-persistent scheduling (SPS) C-RNTI.

Thereafter, in order to complete access to the base station, the MTC terminal may perform a random access procedure such as subsequent steps S1103 to S1106. A basic configuration related to a RACH procedure is transmitted by SIB2. Further, SIB2 includes parameters related to paging. Paging Occasion (PO) is a subframe in which P-RNTI may be transmitted on an MPCCH. When a P-RNTI PDCCH is repeatedly transmitted, PO refers to a start subframe of MPDCCH repetition. A paging frame (PF) is one radio frame and may include one or a plurality of POs. When DRX is used, the MTC terminal monitors only one PO per DRX cycle. A paging narrowband (PNB) is one narrowband, and the MTC terminal receives a paging message.

To this end, the MTC terminal may transmit a preamble through a physical random access channel (PRACH) (S1103) and receive a response message (RAR) to the preamble through the MPDCCH and a corresponding PDSCH (S1104). In the case of contention-based random access, the MTC terminal may perform a contention resolution procedure such as transmission of an additional PRACH signal (S1105) and reception of an MPDCCH signal and a corresponding PDSCH signal (S1106). Signals and/or messages (Msg 1, Msg 2, Msg 3, and Msg 4) transmitted in a RACH procedure in MTC may be repeatedly transmitted, and such a repetition pattern is configured differently according to a CE level. The Msg 1 means a PRACH preamble, the Msg 2 means a random access response (RAR), the Msg 3 means UL transmission of the MTC terminal for RAR, and the Msg 4 means DL transmission of the base station for the Msg 3.

For random access, signaling for different PRACH resources and different CE levels is supported. This provides the same control of the near-far effect for the PRACH by grouping together UEs experiencing a similar path loss. Maximum four different PRACH resources may be signaled to the MTC terminal.

The MTC terminal estimates RSRP using a downlink RS (e.g., CRS, CSI-RS, TRS, etc.), and selects one of resources for random access based on the measurement result. Each of four resources for random access has a relationship with the number of repetitions for the PRACH and the number of repetitions for a random access response (RAR).

Therefore, the MTC terminal with bad coverage needs a large number of repetitions to be successfully detected by the base station, and needs to receive an RAR having a corresponding repetition number in order to satisfy a coverage level thereof.

Search spaces for an RAR and contention resolution messages are also defined in system information and are independent for each coverage level.

A PRACH waveform used in MTC is the same as a PRACH waveform used in legacy LTE (e.g., OFDM and Zadof-Chu sequence).

After performing the above-described procedure, the MTC terminal may receive an MPDCCH signal and/or a PDSCH signal (S1107) and transmit a physical uplink shared channel (PUSCH) signal and/or a physical uplink control channel (PUCCH) signal (S1108) as a general uplink/downlink signal transmission procedure. Control information transmitted from the MTC terminal to the base station is collectively referred to as uplink control information (UCI). UCI may include HARQ-ACK/NACK, a scheduling request (SR), a channel quality indicator (CQI), a precoding matrix indicator (PMI), rank indication (RI) information, etc.

When an RRC connection to the MTC terminal is established, the MTC terminal blind-decodes the MPDCCH in a search space configured to obtain uplink and downlink data allocation.

MTC uses all OFDM symbols available in a subframe in order to transmit DCI. Therefore, in the same subframe, time domain multiplexing between the control channel and the data channel is impossible. That is, as described above, cross-subframe scheduling between the control channel and the data channel is possible.

The MPDCCH having last repetition in a subframe #N schedules PDSCH allocation in a subframe #N+2.

DCI transmitted by the MPDCCH provides information on how many times the MPDCCH is repeated so that the MTC terminal knows when PDSCH transmission is started.

PDSCH allocation may be performed in different narrowbands. Therefore, the MTC terminal needs to retune before decoding PDSCH allocation.

For uplink data transmission, scheduling follows the same timing as that of legacy LTE. Here, a last MPDCCH in a subframe #N schedules PUSCH transmission starting in a subframe #N+4.

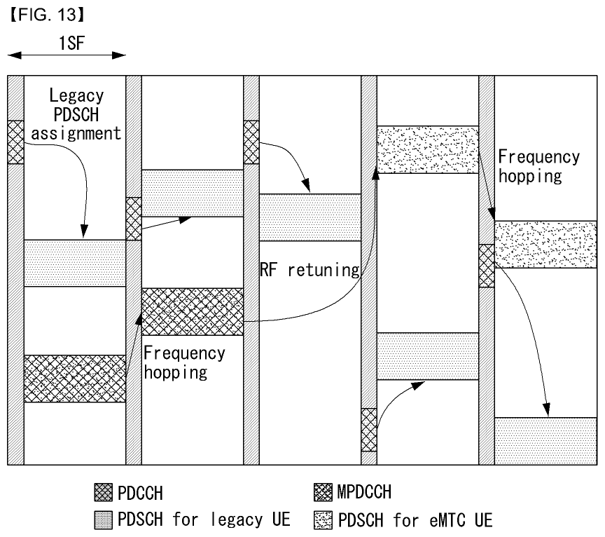

FIG. 13 is a diagram illustrating an example of scheduling for each of MTC and legacy LTE.

Legacy LTE allocation is scheduled using a PDCCH, which uses first OFDM symbols in each subframe, and the PDSCH is scheduled in the same subframe as a subframe in which the PDCCH is received.

However, an MTC PDSCH is scheduled to a cross-subframe, and one subframe is defined between the MPDCCH and the PDSCH to allow MPDCCH decoding and RF retuning.

An MTC control channel and a data channel may be repeated through a large number of subframes having maximum 256 subframes for the MPDCCH and maximum 2048 subframes for the PDSCH to be decoded under extreme coverage conditions.

Narrowband-Internet of Things (NB-IoT)

NB-IoT may mean a system for supporting low complexity and low power consumption through a system bandwidth (system BW) corresponding to 1 Physical Resource Block (PRB) of wireless communication systems (e.g., LTE system, NR system, etc.).

Here, NB-IoT may be referred to as other terms such as NB-LTE, NB-IoT enhancement, enhanced NB-IoT, further enhanced NB-IoT, and NB-NR. That is, NB-IoT may be defined in the 3GPP standard or may be replaced by a term to be defined in the 3GPP standard, and hereinafter, for convenience of description, it will be collectively referred to as “NB-IoT”.

NB-IoT may be mainly used as a communication method for implementing Internet of Things (IoT) by supporting a device (or terminal) such as machine-type communication (MTC) in a cellular system. In this case, by allocating 1 PRB of the existing system band for NB-IoT, there is an advantage that a frequency can be efficiently used. Further, in the case of NB-IoT, because each terminal recognizes a single PRB as each carrier, the PRB and the carrier described in the present disclosure may be interpreted as the same meaning.

Hereinafter, a frame structure, a physical channel, a multi-carrier operation, an operation mode, general signal transmission and reception, etc. related to NB-IoT in the present disclosure will be described in consideration of the case of the existing LTE system, but may be extended and applied to next-generation systems (e.g., NR systems, etc.). Further, a description related to NB-IoT in the present disclosure may be extended and applied to machine type communication (MTC) aiming for similar technical purposes (e.g., low-power, low-cost, coverage enhancement, etc.).

1) Frame Structure and Physical Resource of NB-IoT

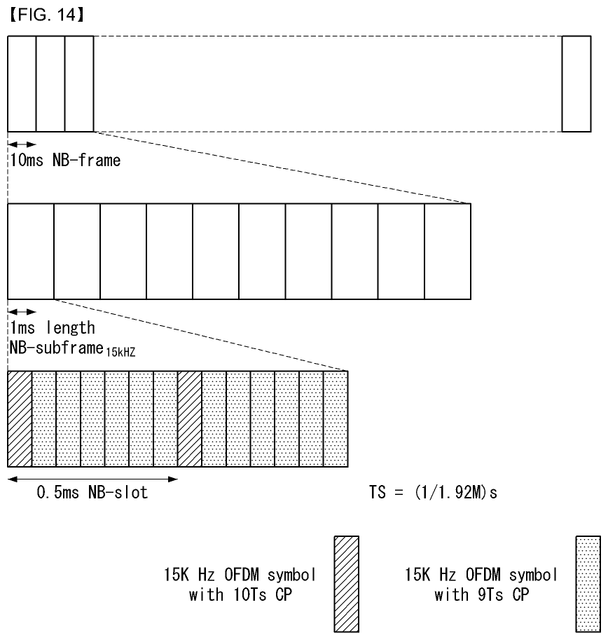

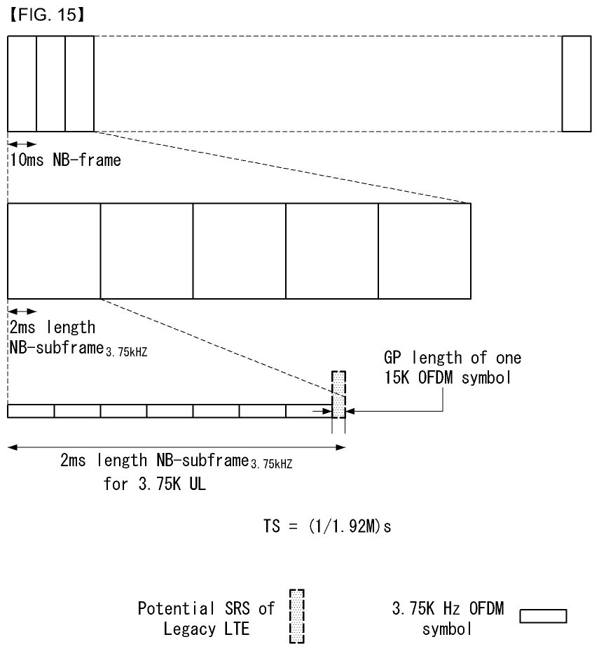

First, the NB-IoT frame structure may be configured differently according to subcarrier spacing. Specifically, FIG. 14 illustrates an example of a frame structure when subcarrier spacing is 15 kHz, and FIG. 15 illustrates an example of a frame structure when subcarrier spacing is 3.75 kHz. However, the NB-IoT frame structure is not limited thereto, and NB-IoT for another subcarrier spacing (e.g., 30 kHz, etc.) may be considered in different time/frequency units.

Further, in the present disclosure, the NB-IoT frame structure based on the LTE system frame structure has been described as an example, but this is for convenience of description and is not limited thereto, and the method described in the present disclosure may be extended and applied to NB-IoT based on a frame structure of a next-generation system (e.g., NR system).

FIGS. 14 and 15 illustrate examples of an NR-IoT frame structure.

Referring to FIG. 14, an NB-IoT frame structure for 15 kHz subcarrier spacing may be configured to the same as a frame structure of the above-described legacy system (i.e., LTE system). That is, a 10 ms NB-IoT frame may include 10 1 ms NB-IoT subframes, and the 1 ms NB-IoT subframe may include 2 0.5 ms NB-IoT slots. Further, each 0.5 ms NB-IoT may include 7 OFDM symbols.

Alternatively, referring to FIG. 15, the 10 ms NB-IoT frame may include 5 2 ms NB-IoT subframes, and the 2 ms NB-IoT subframe may include 7 OFDM symbols and one guard period (GP). Further, the 2 ms NB-IoT subframe may be expressed as an NB-IoT slot or an NB-IoT resource unit (RU).

Next, physical resources of NB-IoT for each of a downlink and an uplink will be described.

First, a physical resource of the NB-IoT downlink may be configured with reference to a physical resource of other wireless communication systems (e.g., LTE system, NR system, etc.), except that a system bandwidth is a certain number of RBs (e.g., 1 RB, 180 kHz). As an example, as described above, when the NB-IoT downlink supports only 15 kHz subcarrier spacing, the physical resource of the NB-IoT downlink may be configured to a resource region in which a resource grid of the LTE system illustrated in FIG. 2 is limited to 1 RB (i.e., 1 PRB) in a frequency domain.

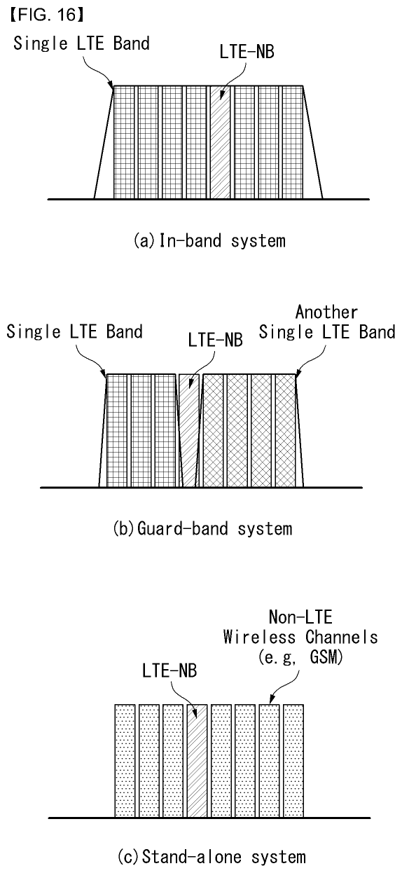

Next, even in the case of the physical resource of the NB-IoT uplink, as in the case of the downlink, the system bandwidth may be limited to one RB. As an example, when the NB-IoT uplink supports 15 kHz and 3.75 kHz subcarrier spacings, as described above, the resource grid for the NB-IoT uplink may be expressed, as illustrated in FIG. 16.

FIG. 16 illustrates an example of a resource grid for an NB-IoT uplink.

In this case, in FIG. 16, the number of subcarriers and the slot period of the uplink band may be given as illustrated in Table 12.

TABLE 12
Subcarrier spacing

[symbol]

[symbol]

indicates data missing or illegible when filed

Further, a resource unit (RU) of the NB-IoT uplink may be configured with SC-FDMA symbols in a time domain and be configured with consecutive subcarriers in a frequency domain. For example, and may be given by Table 13 in case of a frame structure type 1 (i.e., FDD), and be given by Table 14 in case of a frame structure type 2 (i.e., TDD).

TABLE 13

| NPUSCH | | | | |
|---|---|---|---|---|
| format | | | | |
| 1 | 3.75 kHz | 1 | 16 | 7 |
| | 15 kHz | 1 | 16 | |
| | | 3 | 8 | |
| | | 6 | 4 | |
| | | 12 | 2 | |
| 2 | 3.75 kHz | 1 | 4 | |
| | 15 kHz | 1 | 4 | |

TABLE 14

| NPUSCH | | Supported uplink- | | | |
|---|---|---|---|---|---|
| format | | downlink configurations | | | |
| 1 | 3.75 kHz | 1, 4 | 1 | 16 | 7 |
| | 15 kHz | 1, 2, 3, 4, 5 | 1 | 16 | |
| | | | 3 | 8 | |
| | | | 6 | 4 | |
| | | | 12 | 2 | |
| 2 | 3.75 kHz | 1, 4 | 1 | 4 | |
| | 15 kHz | 1, 2, 3, 4, 5 | 1 | 4 | |

2) Physical Channel of NB-IoT

A base station and/or a terminal supporting NB-IoT may be configured to transmit and receive a physical channel and/or a physical signal configured separately from the existing system. Hereinafter, a detailed description related to a physical channel and/or a physical signal supported in NB-IoT will be described.

First, a downlink of the NB-IoT system will be described. An orthogonal frequency division multiple access (OFDMA) scheme may be applied to an NB-IoT downlink based on subcarrier spacing of 15 kHz. Thereby, orthogonality between subcarriers may be provided and thus co-existence with an existing system (e.g., LTE system, NR system) may be efficiently supported.

The physical channel of the NB-IoT system may be expressed in the form in which “N (Narrowband)” is added to distinguish it from the existing system. For example, the downlink physical channel may be defined as a narrowband physical broadcast channel (NPBCH), a narrowband physical downlink control channel (NPDCCH), a narrowband physical downlink shared channel (NPDSCH), and the like, and the downlink physical signal may be defined as a narrowband primary synchronization signal (NPSS), a narrowband secondary synchronization signal (NSSS), a narrowband reference signal (NRS), a narrowband positioning reference signal (NPRS), a narrowband wake up signal (NWUS), and the like.

In general, the downlink physical channel and physical signal of the above-described NB-IoT may be configured to be transmitted based on a time domain multiplexing scheme and/or a frequency domain multiplexing scheme.

Further, characteristically, in the case of NPBCH, NPDCCH, and NPDSCH, which are downlink channels of the NB-IoT system, repetition transmission may be performed for coverage enhancement.

Further, NB-IoT uses a newly defined DCI format, and as an example, the DCI format for NB-IoT may be defined as DCI format NO, DCI format N1, DCI format N2, or the like.

Next, an uplink of the NB-IoT system will be described. A single carrier frequency division multiple access (SC-FDMA) scheme may be applied to the NB-IoT uplink based on subcarrier spacing of 15 kHz or 3.75 kHz. In the uplink of NB-IoT, multi-tone transmission and single-tone transmission may be supported. For example, multi-tone transmission may be supported only for subcarrier spacing of 15 kHz, and single-tone transmission may be supported for subcarrier spacing of 15 kHz and 3.75 kHz.

As described in the downlink part, a physical channel of the NB-IoT system may be expressed in the form in which “N (Narrowband)” is added to distinguish it from the existing system. For example, the uplink physical channel may be defined as a narrowband physical random access channel (NPRACH) and a narrowband physical uplink shared channel (NPUSCH), and the uplink physical signal may be defined as a narrowband demodulation reference signal (NDMRS).

Here, the NPUSCH may be configured with an NPUSCH format 1, an NPUSCH format 2, and the like. For example, the NPUSCH format 1 may be used for UL-SCH transmission (or transport), and the NPUSCH format 2 may be used for UL control information transmission such as HARQ ACK signaling.

Further, characteristically, in the case of an NPRACH, which is a DL channel of the NB-IoT system, repetition transmission may be performed for coverage enhancement. In this case, repetition transmission may be performed by applying frequency hopping.

3) Multi-Carrier Operation of NB-IoT

Next, a multi-carrier operation of NB-IoT will be described. The multi-carrier operation may mean that a plurality of carriers configured to have different uses (i.e., having different types) are used when the base station and/or the terminal transmit and receive a channel and/or a signal to and from each other in NB-IoT.

In general, NB-IoT may operate in a multi-carrier mode, as described above. In this case, in NB-IoT, the carrier may be defined as an anchor type carrier (i.e., anchor carrier, anchor PRB) and a non-anchor type carrier (i.e., non-anchor carrier or non-anchor PRB).

The anchor carrier may mean a carrier that transmits an NPSS, NSSS, NPBCH, and NPDSCH for system information block (N-SIB) for initial access from the viewpoint of the base station. That is, in NB-IoT, a carrier for initial access may be referred to as an anchor carrier, and other(s) may be referred to as a non-anchor carrier. In this case, in the system, only one anchor carrier may exist or a plurality of anchor carriers may exist.

4) Operation Mode of NB-IoT

Next, an operation mode of NB-IoT will be described. In the NB-IoT system, three operation modes may be supported. FIG. 16 illustrates an example of operation modes supported in an NB-IoT system. In the present disclosure, the operation mode of NB-IoT is described based on the LTE band, but this is only for convenience of description, and may be extended and applied to a band of another system (e.g., NR system band).

Specifically, FIG. 16(a) illustrates an example of an in-band system, FIG. 16(b) illustrates an example of a guard-band system, and FIG. 16(c) illustrates an example of a stand-alone system. In this case, the in-band system may be expressed in an in-band mode, the guard-band system may be expressed in a guard-band mode, and the stand-alone system may be expressed in a stand-alone mode.

The in-band system may mean a system or mode that uses a specific 1 RB (i.e., PRB) in a (legacy) LTE band for NB-IoT. The in-band system may be operated by allocating some resource blocks of an LTE system carrier.

The guard-band system may refer to a system or mode using NB-IoT in a space reserved for a guard-band of a (legacy) LTE band. The guard-band system may be operated by allocating a guard-band of an LTE carrier that is not used as a resource block in the LTE system. As an example, the (legacy) LTE band may be configured to have a guard-band of at least 100 kHz at the end of each LTE band. To use 200 kHz, two non-contiguous guard-bands may be used.

As described above, the in-band system and the guard-band system may be operated in a structure in which NB-IoT coexists in the (legacy) LTE band.

Alternatively, the standalone system may mean a system or a mode configured independently from a (legacy) LTE band. The standalone system may be operated by separately allocating a frequency band (e.g., a GSM carrier reassigned in the future) used in a GSM EDGE Radio Access Network (GERAN).

The above-described three operation modes may be operated independently, or two or more operation modes may be combined and operated.

5) General Signal Transmission and Reception Procedure of NB-IoT

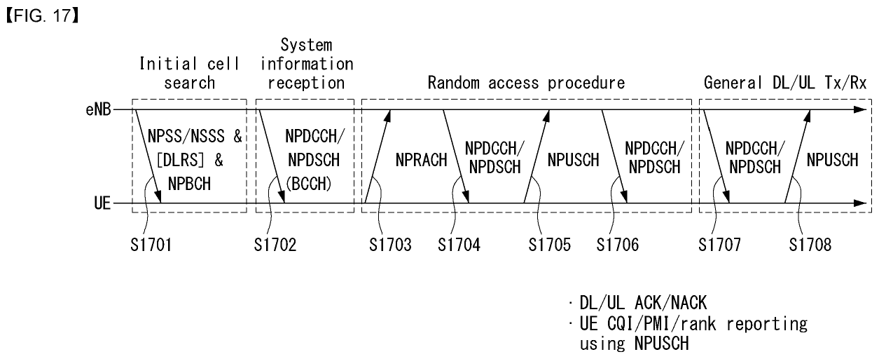

FIG. 17 is a diagram illustrating an example of physical channels that may be used for NB-IoT and a general signal transmission method using the physical channels. In a wireless communication system, an NB-IoT terminal may receive information from the base station through a downlink (DL), and the NB-IoT terminal may transmit information to the base station through an uplink (UL). In other words, in a wireless communication system, the base station may transmit information to the NB-IoT terminal through a downlink, and the base station may receive information from the NB-IoT terminal through an uplink.

The information transmitted and received by the base station and the NB-IoT terminal includes data and various control information, and various physical channels may exist according to the type/use of information transmitted and received by the base station and the NB-IoT terminal. Further, a method of transmitting and receiving a signal of NB-IoT described with reference to FIG. 17 may be performed by a wireless communication device.

An NB-IoT terminal that is powered on again while power is turned off or newly entered a cell may perform an initial cell search operation such as synchronizing with the base station (S1701). To this end, the NB-IoT terminal may receive an NPSS and NSSS from the base station, perform synchronization with the base station, and obtain information such as a cell identity (cell ID). Further, the NB-IoT terminal may receive the NPBCH from the base station to obtain intra-cell broadcast information. Further, the NB-IoT terminal may receive a downlink reference signal (DL RS) in the initial cell search step to check a downlink channel state.

In other words, when there is an NB-IoT terminal newly entering the cell, the base station may perform an initial cell search operation such as synchronizing with the corresponding terminal. The base station transmits an NPSS and NSSS to the NB-IoT terminal to perform synchronization with the corresponding terminal and transmit information such as a cell identity (cell ID). Further, the base station may transmit (or broadcast) the NPBCH to the NB-IoT terminal to deliver intra-cell broadcast information. Further, the base station may transmit a DL RS to the NB-IoT terminal in the initial cell search step to check a downlink channel state.

The NB-IoT terminal, having finished an initial cell search may receive an NPDCCH and a corresponding NPDSCH to obtain more detailed system information (S1702). In other words, the base station may transmit the NPDCCH and the corresponding NPDSCH to the NB-IoT terminal that has finished initial cell search to transmit more specific system information.

Thereafter, in order to complete access to the base station, the NB-IoT terminal may perform a random access procedure (S1703 to S1706).

Specifically, the NB-IoT terminal may transmit a preamble to the base station through an NPRACH (S1703), and as described above, the NPRACH may be configured to be repeatedly transmitted based on frequency hopping or the like for coverage enhancement. In other words, the base station may (repeatedly) receive a preamble from the NB-IoT terminal through the NPRACH.

Thereafter, the NB-IoT terminal may receive a random access response (RAR) for the preamble from the base station through an NPDCCH and the corresponding NPDSCH (S1704). In other words, the base station may transmit an RAR for the preamble to the NB-IoT terminal through the NPDCCH and the corresponding NPDSCH.

Thereafter, the NB-IoT terminal may transmit an NPUSCH to the base station using scheduling information in the RAR (S1705), and perform a contention resolution procedure such as the NPDCCH and the corresponding NPDSCH (S1706). In other words, the base station may receive an NPUSCH from the terminal using the scheduling information in the NB-IoT RAR and perform the contention resolution procedure.

After performing the above-described procedure, the NB-IoT terminal may perform NPDCCH/NPDSCH reception (S1707) and NPUSCH transmission (S1708) as a general uplink/downlink signal transmission procedure. In other words, after performing the above-described procedures, the base station may perform NPDCCH/NPDSCH transmission and NPUSCH reception as a general signal transmission and reception procedure to the NB-IoT terminal.

In the case of NB-IoT, as described above, the NPBCH, NPDCCH, NPDSCH, etc. may be repeatedly transmitted to enhance coverage. Further, in the case of NB-IoT, UL-SCH (i.e., general uplink data) and uplink control information may be transmitted through the NPUSCH. In this case, the UL-SCH and uplink control information may be configured to be transmitted through different NPUSCH formats (e.g., NPUSCH format 1, NPUSCH format 2, etc.).

Further, control information transmitted from the terminal to the base station may be referred to as uplink control information (UCI). UCI may include hybrid automatic repeat and request acknowledgement/negative-ACK (HARQ ACK/NACK), a scheduling request (SR), channel state information (CSI), and the like. CSI includes a channel quality indicator (CQI), a precoding matrix indicator (PMI), a rank indication (RI), and the like. As described above, in NB-IoT, UCI may be generally transmitted through the NPUSCH. Further, according to a request/indication from the network (e.g., base station), the UE may transmit UCI through the NPUSCH in a perdiodic, aperdiodic, or semi-persistent manner.

Hereinafter, techniques/methods proposed in the present disclosure are classified for convenience of description, and some components of a technique/method may be substituted with components of other techniques/methods or may be combined and applied to each other.

When designing an NB-IoT system for an LTE system, channel raster offset may be generated between an anchor PRB and a channel raster. Further, the channel raster offset may be configured to a value of {+2.5 kHz, −2.5 kHz, +7.5 kHz, −7.5 kHz}, and information on the channel raster offset may be delivered through a master information block (MIB)-narrowband (NB) of the NPBCH. Here, the channel raster represents a minimum unit for reading a downlink synchronization signal when the terminal (e.g., UE) performs an initial access procedure or the like.

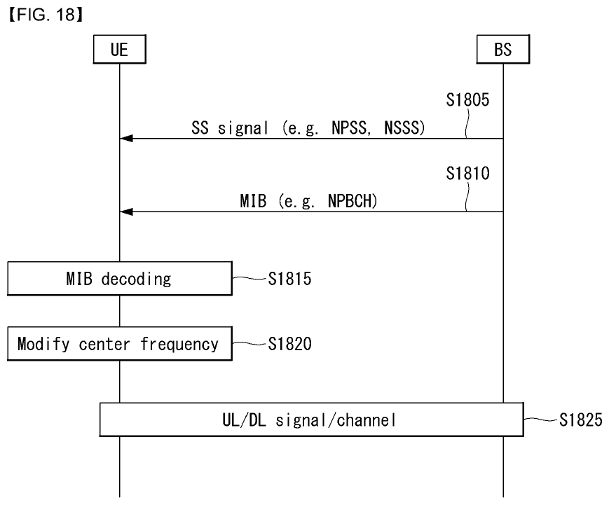

FIG. 18 illustrates an example of signaling related to transmission and reception of channel raster offset information. FIG. 18 is merely for convenience of description and does not limit the scope of the present disclosure. Referring to FIG. 18, names of channels and signals are referred to based on the content of NB-IoT, but this is only for convenience of description, and the content described in FIG. 18 may also be applied to a method for MTC.

A user equipment (UE) may initially detect, monitor, and/or receive a synchronization signal (e.g., NPSS, NSSS) transmitted by the base station (BS) at intervals of channel raster (S1805). In this case, the UE cannot know how much a channel raster offset value the corresponding synchronization signal has.

The UE may receive broadcast information (e.g., Master Information Block (MIB), MIB-NB) including information on the channel raster offset value from the BS through a broadcast channel (e.g., NPBCH) (S1810).

The UE may receive a (N) PBCH and decode the broadcast channel to receive (i.e., obtain) a channel raster offset value (S1815).

The terminal may apply the channel raster offset value indicated by the BS to modify a DL/UL center frequency (S1820). Thereafter, the UE and/or the BS may perform transmission and reception of an UL/DL signal and/or a channel in a situation where there is no channel raster offset based on the modified center frequency (S1825).

Hereinafter, in the present disclosure, when the NB-IoT system and/or the (e) MTC system coexist(s) with the NR system, a method of transmitting information on the channel raster offset in relation to the above-described channel raster offset and a processing method when there is a frequency resource (e.g., subcarrier) remaining by the channel raster offset will be described in detail.

Embodiments to be described below are only classified for convenience of description, and some elements of one embodiment may be substituted with some elements of another embodiment or may be combined and applied to each other.

### Embodiment 1

First, in the first embodiment, a method(s) of transmitting information on channel raster offset that may occur when an NB-IoT system coexists with an NR system will be described.

In the case of an LTE system, the channel raster may be set to a value of 100 kHz. In the case of the LTE system, the UE may sequentially monitor a frequency value equal to an available minimum frequency bandwidth (e.g., 6 RB, 1.08 MHz) at intervals of channel raster (e.g., 100 kHz). In the case of the NB-IoT system, the UE may sequentially monitor a frequency value equal to an available minimum frequency bandwidth (1 RB, 180 kHz) at intervals of channel raster (e.g., 100 kHz). For example, in the case of the NB-IoT system, there may be four values of channel raster offset {+2.5 kHz, −2.5 kHz, +7.5 kHz, −7.5 kHz}.

Similarly, in order to coexist the NB-IoT system and the enhanced-MTC (eMTC) system in the NR system, it is necessary to align an NR PRB boundary, and channel raster offset may be generated accordingly. In this case, it may be necessary to notify this information through the MIB-NB and/or MIB.

In this case, the channel raster offset means offset between a center point of a bandwidth at which an actual synchronization signal is transmitted and a channel raster in which the UE is monitoring, and may be configured to select the smallest value for each system bandwidth.

Hereinafter, subcarrier spacing of the NR system considered in the present disclosure targets 15 kHz, but methods described below may be applied equally to other subcarrier spacings (e.g., 30 kHz, 60 kHz, etc.).

Unlike the LTE system, in the case of the NR system, a direct current (DC) subcarrier does not exist. Instead, a subcarrier serving as an RF reference frequency (i.e., channel raster position) may be defined as illustrated in Table 15.

TABLE 15
Resource element index

| | |
|---|---|
| 0 | 6 |

Physical resource block number

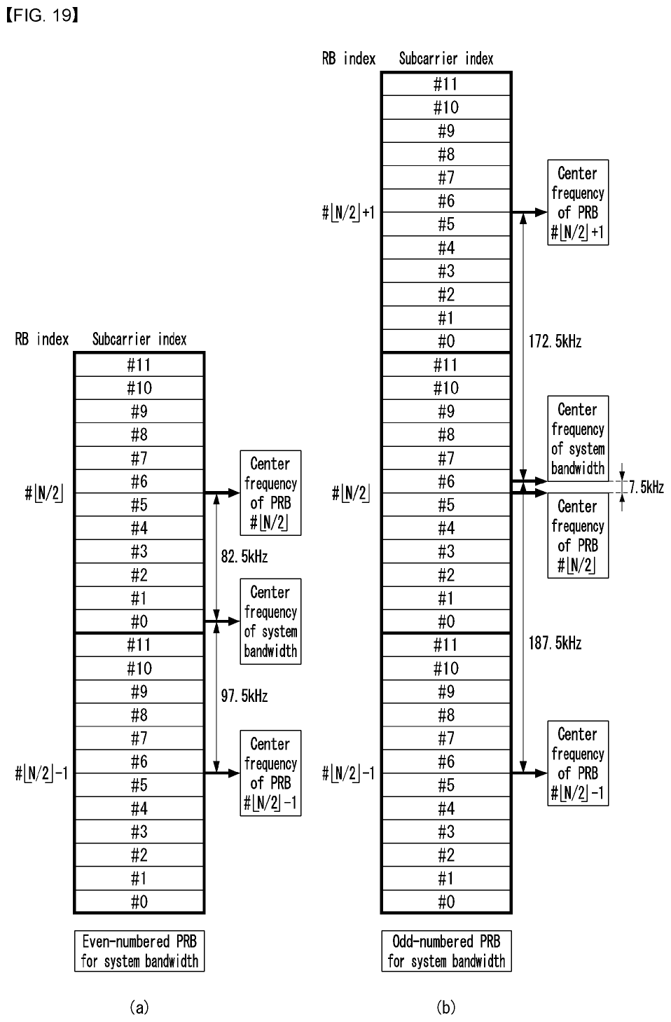

FIG. 19 illustrates an example of a center frequency in an NR system. FIG. 19 is merely for convenience of description and does not limit the scope of the present disclosure.

Specifically, FIG. 19(a) illustrates an example of a center frequency when the number of PRBs constituting a system bandwidth is an even number, and FIG. 19(b) illustrates an example of a center frequency when the number of PRBs constituting a system bandwidth is an odd number.

Referring to FIG. 19, it is assumed that the number of resource blocks (RBs), that is, physical resource blocks (PRBs) constituting the system bandwidth, is N. When the number of PRBs of an NR system bandwidth is an even number, a position of a 0th subcarrier (#0 subcarrier) of the PRB having an RB index of [N/2] may serve as the center frequency of the system bandwidth (e.g., DC subcarrier role of LTE system). In this case, as illustrated in FIG. 19(a), the center frequency may be positioned at a point of +7.5 kHz from the center of the NR system bandwidth. Similarly, when the number of PRBs of the NR system bandwidth is an odd number, a position of a sixth subcarrier (#6 subcarrier) of the PRB having an RB index of [N/2] may serve as a center frequency of the system bandwidth. In this case, as illustrated in FIG. 19(b), the center frequency may be positioned at a point of +7.5 kHz from the center of the NR system bandwidth.

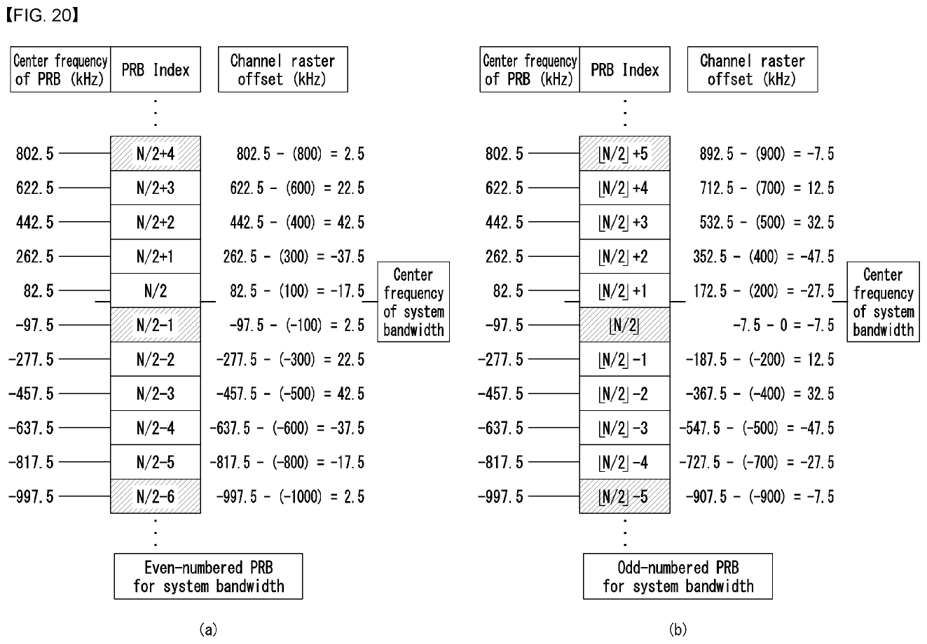

As described above (e.g., as illustrated in FIG. 19), as the center frequency of the NR system is defined, the channel raster offset of the NB-IoT system may be configured and/or determined as illustrated in FIG. 20.

FIG. 20 illustrates an example of calculating channel raster offset of an NB-IoT system when the NR system and the NB-IoT system coexist. FIG. 20 is merely for convenience of description and does not limit the scope of the present disclosure.

Specifically, FIG. 20(a) illustrates calculation of channel raster offset when the number of PRBs constituting a system bandwidth is an even number, and FIG. 20(b) illustrates calculation of channel raster offset when the number of PRBs constituting a system bandwidth is an odd number. Referring to FIG. 20(a), the center frequency of the PRB represents the center frequency of each PRB constituting a system bandwidth of the NR system, and as described in FIG. 19(a), the center frequency of the system bandwidth may be positioned above by a predetermined frequency (e.g., 7.5 kHz) from the center of the system bandwidth. Further, referring to FIG. 20(b), the center frequency of the PRB represents the center frequency of each PRB constituting a system bandwidth of the NR system, and as described in FIG. 19(b), the center frequency of the system bandwidth may be positioned above by a predetermined frequency (e.g., 7.5 kHz) from the center of the system bandwidth.

As illustrated in FIG. 20(a), when the NR system bandwidth is configured with an even number of PRBs, channel raster offset of +2.5 kHz may occur. As illustrated in FIG. 20(b), when the NR system bandwidth is configured with an odd number of PRBs, channel raster offset of −7.5 kHz may occur.

That is, assuming that the total number of PRBs existing in the NR system bandwidth is N, in the case of an even number of RBs as illustrated in FIG. 20(a), a channel raster offset value of the PRBs corresponding to { . . . , N/2−6, N/2−1, N/2+4, . . . } index may be 2.5 kHz. Similarly, in the case of an odd number of RBs as illustrated in FIG. 20(b), a channel raster offset value of PRBs corresponding to { . . . , [N/2]−5, [N/2], [N/2]+5, . . . } may be −7.5 kHz.

It is assumed that the NB-IoT system existing in a band of the NR system is set to operate in an in-band mode or a guard-band mode. In this case, a method of indicating appropriate channel raster offset to the UE among the above-described {+2.5 kHz and −7.5 kHz} by the BS using a field existing in the existing MIB-NB may be considered. Thereafter, the UE may receive channel raster offset information broadcast by the BS through the (N)PBCH. Thereafter, the UE may apply channel raster offset indicated by the BS to perform transmission and reception of a subsequent DL/UL signal and/or channel (e.g., see the above-described procedure in FIG. 18).

However, in the case of a specific frequency band (e.g., NR frequency band) and when the NB-IoT system is configured to operate in a standalone mode, channel raster offset including at least {+2.5 kHz, −7.5 kHz} may be transmitted through a broadcast signal (e.g., (N)PBCH, etc.). Here, the broadcast signal may be configured in the form of the MIB or MIB-NB. Further, the channel raster offset may be configured in the form of {+2.5 kHz, −7.5 kHz} through a 1-bit field. When the UE (e.g., NB-IoT UE) receives an indication of +2.5 kHz channel raster offset information (from the BS), the UE may know that the number of system band PRBs of the NR system coexisting with the NB-IoT system is an even number. Conversely, when the UE (e.g., NB-IoT UE) receives an indication of −7.5 kHz channel raster offset information, the UE may know that the number of system band PRBs of the NR system coexisting with the NB-IoT system is an odd number.

### Embodiment 2

In the above-described first embodiment, a method for coexisting an NB-IoT system and an NR system in an LTE system without affecting pre-defined rules, configurations, and/or definitions for the NR system has been described. However, in a specific situation, a problem (e.g., a separate indication is required in a standalone mode) may occur in which the existing NB-IoT UE (e.g., legacy NB-IoT UE) cannot be supported in the LTE system. Accordingly, in the present embodiment, a method of enabling an existing NR-IoT UE to be supported in an LTE system under any circumstances will be described.

The LTE system band may be re-farmed and the NR BS (e.g., NR gNB) may be configured to generate both an NB-IoT signal for an existing NB-IoT UE and an NR signal for a new NR UE. In this case, in order to generate an NB-IoT signal and an NR signal in one Inverse Fast Fourier Transform (IFFT), the NR BS needs to match subcarrier spacing grids of the NB-IoT signal and the NR signal.

When the subcarrier spacing grids do not match, the NR BS may have the burden that first performs IFFT on the NR signal and that separately performs IFFT on the NB-IoT signal and that merges and transmits them in a time domain. Therefore, in order to match subcarrier spacing grids for signals of two different systems, the system may be designed with offset of +7.5 kHz or −7.5 kHz from the channel raster in the NR system. Thereafter, for an NR UE accessed through an initial access process, a method may be considered in which the NR BS indicates channel raster offset, that is, +7.5 kHz or −7.5 kHz to the UE through a PSS, SSS, PBCH, MIB, and/or SIB.

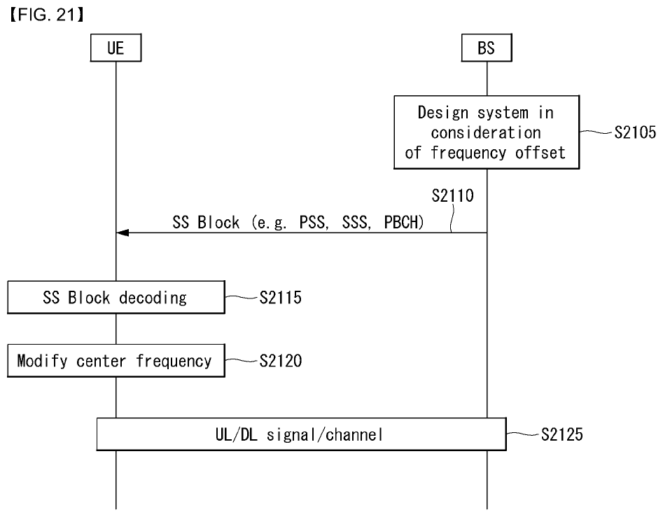

FIG. 21 illustrates an example of signaling related to transmission and reception of information on frequency offset applied to an NR system. FIG. 21 is merely for convenience of description and does not limit the scope of the present disclosure.

In order to match subcarrier spacing grids for signals of two different systems, as described above, the BS (e.g., NR BS, gNB) may design a system with offset of +7.5 kHz or −7.5 kHz from the channel raster in the NR system (S2105).

Thereafter, the BS may transmit a synchronization signal block (SS Block) to the UE (e.g., NR UE) on the designed system (S2110). The SS block includes a PSS, SSS, and/or PBCH, and the like, and the BS may be configured to transmit a preset (or designed) channel raster offset value (e.g., +7.5 kHz, −7.5 kHz, etc.) to the UE through the corresponding SS block.

The UE may decode the corresponding SS block (i.e., PSS, SSS, and/or PBCH) (S2115), thereby obtaining (or receiving) a channel raster offset value. The UE may apply a channel raster offset value obtained (i.e., indicated) from the BS to modify a center frequency for DL/UL transmission and reception (S2120). Thereafter, the UE and/or the BS may perform transmission and reception of a DL/UL signal and/or a channel in a situation where there is no channel raster offset (S2125).

The channel raster offset may be configured to be indicated through 1-bit information included in the MIB, or may be configured to be indicated through 1-bit information included in remaining minimum system information (RMSI). Alternatively, the NR BS may be configured to indicate (e.g., on/off) whether a channel raster shift has occurred through 1-bit information such as the MIB and/or RMSI. In this case, a channel raster shift value may always be configured to be fixed at +7.5 kHz or −7.5 kHz. Alternatively, a channel raster shift value may be shifted into a specific value according to an NR Absolute Radio Frequency Channel Number (NR-ARFCN) value, and the corresponding value may be configured by a predefined rule (e.g., 3gpp standard). Even in this case, the specific value may be +7.5 kHz or −7.5 kHz.

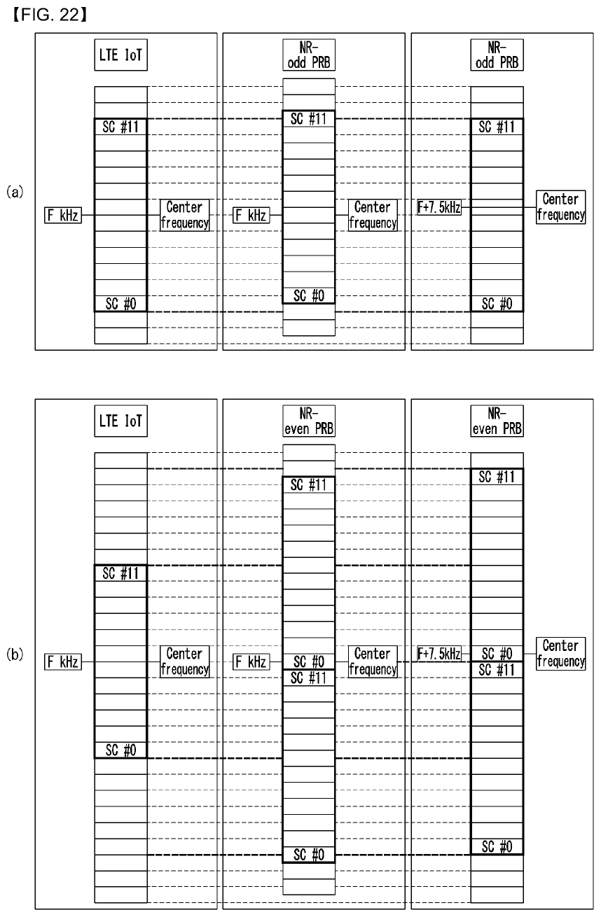

FIG. 22 illustrates an example of subcarrier spacing grid alignment between an LTE NB-IoT system and an NR system. FIG. 22 is merely for convenience of description and does not limit the scope of the present disclosure.

Specifically, FIG. 22(a) illustrates an example of subcarrier spacing grid alignment when the number of PRBs constituting a system bandwidth of the NR system is an odd number, and FIG. 22(b) illustrates an example of subcarrier spacing grid alignment when the number of PRBs constituting a system bandwidth of the NR system is an even number.

For example, FIGS. 22(a) and 22(b) are examples of a method of matching the NR system and the subcarrier spacing grid when the NB-IoT UE operates in a standalone mode. In the case of the NB-IoT standalone mode, an NB-IoT anchor carrier using a frequency position existing at every 100 kHz as a center frequency may be designated.

Referring to FIGS. 22(a) and 22(b), it is illustrated that the NB-IoT anchor carrier has configured F kHz (here, F is a multiple of 100 kHz, e.g., F=2000 kHz) as the center frequency. Further, when the center frequency of the NR carrier is configured equally to F kHz, it is illustrated differently according to whether the number of PRBs of the NR system bandwidth is an odd number or even number. In both cases, the subcarrier spacing grids are matched between the two systems using+7.5 kHz shift, but the RB grids (i.e., PRB grids) are not matched when the number of PRBs is an even number (i.e., FIG. 22(b)).

In the current NR system, when the NR BS performs scheduling of a control channel (CCH)/data channel (shared channel (SCH)) of a specific UE, the RB level rate-matching may be used. In the case of FIG. 22(a), it is not a problem because the PRB grids are completely matched between the two systems, but in the case of FIG. 22(b), because the PRB grids do not match between the two systems, the NR system has to lose one PRB.

Accordingly, a method of improving a performance of the NR UE coexisting with the NB-IoT system in the LTE system by introducing rate-matching of a half RB level to the NR system may be considered.

In this case, rate-matching of the half RB level may be introduced in the form of a bitmap, and may be indicated to add an upper half or a lower half to a bitmap of the existing RB level rate-matching. For example, when the bitmap of rate-matching of the existing RB level indicates on/off at the RB level using 0 and 1, a method in which rate-matching of the half RB level indicates one of 4 states such as {0, 1, j (e.g., upper half (i.e., use SC #6 to SC #11)),−j (e.g., lower half (i.e., use SC #0 to SC #5))} may be considered. Further, the above-described method may be applied to a coexistence situation for eMTC.

Further, when the NR BS schedules a control channel (CCH)/data channel (SCH) for a specific UE in the NR system, rate-matching of the RE level may be considered. In particular, when configuring to a full level, a signaling overhead may occur and thus rate-matching of a non-full RE level may be considered. Specifically, REs that may be used by a corresponding UE within a specific PRB always exist adjacent to each other, and REs that cannot be used need to always exist adjacent to each other.

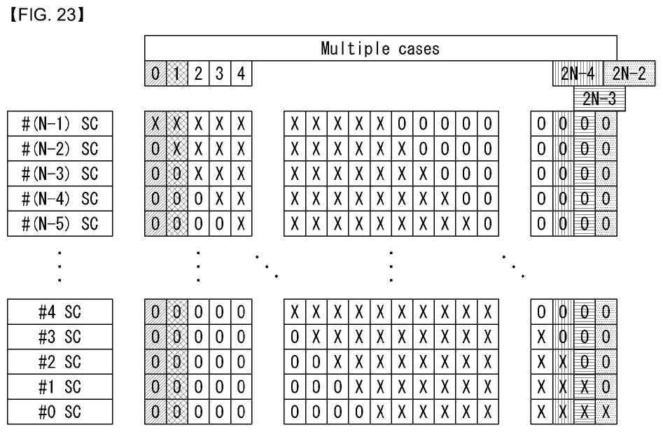

FIG. 23 illustrates an example of rate-matching of non-total RE levels. FIG. 23 is merely for convenience of description and does not limit the scope of the present disclosure.

Referring to FIG. 23, when the total number of subcarriers is N, it may also be configured that the total number of rate-matching combinations of the RE level that may be indicated by the above-described method is (N−1)*2 and that some of them are actually used.

Further, as a method of indicating the above-described rate-matching combination of the RE level, a method of indexing each case and directly indicating may be considered, but as the BS notifies the UE of information about whether the BS may use a start RE (e.g., #0 RE) and whether to use is changed in which RE, the same result as the above method of indexing and directly indicating may occur. For example, when #0 RE is available and it is indicated to reverse use in #(N−2) RE, it may be set to be the same as an indication of a case 1 (i.e., case #1) of FIG. 23. Rate-matching of the RE level may be introduced in the form of a bitmap or may be additionally indicated through a bitmap of rate-matching of the existing RB level.

The above-described method enables rate-matching of a sub-PRB level in the NR system, so that there is an advantage that the NR system can efficiently manage resources when the NB-IoT system or the eMTC system and the NR system coexist.

### Embodiment 3

Hereinafter, in the present embodiment, methods of transmitting information on channel raster offset when an eMTC system coexists with an NR system, a method of utilizing remaining resources by channel raster offset, and the like will be described.

Methods described below are only classified for convenience of description, and some components of one method may be substituted with some components of another method, or may be merged and applied to each other.

(Method 1)

In the case of an eMTC system, when an NR system bandwidth is configured with an odd number of PRBs (i.e., RBs), +10 kHz or −10 kHz channel raster offset occurs, and when an NR system bandwidth is configured with an even number of PRBs (i.e., RBs), channel raster offset (i.e., channel raster offset=0 kHz) may not occur.

FIG. 24 illustrates an example of calculating channel raster offset of an eMTC system when an NR system and the eMTC system coexist. FIG. 24 is merely for convenience of description and does not limit the scope of the present disclosure.

Referring to FIG. 24, a narrowband (NB) of the eMTC system is configured with 6 PRBs, and each of channel raster offsets for configurable NBs may be calculated. Further, as a DC subcarrier (i.e., DC subcarrier of eMTC anchor NB) exists at the center of each NB, one NB may be configured with total 73 subcarriers. That is, an error corresponding to one subcarrier may occur between PRBs and NB of the NR system.

In particular, in the case of FIG. 24, it is assumed that DC subcarriers in each NB are aligned at a position of a 0th subcarrier (#0 subcarrier) of a PRB of the NR system.

It is assumed that the total number of PRBs existing in an NR system bandwidth is N. When the NR system bandwidth is configured with an odd number of PRBs, as illustrated in FIG. 24A, a channel raster offset value for NBs corresponding to { . . . , [N/2]-8 to [N/2]-3, [N/2]-3 to [N/2]+2, [N/2]+2 to [N/2]+7, . . . } is 10 kHz, and a channel raster offset value for NBs corresponding to { . . . , [N/2]−7 to [N/2]−2, [N/2]−2 to [N/2]+3, [N/2]+3 to [N/2]+8, . . . } may be −10 kHz. Similarly, when the NR system bandwidth is configured with an even number of PRBs, as illustrated in FIG. 24(b), there is no channel raster offset value for NBs corresponding to { . . . , N/2-8 to N/2-3, N/2-3 to N/2+2, N/2+2 to N/2+7, . . . }.

Accordingly, in the case of a specific (e.g., NR system) frequency band, a method of transmitting information on channel raster offset including at least {−10 kHz, 0 kHz, 10 kHz} through a specific broadcast signal or the like may be considered. That is, the BS (e.g., the BS supporting the LTE system) may transmit information on channel raster offset consisting of {−10 kHz, 0 kHz, 10 kHz} to the UE through a broadcast method. Here, a specific broadcast signal may be configured in the form of MIB, and information on the channel raster offset may be configured in the form of {−10 kHz, 0 kHz, 10 kHz, spare} through a 2-bit field.

(Method 2)

Further, because an NB having 10 kHz offset and an NB having −10 kHz offset among the above-described −10 kHz or +10 kHz channel raster offset are right next to each other, a method of configuring to allow only one of the two may be considered.

For example, it may be configured that an NB having −10 kHz as channel raster offset cannot be an anchor NB, and only an NB having 10 kHz as channel raster offset and an NB without channel raster offset may be configured as an anchor NB. In this case, a method may be used in which the BS transmits and/or indicates channel raster information of {0, +10 kHz} using only a 1-bit field (i.e., 1-bit information) through the MIB. The above method may be a great advantage when considering the MIB with a narrow space for transmitting information.

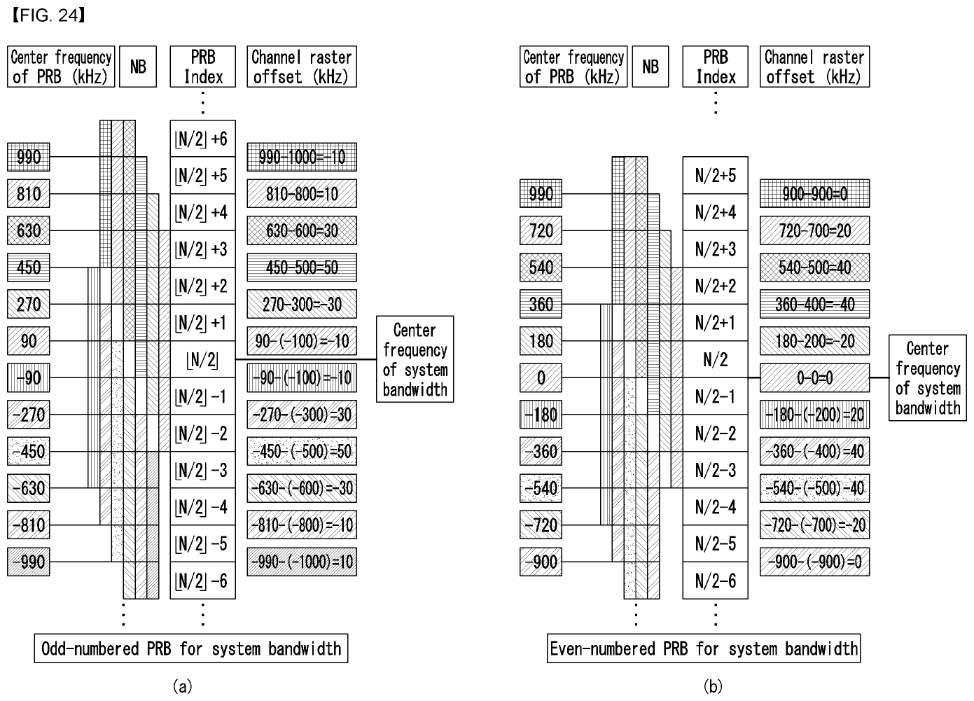

In particular, when the number of PRBs constituting an NR system bandwidth is an odd number, this is because an occurrence cause of channel raster offset of −10 kHz and 10 kHz is set to map (i.e., align) a position of a DC subcarrier of an eMTC anchor NB to a 0th subcarrier (#0 subcarrier) of a specific PRB existing in the NR system. When the number of PRBs constituting an NR system bandwidth is an odd number, if the position of a DC subcarrier of an eMTC anchor NB is configured to map to an 11th subcarrier (#11 subcarrier) of a specific PRB existing in the NR system, channel raster offset of −5 kHz may occur, as illustrated in FIG. 25.

FIG. 25 illustrates another example of calculating channel raster offset of an eMTC system when an NR system and the eMTC system coexist. FIG. 25 is merely for convenience of description and does not limit the scope of the present disclosure.

In particular, in the case of FIG. 25, it is assumed that the number of PRBs constituting the NR system bandwidth is an odd number, and that DC subcarriers of each NB (i.e., the DC subcarrier of the eMTC anchor NB) are aligned at a position of an 11th subcarrier (#11 subcarrier) of the PRB of the NR system.

Therefore, it may be desirable to differently configure a criterion for mapping a position of the DC subcarrier of the eMTC anchor NB to a specific subcarrier of the NR system in the case where the number of PRBs of the NR system bandwidth is an even number and an odd number. For example, when the number of PRBs of the NR system bandwidth is an even number, the position of the DC subcarrier of the eMTC anchor NB may be configured to be mapped to a 0th subcarrier (#0 subcarrier) of a specific PRB existing in the NR system, and when the number of PRBs of the NR system bandwidth is an odd number, the position of the DC subcarrier of the eMTC anchor NB may be configured to be mapped to an 11th subcarrier (#11 subcarrier) of a specific PRB existing in the NR system.

When configuring in this way, a method of transmitting information on channel raster offset including at least {0 kHz, −5 kHz} through a specific broadcast signal or the like may be considered. That is, the BS (e.g., the BS supporting the LTE system) may transmit information on channel raster offset consisting of {OkHz, −5 kHz} to the UE through a broadcast method. Here, the specific broadcast signal may be configured in the form of a MIB, and information on the channel raster offset may be configured in the form of {OkHz, −5 kHz} through a 1-bit field. This method has an advantage of saving the field of the MIB.

(Method 3)

Further, when a channel raster offset value is set, as in the above-described methods, it is necessary to consider a method for indicating a channel raster offset value and/or an operation mode of the UE through the MIB. In this case, a method of notifying a channel raster offset value and a standalone mode using a reserved state that is not used among several fields included in the existing MIB (i.e., legacy MIB) may be considered. In this case, a legacy eMTC operation may be referred to as an in-band mode.

For example, in the existing MIB, a 3-bit field for transmitting an LTE system bandwidth uses only 6 states of {n6, n15, n25, n50, n75, n100}. Thus, there are two reserved states, which may be used for delivering channel raster offset information (e.g., {0 kHz, −5 kHz}). That is, when the corresponding 3-bit field is expressed in a table, it may be illustrated as in Table 16.

TABLE 16

| | LTE System bandwidth | Operation | Channel |
|---|---|---|---|
| State | (number of RBs) | mode | raster offset |
| 000 | 6 | In-band | N/A |
| 001 | 15 | In-band | N/A |
| 010 | 25 | In-band | N/A |
| 011 | 50 | In-band | N/A |
| 100 | 75 | In-band | N/A |
| 101 | 100 | In-band | N/A |
| 110 | N/A | Standalone | 0 kHz |
| 111 | N/A | Standalone | −5 kHz |

Referring to Table 16, when the UE is indicated to be one of states 000 to 101, the UE may understand that it is an existing eMTC operation (i.e., legacy eMTC operation). However, when the UE is indicated to be one of states 110 and 111, the UE may understand that it is a standalone mode operation other than an in-band mode (i.e., LTE in-band). Further, in this case, as indicated to have one channel raster offset value of 0 kHz and −5 kHz, the UE may recognize that it belongs to a band of the NR system.

Further, when the UE is indicated to have 0 kHz channel raster offset, the UE may know that the number of PRBs constituting the NR system bandwidth is an odd number. However, when the UE is indicated to have −5 kHz channel raster offset, the UE may know that the number of PRBs constituting the NR system bandwidth is an even number.

In the case of using the above method, there is an advantage that the MIB does not need to include an additional field for notifying channel raster offset. Further, when the existing UEs (i.e., legacy eMTC UEs) receive a state 110 or 111, the UE has an advantage of being able to determine that the existing UE (i.e., legacy eMTC UE) cannot enter the corresponding cell.

(Method 4)

Further, when eMTC coexists in an NR system in which the number of PRBs constituting an NR system bandwidth is an odd number, there may also be considered a method of configuring to locate a DC subcarrier of eMTC to the subcarrier serving as the center frequency of the NR system so that channel raster offset does not occur, as described above.

For example, in an NR system in which the number of PRBs constituting the NR system bandwidth is an odd number, a position of a 6th subcarrier (#6 subcarrier) of a PRB whose PRB index (i.e., RB index) is [N/2] may serve as a center frequency of the system bandwidth. Accordingly, it may be configured to locate (i.e., map) a DC subcarrier for eMTC (i.e., a DC subcarrier of the eMTC anchor NB) in the corresponding subcarrier.

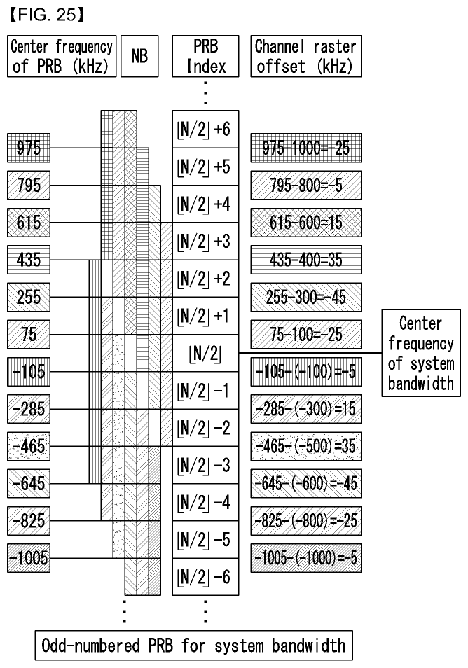

FIG. 26 illustrates another example of calculating channel raster offset of an eMTC system when an NR system and the eMTC system coexist. FIG. 26 is merely for convenience of description and does not limit the scope of the present disclosure.

In particular, in the case of FIG. 26, it is assumed that the number of PRBs constituting an NR system bandwidth is an odd number, and that DC subcarriers (i.e., the DC subcarrier of the eMTC anchor NB) of each NB are aligned to a position of a 6th subcarrier (#6 subcarrier) of the PRB of the NR system.

In this case, due to the characteristics of the NR system having an odd number of PRBs, the method may have a burden of having to provide 73 subcarriers among 7 PRBs of the NR system for eMTC. However, because a channel raster offset value of the eMTC UE is 0, there is an advantage of preventing deterioration of an initial acquisition performance. Additionally, in the NR system, in the case where the BS performs scheduling in a symbol level, an RE level, and/or a subcarrier spacing level or is configured to perform rate-matching, the effect on the NR band may be similar to the above-described other methods. Accordingly, there may be an advantage that there is no need to perform additional signaling to the MIB and to preserve a performance of the eMTC UE.

In the existing eMTC system (e.g., legacy eMTC system), a region in which a PSS, SSS, and/or PBCH are transmitted and a region constituting an NB are designated. In the eMTC system coexisting with the NR system, a region in which a PSS, SSS, and/or PBCH are transmitted and a region constituting the NB may be fixed in advance, but for flexibility in scheduling, a method may be considered in which the BS sets one of NBs at a specific location to the UE.

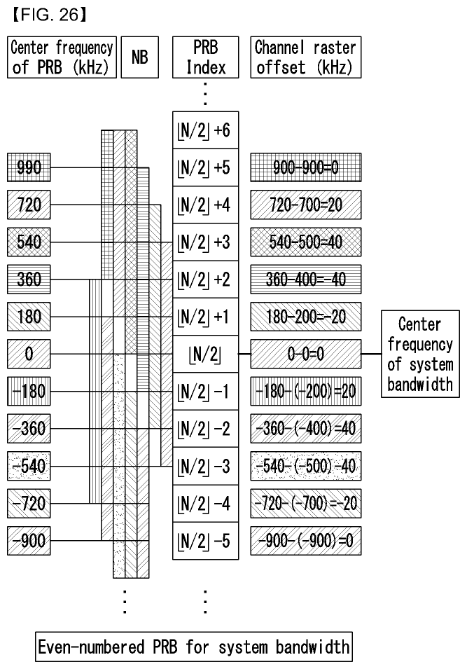

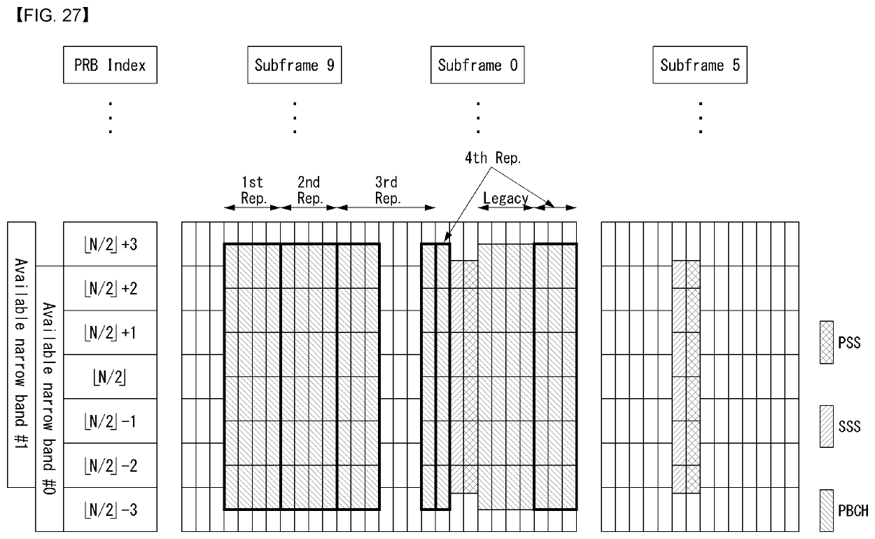

FIG. 27 illustrates an example of a bandwidth and a narrowband for a synchronization signal. FIG. 27 is merely for convenience of description and does not limit the scope of the present disclosure.

Referring to FIG. 27, the BS may configure and/or configure to indicate, to the corresponding UE, a specific NB (e.g., any one of #0 NB and #1 NB) to be used by the UE after initial access. Thereby, after an initial access procedure, the UE may perform narrowband communication in the NB set and/or indicated by the BS.

The above-described method is described based on application to the eMTC system, but it may be extended and applied even when the NB-IoT system coexists with the NR system.

### Embodiment 4

In the above-described third embodiment, a method of configuring an eMTC (and/or NB-IoT) anchor NB by avoiding an SS block has been described. However, in the case of a 5 MHz system (i.e., a system in which a system bandwidth is configured with 25 RB), there is no method for configuring an anchor NB by avoiding an SS block. This is because a region configured to the SS block is 20 RB and a region set to the NB is 6 RB.

Therefore, in order to solve this problem, the anchor PRB or the anchor NB may not be configured to avoid a frequency domain occupied by the SS block in some cases. In this case, the BS may configure and/or indicate, to the UE, a subframe in which an SS block exists as an invalid subframe.

With regard to the configuration and/or indication for an invalid subframe, the BS may be configured to transmit information related to a valid subframe within a specific period to the UE through system information such as a system information block (SIB). Such a procedure may be configured to be performed after an initial access procedure. For example, a valid subframe within X ms may be displayed through Y-bit bitmap information. As a specific example, when X is 40 and one subframe exists in 1 ms, Y may be 40. The UE may determine which subframe is not valid through information related to the valid subframe. Upon receiving the information, the UE may transmit and receive a DL/UL signal and/or a channel in a valid subframe.

Further, instead of a method in which the BS transmits information related to the valid subframe to the UE, as described above, the UE may be configured to regard a specific subframe as invalid. For example, the UE may operate in a state that assumes and/or regards a subframe in which the SS block exists as invalid. Accordingly, the UE may omit a reception operation of a (N)PDCCH and/or (N)PDSCH in the corresponding subframe. That is, when the UE receives the above-described indication from the BS, the UE may not perform transmission and reception of a DL/UL signal and/or a channel in an invalid subframe determined (or interpreted) by the indication. In particular, in order for the UE to interpret an invalid subframe, as described above, the UE may be configured to receive information on a subframe in which an SS block is transmitted from the BS.

In the above-described eMTC system and/or NB-IoT system, because an anchor PRB or an anchor NB may not be always configured by frequency division multiplexing (FDM) with the SS block of the NR system, a method of distinguishing and configuring valid subframes may be necessary in order not to affect transmission of the SS block of the NR system. Therefore, when the above-described method is used, there is an advantage of minimizing the effect that may affect a performance of the NR system.

Further, until the UE receives information related to the above-described valid subframe from the BS, the UE may define a default configuration that may assume that the SS block is transmitted in a process of receiving a specific signal and/or channel. Here, the default configuration may be defined according to a frequency band and a subcarrier spacing option available in the frequency band.

Further, because there is a system bandwidth in which the frequency band is insufficient when configuring the anchor NB or the anchor PRB by FDM with the frequency band in which the SS block is transmitted, a method of together applying FDM and/or TDM may also be considered. When TDM is considered, a method of offsetting an NR radio frame boundary and an NB-IoT radio frame boundary by a pre-promised X subframe may be considered. In the case of this method, there is an advantage that the restriction that 20 RB should always be emptied in the frequency domain and that the NB-IoT anchor PRB should be configured may be eliminated. In particular, because the NR subframe index is required for the NB-IoT UE, or conversely, because the NB-IoT subframe index may be required for the NR UE, the BS may be configured to transmit information on the corresponding subframe offset value to the NB-IoT UE and/or the NR UE through higher layer signaling or the like.

Further, the NR BS may support the NB-IoT system and/or the eMTC system using resources thereof, and transmit information related to an additional reference signal (RS) transmitted to a specific PRB other than NB-IoT or eMTC PRB(s) in order to improve the channel estimation effect of the NB-IoT UE and/or eMTC UE. In this case, the NB-IoT UE or the eMTC UE needs to know information about whether they coexist in the current NR band.

Accordingly, according to such a need, the NB-IoT UE and/or the eMTC UE need(s) to distinguish whether the corresponding band is an NR system. Information about this may be transmitted through a broadcast channel, or may be transmitted through higher layer signaling or system information.

For example, the information may be delivered using a 1-bit field of MIB (e.g., MIB-NB), and a value of ‘0’ may be configured to mean that it is not an NR band, and a value of ‘1’ may be set to mean that it is an NR band. That is, information on what kind of band the UE currently exists in (e.g., a separate 1-bit field for distinguishing whether it is an NR band) may be indicated and/or configured through the MIB or SIB.

Additionally, as described above, in order to transmit information on signals (e.g., PBCH-DMRS, PDCCH-DMRS, PDSCH-DMRS, etc.) in which the NR BS transmits using resources thereof for the NB-IoT system and/or eMTC system, the NB-IoT UE or the eMTC UE needs to know a cell ID of the corresponding NR BS. In particular, the cell ID for the NB-IoT system or the eMTC system coexisting in the NR band may be configured to be determined according to an NR cell ID value. In the case of the NR system, 1008 (3*336=1008) cell IDs are used using three different PSSs and 336 different SSSs. This corresponds to twice the number of cell IDs used in the eMTC system and/or the NB-IoT system. That is, 3 PSSs and 504 SSSs may be used in the eMTC system, and 1 PSS and 504 SSSs may be used in the NB-IoT system.

Accordingly, a method of transmitting a correct cell ID of the NR BS to the UE by adding additional 1-bit information (i.e., 1-bit field) to the MIB or SIB may be considered.

For example, when the NR cell ID is referred to as CID_NR, a cell ID used for a synchronization signal of NB-IoT or eMTC coexisting with the NR system may be configured to CID_NR mod 504. In this case, the NB-IoT UE and/or the eMTC UE may find out one of 504 values through a synchronization process, and additionally, by providing [CID_NR/504] (i.e., 0 or 1) through the above-described 1-bit information, the NR BS may configure so that the NB-IoT UE or the eMTC UE finds a correct cell ID thereof. That is, when the UE (i.e., the NB-IoT UE and/or the eMTC UE) finds a value (e.g., k) of one of 0 to 503 through a synchronization process and receives a [CID_NR/504] value through the MIB or SIB, an actual cell ID of the NR BS is determined to k when the provided [CID_NR/504] value is 0, and to k+504 when the provided [CID_NR/504] value is 1. In terms of a formula, NR cell ID CIDNR_EST estimated by the UE may be the same as CIDNR_EST=k+504*([CID_NR/504]).

Additionally, in order for the NB-IoT UE or the eMTC UE to generate a PBCH-DMRS, the NB-IoT UE or the eMTC UE needs to know a correct NR cell ID, a subframe index (i.e., slot index in the case of NR), and an index of the SS block (e.g., SSB-ID). Accordingly, the NR BS may be configured to transmit information on the SS block index to the NB-IoT UE and/or the eMTC UE through higher layer signaling and/or SIB. Further, in order for the UE to find out an accurate position of an anchor PRB or anchor NB, there is a need that the BS notifies the UE of information on the NR system bandwidth and a relative position from a center frequency of an initial bandwidth part (BWP) to the anchor PRB or anchor NB. Corresponding information may be defined in the form of a table in combination with the above-described channel raster offset.

### Embodiment 5

Further, when a basic NB (i.e., 6PRB) of the eMTC system coexisting with the NR system is configured to 1, it is necessary to process channels and/or signals occupying as much as 73 subcarriers. In the case of synchronization signals (e.g., PSS, SSS), an actual effective sequence is transmitted to 62 subcarriers (63 subcarriers when DC subcarriers are included) from the center, and 5 guard subcarriers may exist at each of both ends.

Therefore, when one of guard subcarriers at both ends of the PSS and the SSS for actual eMTC is configured not to be used, it may be positioned within a specific 6PRB of the NR system. However, because the PBCH and a cell reference signal (CRS) of a symbol in which the PBCH is transmitted occupy 72 subcarriers (73 subcarriers when DC subcarriers are included), they are not completely included in a specific 6PRB. Accordingly, one remaining subcarrier is generated, which may affect another band for the NR system as much as one subcarrier.

Therefore, the following methods may be applied to solve this problem. Methods described below are only classified for convenience of description, and some components of one method may be substituted with some components of another method or may be combined with each other.

(Method 1)

First, a method of dropping (i.e., puncturing) or rate-matching as much as one subcarrier of a specific symbol(s) (e.g., a symbol in which a PBCH is transmitted) for an eMTC system may be considered.

As described above, when a subcarrier serving as the DC subcarrier of the NB of the eMTC system is positioned at a 0th subcarrier (#0 subcarrier) of a specific PRB of the NR band, one subcarrier disposed at topmost among subcarriers allocated for PBCH transmission in the eMTC system may be dropped. However, when a subcarrier serving as a DC subcarrier is positioned below the center of the NB, one subcarrier disposed at bottommost among subcarriers allocated for PBCH transmission in the eMTC system may be dropped.

This method has an advantage that it does not interfere with the NR system, but it requires dropping a part of a channel that transmits important information such as the MIB. Here, in a rate-matching method, a method of configuring to perform downlink transmission of PRBs of the side that is not aligned with the PRB grid of the NR system among PRBs disposed at both ends of 6 PRBs using 11 subcarriers except for one subcarrier at the far end instead of total 12 subcarriers may be considered.

(Method 2)

Secondly, a method of configuring the NR BS to transmit and receive a signal and/or a channel to and from the NR UEs by dropping one subcarrier of an NR band of a location bordering the NB of the eMTC system may be considered. In other words, this may mean that the NB of the eMTC system is configured with 73 subcarriers.

In this case, a CRS transmitted to a PBCH or a PBCH symbol for the eMTC system may be completely delivered. Using this method, there is an advantage that the eMTC system may operate without any effect, and because NR UEs perform decoding with an error of one subcarrier, performance degradation may occur, but the overall performance thereof may not be greatly affected.

(Method 3)

Thirdly, the NR BS may drop one subcarrier of the NR band only for specific symbols (e.g., symbols in which PBCH is transmitted) among areas bordering the NB of the eMTC system to transmit and receive a signal and/or a channel to and from the NR UEs.

That is, when the method is used, the number of subcarriers constituting the NB may vary according to a specific symbol. Further, all CRSs transmitted to a PBCH or PBCH symbol for an eMTC system may be delivered. For example, the eMTC UE needs to determine and receive that the NB is configured with 73 subcarriers until a PSS, SSS, and PBCH are decoded. When the eMTC UE knows information that it is currently positioned in the NR band through the MIB of the PBCH, it is necessary to determine and receive that the NB is configured with 72 subcarriers from when performing the next operation. Thereafter, a CRS positioned in a symbol in which the PBCH is transmitted needs to determine and receive that the NB is configured with 73 subcarriers.

When the method is applied, there is an advantage that performance degradation of eMTC UEs is also minimized and that performance degradation of NR UEs may also be a minimum.

The above methods (i.e., methods 1 to 3) may be described in terms of signal mapping in a BS (e.g., eNB), actual transmission, and a corresponding signal reception operation in the eMTC UE as follows.

In the case of a drop (or puncture) in a first method (i.e., method 1), coded bit generation and RE mapping for a signal and/or a channel of the eMTC system are performed according to 73 subcarriers. However, the BS may perform transmission for only 72 subcarriers except for one subcarrier (by puncturing or dropping), and the UE may receive a signal and/or a channel of the eMTC system under the assumption that the BS will perform mapping and transmission according to 72 subcarriers. In the first method, coded bit generation and RE mapping for a signal and/or a channel of the eMTC system are performed according to 72 subcarriers. Further, the BS also performs transmission for only 72 subcarriers, and the UE may receive a signal and/or a channel of the eMTC system under the assumption that the BS will perform mapping and transmission according to the 72 subcarriers.

In the second method, coded bit generation and RE mapping for a signal and/or a channel of the eMTC system are performed according to 73 subcarriers. Further, the BS also performs transmission for 73 subcarriers, and the UE may receive a signal and/or a channel of the eMTC system under the assumption that the BS will perform mapping and transmission according to the 73 subcarriers.

In the third method, coded bit generation and RE mapping for a signal and/or a channel (e.g., PSS, SSS, PBCH, PBCH-CRS, etc.) of a specific eMTC system are performed according to 73 subcarriers. Further, the BS performs transmission for 73 subcarriers, and in the case of a signal and/or channel (e.g., PSS, SSS, PBCH, PBCH-CRS, etc.) of the specific eMTC system, the UE may receive a signal and/or a channel of the eMTC system under the assumption that the BS will perform mapping and transmission according to 73 subcarriers. However, coded bit generation and RE mapping for a signal and/or a channel (e.g., PDSCH, PDCCH, etc.) that have (has) not been performed according to previously 73 subcarriers may be performed according to 72 subcarriers. Further, the BS transmits only for 72 subcarriers, and in the case of a signal and/or a channel (e.g., PDSCH, PDCCH, etc.) that have (has) not been performed according to the previously 73 subcarriers, the UE may receive a signal and/or a channel of the eMTC system under the assumption that the BS will perform mapping and transmission according to 72 subcarriers.

Further, the proposed methods (i.e., methods 1 to 3) may be applied to a situation in which the UE receives scheduling of a PDCCH and/or a PDSCH from the BS in a smaller number of PRBs than a single NB (e.g., 6 PRBs).

Specifically, a case may be considered in which the BS schedules for a PDCCH and/or a PDSCH as much as the N number of PRBs (here, N<6) to the (e)MTC UE, and schedules for a PDCCH and/or a PDSCH as many as the 6-N number of PRBs of the same timing (e.g., slot, subframe) to the NR UE. In this case, the N number of PRBs and the 6-N number of PRBs may exist in a narrowband (NB) in which an (e)MTC signal and/or a channel are transmitted and be adjacent to each other, and be allocated to two or more UEs. In this case, among the PRB(s) allocated to the MTC UE, one subcarrier of the PRB allocated to the NR UE and the PRB adjacent thereto may be dropped (or punctured) or rate-matched.

For example, in a situation where the PRB grid (i.e., RB grid) does not match as much as one subcarrier of the high frequency side, as illustrated in FIG(S). 22 and/or 24, a scheme of allocating 2 PRBs disposed at the high frequency side near the center among 6 PRBs to the (e)MTC UE, and allocating 1 PRB disposed at the far end of the high frequency side to the NR UE may be considered. In this case, because one subcarrier of the high frequency side of the PRB positioned at the highest frequency among PRBs allocated to the MTC UE is out of the PRB grid, the BS and the UE may determine that the corresponding one subcarrier is dropped (or punctured) or rate-matched, and perform transmission and reception of control information and/or data.

Similarly, the method may be applied even when the PRB grids do not match as much as one subcarrier of the lower frequency side, as illustrated in FIG. 25. That is, a method of allocating 2 PRBs disposed at the lower frequency side near the center among 6 PRBs to the (e)MTC UE and allocating 1 PRB disposed at the far end of the lower frequency side to the NR UE may be considered. In this case, because one subcarrier of the lower frequency side of the PRB positioned at the lowest frequency among PRBs allocated to the MTC UE is out of the PRB grid, the BS and the UE may determine that the corresponding one subcarrier is dropped (or punctured) or rate-matched, and perform transmission and reception of control information and/or data.

Further, the BS may schedule the PDCCH and/or PDSCH for the MTC UE at the side where the PRB grids match (e.g., the opposite side to the above-described direction). In this case, the BS and the UE may determine that drop (or puncture) or rate-matching is not necessary, and transmit and receive control information and/or data. Further, by transmitting an indicator (e.g., “1 subcarrier dropping/rate matching indicator”) related to drop, puncture, and/or rate-matching through the DCI field, the BS may indicate to perform or not to perform drop (or puncture) or rate-matching to the UE. Additionally, the indicator may distinguish whether it is one subcarrier of a low frequency or one subcarrier of a high frequency. Additionally, information on whether the scheduled PRB, the NR system, and the PRB grid are aligned (or mapped) may be included in the DCI field.

Further, the above-described methods (i.e., methods 1 to 3) may be applied not only to the PBCH, but also to other downlink transmissions (e.g., MPBCH, MPDCCH, PDSCH, etc.).

Further, when RE is punctured or rate-matched in the above-described methods (i.e., methods 1 to 3), RE shift for CRS may occur according to a cell ID. In this case, when CRS is included in one RE of the eMTC system overlapping the PRB of the NR system, the CRS may be processed separately from the PDSCH and/or PDCCH. In particular, in even when the eMTC system drops and does not use the corresponding one RE, the CRS may be transmitted. Further, in the case of MPDCCH transmission, in an enhanced resource element group (EREG) configuration for an enhanced control channel element (ECCE) configuration, the punctured or rate-matched RE is used, but may be dropped in actual transmission.

### Embodiment 6

Further, when the basic number of NBs of the eMTC system coexisting with the NR system is configured to N (e.g., N=2), there may be considered a method of configuring so that the BS transmits a PSS, SSS, and/or PBCH at a desired position within the total N*72 subcarriers. The UE may be configured to receive a PSS, SSS, and/or PBCH, etc., under an assumption that the BS transmits in this manner, and to shift to the configured NB through a pre-promised NB or MIB (and/or SIB) to receive the PDCCH and/or the PDSCH.

For example, it is assumed that the NR is configured with i) #0 NB from a 0th subcarrier (#0 subcarrier) to a 71st subcarrier (#71 subcarrier) and ii) #1 NB from a 72nd subcarrier (#72 subcarrier) to a 143th subcarrier (#143 subcarrier).

In this case, the PSS, SSS, and/or PBCH may be configured to be transmitted over a 36th subcarrier (#36 subcarrier) to a 108th subcarrier (#108 subcarrier). Here, the 36th subcarrier (#36 subcarrier) to the 71st subcarrier (#71 subcarrier) may be used for a role for transmitting an effective signal, the 72nd subcarrier (#72 subcarrier) may server as a DC subcarrier, and a 73rd subcarrier (#73 subcarrier) to a 108th subcarrier (#108 subcarrier) may be used for a role for transmitting an effective signal.

Alternatively, the PSS, SSS, and/or PBCH may be configured to be transmitted over a 35th subcarrier (#35 subcarrier) to a 107th subcarrier (#107 subcarrier). Here, the 35th subcarrier (#35 subcarrier) to a 70th subcarrier (#70 subcarrier) may be used for a role for transmitting an effective signal, the 71st subcarrier (#71 subcarrier) may serve as a DC subcarrier, and the 72nd subcarrier (#72 subcarrier) to a 107th subcarrier (#107 subcarrier) may be used for a role for transmitting an effective signal.

That is, each NB is configured with 72 subcarriers, and the PSS, SSS, and/or PBCH may be configured to be transmitted over 73 subcarriers. In particular, the eMTC UE may receive a CRS under an assumption that the 72nd subcarrier serves as a DC subcarrier in the symbol in which the PBCH is transmitted, and receive a CRS under an assumption that the DC subcarrier does not exist in other symbols. In other words, the PSS, SSS, and/or PBCH may be configured to be transmitted over almost half of the two NBs.

Further, an area corresponding to a symbol in which the PBCH is transmitted, but in which the PBCH is not actually transmitted, may be 71 subcarriers except for 73 subcarriers (i.e., PBCH transmission and reception and DC subcarrier role) among 144 subcarriers. To this end, the BS may use a method such as rate-matching or RE drop, and the UE may be configured to transmit and receive a signal and/or a channel under the assumption that the BS performs an operation such as rate-matching.

When configuring in this way, because no drop of the NR band occurs, performance degradation of the NR UE does not occur, but as a basic area for the eMTC system increases, the NR system throughput may decrease.

FIG. 28 illustrates an example of a method of configuring regions for a PSS, an SSS, and a PBCH when a plurality of NBs for an eMTC system are configured. FIG. 28 is merely for convenience of description and does not limit the scope of the present disclosure.

Referring to FIG. 28, as described above, the PSS, SSS, and/or PBCH may be transmitted/received over each half of two NBs (i.e., #0 NB and #1 NB).

### Embodiment 7

Further, as described above, when the NR system empties 7 RBs (or PRBs) (hereinafter, 7 RBs) of the NR system for coexistence with the eMTC system (e.g., FIGS. 24 to 27), for enhanced eMTC UEs, it is necessary to consider a method in which the BS may efficiently use the 7 RB.

The reason of emptying 7 RBs in the NR system is that the eMTC system requires 6 RBs and 1 subcarrier. That is, when only 6 RBs are emptied in the NR system, a problem may occur when coexisting with the eMTC system.

Therefore, when the simplest method of empting 1 RB is considered, 7 RBs may be emptied for eMTC. 7 RBs are 84RE (7*12=84), and 73 REs among 7 RBs for existing eMTC UEs need to be used for transmission and reception of an existing signal and/or channel (e.g., legacy signal/channel). In order to efficiently use resources, a scheme of sequentially mapping the 73 REs from the bottom of the 7 RB and using the remaining 11 REs for the (enhanced) eMTC UE may be considered. Alternatively, when mapping DC subcarriers in the form that takes channel raster offset to the minimum, 73 REs are mapped to the center of the 7 RB, and a scheme of using 5 REs and 6 REs (or vice versa) up and down, respectively for the (enhanced) eMTC UE may be considered.

As an example, considering a method of extending and transmitting 11 REs in addition to the existing 73 REs (72 REs+DC subcarriers) for the PBCH for the (enhanced) eMTC UE, a method of including and transmitting encoded bits of the PBCH to be transmitted after 10 ms in the corresponding 11 RE within a period in which the MIB is not changed may be considered. In this case, the BS may read and transmit more by 11RE than the existing PBCH (legacy PBCH) in a circular buffer for a PBCH to be transmitted in the N number of subframes. In this case, the 11 REs are actually scheduled to be transmitted to N+10 subframes, and may actually be transmitted to the existing area for the existing UE.

However, the existing PBCHs of 84 REs may be configured so that there is no misunderstanding with the UEs that do not understand extension of 11 REs by preferentially mapping resources to the center 6 RBs (i.e., 73 REs including DC subcarriers) recognized by the existing UEs. In this case, a UE (i.e., (enhanced) eMTC UE) that understands extension of 11 REs has an advantage that early decoding is possible. Additionally, a method of sequentially extending and transmitting 11 REs after the last bit of encoded bits of the PBCH to be transmitted after 40 m may be considered. In this case, the operation may also be applied to the MPBCH for the eMTC system.

Additionally, in using 11 REs for early decoding of the PBCH, repetition of the PBCH may be considered. In this case, the RE of the repeatedly transmitted PBCH may be configured differently depending on how the center 6 RBs are aligned with the NR RB grid.

That is, when the center subcarrier (e.g., DC subcarrier) of the center 6 RB for the PBCH of the eMTC system is mapped to a 0th subcarrier (#0 subcarrier) of an NR specific RB, it may be configured to perform repetition transmission in 11 REs extended by 11 from the last RE of the PBCH.

Further, when the center subcarrier (e.g., DC subcarrier) of the center 6 RB for the PBCH of the eMTC system is mapped to an 11th subcarrier (#11 subcarrier) of an NR specific RB, it may be configured to perform repetition transmission in 11 REs extended by 11 from the first RE of the PBCH.

Further, when the central subcarrier (e.g., DC subcarrier) of the center 6 RB for the PBCH of the eMTC system is mapped to a 6th subcarrier (#6 subcarrier) of the NR specific RB, it may be configured to perform repetition transmission in 6 REs extended to the downside by 6 from the first RE of the PBCH and to perform repeated transmission in 5 REs extended to the upside by 5 from the last RE of the PBCH.

Further, when the center subcarrier (e.g., DC subcarrier) of the center 6 RB for the PBCH of the eMTC system is mapped to a 5th subcarrier (#5 subcarrier) of the NR specific RB, it may be configured to perform repetition transmission in 5 REs extended to the downside by 5 from the first RE of the PBCH and to perform repetition transmission in 6 REs extended to the upside by 6 from the last RE of the PBCH.

As described above, the UE may know that PBCH extension is mapped differently according to each case, and may be configured to attempt early decoding of the PBCH using this.

Additionally, as described above, when the PBCH is extended, the CRS may be configured to be used in the same manner as the existing LTE CRS (legacy LTE CRS) is extended, and it may be configured to repeatedly transmit a CRS value of a position where the existing PBCH (legacy PBCH) is transmitted in the extended area. Even in this case, the RE of the PBCH that is repeatedly transmitted, as described above may be configured differently from the CRS according to how the center 6 RB is aligned with the NR RB grid, and this may be applied similarly to the above method.

### Embodiment 8

In first 3 symbols of a 1st slot in a standalone mode, it is set that data is always transmitted up to the existing NB-IoT (e.g., Rel. 15 NB-IoT) system. However, in a standalone mode of an NB-IoT (e.g., Rel. 16 NB-IoT) system newly discussed for coexistence with IoT (i.e., NR IoT) of the NR system, a method used in the existing in-band mode (e.g., Rel. 15 NB-IoT in-band mode) may need to be additionally considered.

For example, it may need to be able to configure in a configurable method whether to transmit or receive data in first 3 symbols of a first slot using a higher-layer parameter (e.g., eutraControlRegionSize [n1, n2, n3]) used in the existing in-band mode.

Further, there may also be considered a method of pre-distorting channel raster offset for a signal for a service (e.g., eMTC, NB-IoT, etc.) in which channel raster offset may occur while the NR BS generates a baseband signal. The method has an advantage of being backward compatible because existing eMTC UEs may also receive a broadcast signal and/or channel without channel raster offset in an eMTC system area (i.e., an area coexisting with the NR system) existing in the NR band. Further, in a standalone NB-IoT region existing in the NR band, because existing NB-IoT UEs may also receive a broadcast signal and/or channel without channel raster offset, there is an advantage of being backward compatible.

In the above method, there may be actual physical channel raster offset. Therefore, when notifying an UL carrier corresponding to a DL carrier, it may be configured to notify an UL carrier index other than an actual UL carrier index by additionally considering the channel raster offset that was existed in the DL carrier in addition to a frequency value of the existing UL carrier. When a UE that needs to be configured in this way transmits UL data and/or signals, interference in an adjacent frequency domain may be minimized.

### Embodiment 9

Further, a situation of coexisting in one PRB (or NB) may be considered using different operation modes according to a category (or type) of the UE (e.g., a UE according to a standard Rel. version). For example, in a specific NB-IoT system or eMTC system, a situation may be considered in which UEs (e.g., Rel. 16 UEs and existing UEs before Rel. 15) belonging to a specific category operate in different operating modes (e.g., in-band mode, guard band mode, standalone mode).

The above-described specific category may be divided into a UE category or the like. When the specific category is divided into a legacy UE and an enhanced UE, Rel. 16 UEs may be configured to know that an operation mode recognized by the legacy UE may be different from an operation mode recognized by the Rel. 16 UE. For example, existing UEs have indicated to have operation modes (e.g., in-band mode, guard band mode, stand-alone mode, etc.) through the MIB, but Rel. 16 UEs may be configured to receive signaling (e.g., operation mode change information) of the BS through the MIB or SIB in addition to the corresponding operation mode information, and to change the operation mode.

For example, when an existing UE (e.g., Rel. 15 UE) operates in an in-band mode and an enhanced UE (e.g., Rel. 16 UE) operates in a stand-alone mode, the existing UE and the enhanced UE may be configured to operate under the assumption that 11 symbols are used from the 3rd symbol (3rd OFDM symbol), as in the previous operation so that signals and/or signals in which the existing UE and the enhanced UE should share do not use 3 symbols (i.e., 0th to 2nd symbols) in the front part. Further, the BS may need to perform rate-matching under the assumption that there is a CRS in the following 11 symbols.

When the NB-IoT system, for example, existing UEs operating in an in-band mode are operating in an in-band same physical cell ID (PCI) mode, the enhanced UE (e.g., Rel. 16 UE) may also sufficiently know the corresponding information and thus rate-matching needs to be performed in consideration of where the CRS will be. Further, it may be configured to use the corresponding CRS to enhance a channel estimation performance. Even if the existing UEs operating in the in-band mode operate in an in-band different PCI mode, the enhanced UE (e.g., Rel. 16 UE) may also sufficiently know the corresponding information and thus rate-matching needs to be performed in consideration of where the CRS will be.

Additionally, when it may be configured in a configurable method whether to transmit/receive data in first 3 symbols of the above-described first slot in the standalone mode, other additional operations may not be required. However, when such a signaling method is not introduced, it is necessary to transmit data to first 3 symbols for an enhanced UE (e.g., Rel. 16 UE) recognizing in a standalone mode.

As a method of efficiently using the corresponding 3 symbols, a method of configuring to copy 3 symbols of a specific position from the following 11 symbols may be considered. In this case, there may be a method of copying and transmitting last 3 symbols regardless of whether Narrowband RS (NRS) is included, and there may be a method of copying and transmitting 3 symbols (e.g., 8th, 9th, and 10th OFDM symbols) that do not include an NRS. Alternatively, there may be a method of continuing to read from a circular buffer and mapping and transmitting additionally first 3 symbols in order. Characteristically, when existing UEs operate in the in-band mode, it may be configured to transmit data by rate-matching CRS positions to the first 3 symbols. Further, when the in-band mode is an in-band same PCI mode, it may be configured that the BS transmits an actual CRS.

Additionally, it may be configured that the BS may designate a non-anchor carrier that can access only a UE in a specific operation mode in a non-anchor carrier operation. When only the standalone mode UE may access the corresponding non-anchor carrier, the UE operating in the in-band mode cannot access the corresponding non-anchor carrier. Alternatively, it may be configured that the BS notifies whether a specific operation mode and another operation mode UE may also access a specific non-anchor carrier.

The above-described methods (e.g., methods described in the first to ninth embodiments) are methods proposed so that one BS (e.g., NR BS) basically supports an LTE NB-IoT system and/or an LTE eMTC system in the NR band.

However, the above-described methods (e.g., the methods described in the first to ninth embodiments) may be extended and applied to the form in which two different BSs (e.g., LTE BS, NR BS) coexist while providing the respective services. That is, even when the NR BS supports the NR system and the LTE BS supports the NB-IoT system or the eMTC system and coexists in a frequency band, the above-described methods may be considered for optimization.

Further, as described above, each of the above-described methods (e.g., the methods described in the first to ninth embodiments) may be applied independently when the NB-IoT system and/or the (e)MTC system coexist with the NR system or two or more methods may be applied by coupling (i.e., in combination).

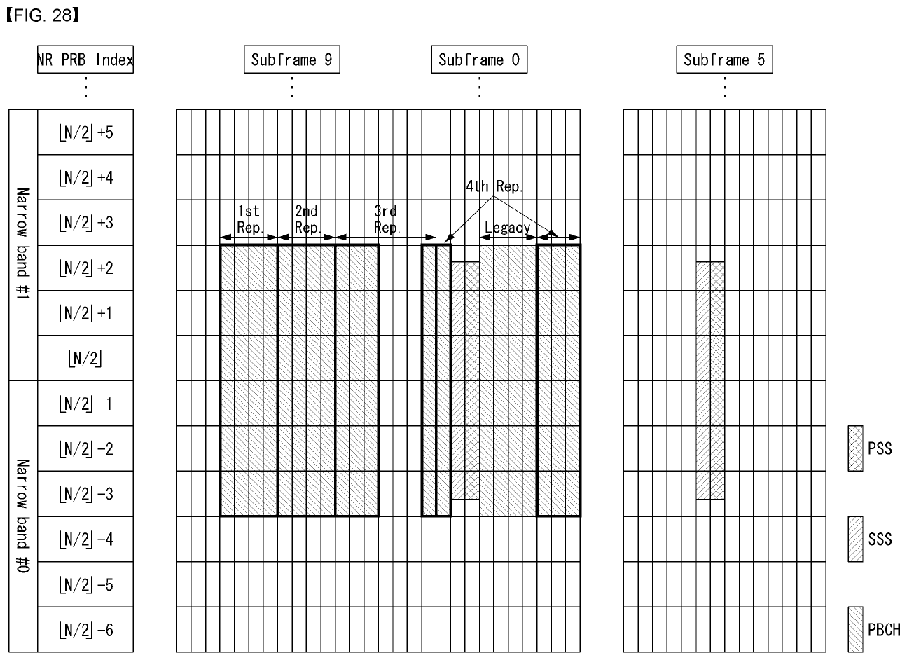

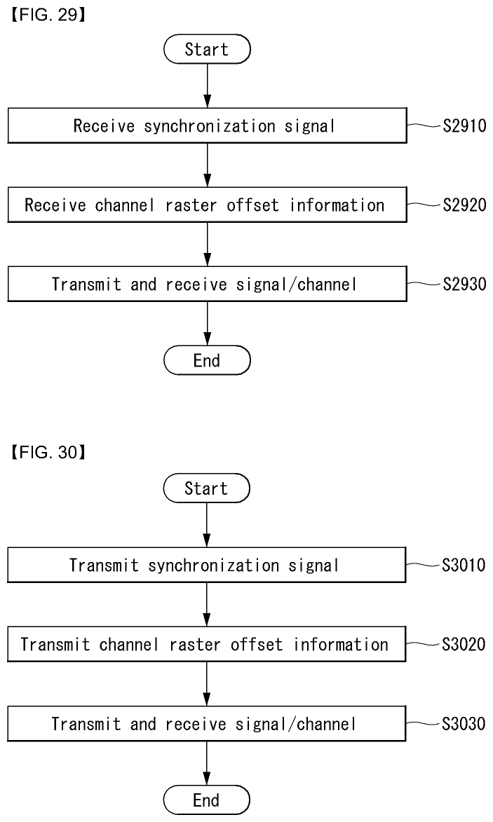

FIG. 29 illustrates an example of an operation flowchart of a UE for transmitting and receiving a signal and/or a channel in a narrowband wireless communication system coexisting with another wireless communication system to which a method proposed in the present disclosure may be applied. FIG. 29 is merely for convenience of description and does not limit the scope of the present disclosure.

Referring to FIG. 29, there is assumed a case that a wireless communication system using a narrowband coexists in a system band of another wireless communication system (e.g., NR system), as in the above-described methods (e.g., the methods described in the first to ninth embodiments). That is, the method described in FIG. 29 may be operated, configured, defined, and/or indicated based on the above-described methods.

The UE may receive a synchronization signal (e.g., (N)PSS, (N)SSS, etc.) from the BS based on a preset channel raster (e.g., 100 kHz) (S2910). For example, as in the above-described methods, the UE may be configured to monitor the synchronization signal for each channel raster.

The UE may receive information on channel raster offset from the BS through a physical broadcast channel (e.g., PBCH) (S2920). For example, the UE may receive information on channel raster offset from the BS through the MIB and/or SIB. For example, a channel raster offset value may be configured with the above-described 1-bit information (i.e., 1-bit field) or 2-bit information. Alternatively, the channel raster offset value may be transmitted using a field configuration (e.g., reserved state, etc.) included in the existing MIB and/or SIB.

The UE may transmit and receive a signal and/or a channel to and from the BS in a narrowband in which a center frequency is adjusted by applying the channel raster offset (S2930).

In this case, a specific subcarrier among a plurality of subcarriers included in the narrowband (e.g., 73 subcarriers in the case of an eMTC system, as described above) may be punctured (or dropped) or rate-matched. For example, as in the above-described fifth embodiment, when the eMTC system and the NR system coexist, one remaining subcarrier due to mismatch of the PRB grid of the NR system may be punctured (or dropped) or rate-matched. In this case, the specific subcarrier may be limited to that for a symbol allocated for transmission of a specific signal and/or channel (e.g., PBCH).

Further, as described above, the specific subcarrier may be determined according to a position of the narrowband direct current (DC) subcarrier. For example, as illustrated in FIGS. 24 to 26, the position of the specific subcarrier, that is, one remaining subcarrier may be changed according to the position of the DC subcarrier in the narrowband of the eMTC system.

As a specific example, when the position of the DC subcarrier is mapped to that of a 0th subcarrier of a physical resource block constituting a system bandwidth of the other wireless communication system, the specific subcarrier may be a subcarrier having a last index among the plurality of subcarriers. Alternatively, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, as described above (e.g., the fifth embodiment), when the specific subcarrier is punctured, coded bit generation and resource element mapping for the signal and the channel may be performed for all of the plurality of subcarriers (e.g., 73 subcarriers). Alternatively, when the specific subcarrier is rate-matched, coded bit generation and resource element mapping for the signal and the channel may be performed for subcarriers (e.g., 72 subcarriers) except for a specific subcarrier in the plurality of subcarriers.

FIG. 30 illustrates an example of an operation flowchart of a BS for transmitting and receiving a signal and/or a channel in a narrowband wireless communication system coexisting with another wireless communication system to which a method proposed in the present disclosure can be applied. FIG. 30 is merely for convenience of description and does not limit the scope of the present disclosure.

Referring to FIG. 30, there is assumed a case that a wireless communication system using a narrowband coexists in a system band of another wireless communication system (e.g., NR system), as in the above-described methods (e.g., the methods described in the first to ninth embodiments). That is, the method described in FIG. 30 may be operated, configured, defined, and/or indicated based on the above-described methods.

The BS may transmit a synchronization signal (e.g., (N)PSS, (N)SSS, etc.) to the UE based on a preset channel raster (e.g., 100 kHz) (S3010). For example, as in the above-described methods, when the BS transmits a synchronization signal, the UE may be configured to monitor the synchronization signal for each channel raster.

The BS may transmit information on the channel raster offset to the UE through a physical broadcast channel (e.g., PBCH) (S3020). For example, the BS may transmit information on the channel raster offset to the UE through the MIB and/or SIB. For example, the channel raster offset value may be configured with the above-described 1-bit information (i.e., 1-bit field) or 2-bit information. Alternatively, the channel raster offset value may be transmitted using a field configuration (e.g., reserved state, etc.) included in an existing MIB and/or SIB.

The BS may transmit and receive a signal and/or a channel to and from the UE in a narrowband in which a center frequency is adjusted by applying the channel raster offset (S3030).

In this case, a specific subcarrier among a plurality of subcarriers included in the narrowband (e.g., 73 subcarriers in the case of an eMTC system, as described above) may be punctured (or dropped) or rate-matched. For example, as in the above-described fifth embodiment, when the eMTC system and the NR system coexist, one remaining subcarrier due to mismatch of the PRB grid of the NR system may be punctured (or dropped) or rate-matched. In this case, the specific subcarrier may be limited to that for a symbol allocated for transmission of a specific signal and/or channel (e.g., PBCH).

Further, as described above, the specific subcarrier may be determined according to the position of the narrowband DC subcarrier. For example, as illustrated in FIGS. 24 to 26, the position of the specific subcarrier, that is, one remaining subcarrier may be changed according to the position of the DC subcarrier in the narrowband of the eMTC system.

As a specific example, when the position of the DC subcarrier is mapped to that of a 0th subcarrier of a physical resource block constituting a system bandwidth of the other wireless communication system, the specific subcarrier may be a subcarrier having a last index among the plurality of subcarriers. Alternatively, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, as described above (e.g., the fifth embodiment), when the specific subcarrier is punctured, coded bit generation and resource element mapping for the signal and the channel may be performed for all of the plurality of subcarriers (e.g., 73 subcarriers). Alternatively, when the specific subcarrier is rate-matched, coded bit generation and resource element mapping for the signal and the channel may be performed for subcarriers (e.g., 72 subcarriers) except for the specific subcarrier in the plurality of subcarriers.

General devices to which the present disclosure can be applied

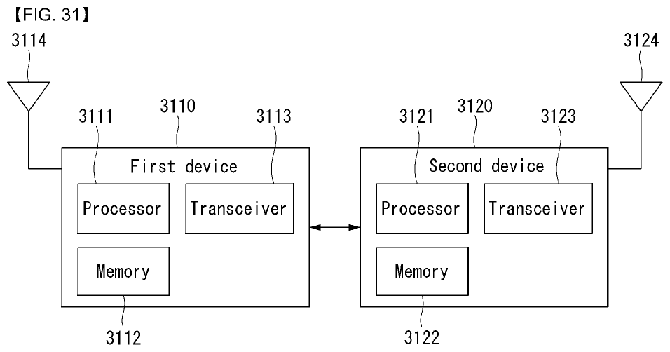

FIG. 31 is a block diagram of a wireless communication device to which a methods proposed in the present disclosure may be applied.

Referring to FIG. 31, the wireless communication system may include a first device 3110 and a second device 3120.

The first device 3110 may be a BS, a network node, a transmission UE, a reception UE, a transmission device, a reception device, a wireless device, a wireless communication device, a vehicle, a vehicle equipped with an autonomous driving function, a connected car, a unmanned aerial vehicle (UAV), an AI module, a robot, an augmented reality (AR) device, a virtual reality (VR) device, a mixed reality (MR) device, a hologram device, a public safety device, an MTC device, an IoT device, a medical device, a FinTech device (or financial device), a security device, a climate/environment device, a device related to a 5G service, or a device related to a fourth industrial revolution field.

The second device 3120 may be a BS, a network node, a transmission UE, a reception UE, a transmission device, a reception device, a wireless device, a wireless communication device, a vehicle, a vehicle equipped with an autonomous driving function, a connected car, an UAV, an AI module, a robot, an AR device, a VR device, a MR device, a hologram device, a public safety device, an MTC device, an IoT device, a medical device, a FinTech device (or financial device), a security device, a climate/environment device, a device related to 5G service, or a device related to a fourth industrial revolution field.

For example, the UE may include a mobile phone, a smart phone, a laptop computer, a digital broadcasting UE, a personal digital assistant (PDA), a portable multimedia player (PMP), a navigation device, a slate PC, a tablet PC, an ultrabook, a wearable device (e.g., smartwatch, smart glass, head mounted display (HMD)), and the like. For example, the HMD may be a display device wearing on a head. For example, the HMD may be used for implementing VR, AR, or MR.

For example, the UAV may be a vehicle flying by a radio control signal without on-boarding of a human. For example, the VR device may include a device that implements an object or a background of a virtual world. For example, the AR device may include a device that connects and implements an object or background of a virtual world to an object or background of the real world. For example, the MR device may include a device that combines and implements an object or background of a virtual world to an object or background of the real world. For example, the hologram device may include a device that implements a 360-degree stereoscopic image by recording and reproducing stereoscopic information by utilizing an interference phenomenon of light generated by the encounter of two laser lights called holography. For example, the public safety device may include an image relay device or an image device wearable on a user's human body. For example, the MTC device and the IoT device may be devices that do not require a human's direct intervention or manipulation. For example, the MTC device and the IoT device may include a smart meter, a bending machine, a thermometer, a smart light bulb, a door lock, or various sensors. For example, the medical device may be a device used for the purpose of diagnosing, treating, alleviating, or preventing a disease. For example, the medical device may be a device used for the purpose of diagnosing, treating, alleviating, or correcting an injury or disorder. For example, the medical device may be a device used for the purpose of examining, replacing, or modifying a structure or function. For example, the medical device may be a device used for the purpose of controlling pregnancy. For example, the medical device may include a device for treatment, a device for surgery, a device for (extra-corporal) diagnosis, a hearing aid, or a device for a surgical procedure. For example, the security device may be a device installed to prevent a risk that may occur and to maintain safety. For example, the security device may be a camera, a CCTV, a recorder, or a black box. For example, the FinTech device may be a device capable of providing financial services such as mobile payment. For example, the FinTech device may include a payment device or a point of sales (POS). For example, the climate/environment device may include a device that monitors or predicts the climate/environment.

The first device 3110 may include at least one processor such as a processor 3111, at least one memory such as a memory 3112, and at least one transceiver such as a transceiver 3113. The processor 3111 may perform the above-described functions, procedures, and/or methods. The processor 3111 may perform one or more protocols. For example, the processor 3111 may perform one or more layers of a radio interface protocol. The memory 3112 may be connected to the processor 3111 to store various types of information and/or commands. The transceiver 3113 may be connected to the processor 3111 and be controlled to transmit and receive wireless signals.

As a specific example, the processor 3111 may control to receive a synchronization signal (e.g., (N)PSS, (N)SSS, etc.) from the BS using the transceiver 3113 based on a preset channel raster (e.g., 100 kHz) (S2910). For example, as in the above-described methods, the processor 3111 may be configured to monitor a synchronization signal for each channel raster.

The processor 3111 may control to receive information on channel raster offset from the BS through a physical broadcast channel (e.g., PBCH) using the transceiver 3113 (S2920). For example, the processor 3111 may receive information on channel raster offset from the BS through the MIB and/or SIB. For example, the channel raster offset value may be configured with the above-described 1-bit information (i.e., 1-bit field) or 2-bit information. Alternatively, the channel raster offset value may be transmitted using a field configuration (e.g., reserved state, etc.) included in the existing MIB and/or SIB.

The processor 3111 may control to transmit and receive the signal and/or the channel using the BS and the transceiver 3113 in a narrowband in which a center frequency is adjusted by applying the channel raster offset (S2930).

In this case, a specific subcarrier among a plurality of subcarriers (e.g., 73 subcarriers in the case of an eMTC system, as described above) included in the narrowband may be punched (or dropped) or rate-matched. For example, as in the above-described fifth embodiment, when the eMTC system and the NR system coexist, one remaining subcarrier due to mismatch of the PRB grid of the NR system may be punched (or dropped) or rate-matched. In this case, the specific subcarrier may be limited to that for a symbol allocated for transmission of a specific signal and/or channel (e.g., PBCH).

Further, as described above, the specific subcarrier may be determined according to the position of the narrowband DC subcarrier. For example, as illustrated in FIGS. 24 to 26, the position of the specific subcarrier, that is, one remaining subcarrier may be changed according to the position of the DC subcarrier in the narrowband of the eMTC system.

As a specific example, when the position of the DC subcarrier is mapped to that of a 0th subcarrier of a physical resource block constituting a system bandwidth of the other wireless communication system, the specific subcarrier may be a subcarrier having a last index among the plurality of subcarriers. Alternatively, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, as described above (e.g., the fifth embodiment), when the specific subcarrier is punctured, coded bit generation and resource element mapping for the signal and the channel may be performed for all of the plurality of subcarriers (e.g., 73 subcarriers). Alternatively, when the specific subcarrier is rate-matched, coded bit generation and resource element mapping for the signal and the channel may be performed for subcarriers (e.g., 72 subcarriers) except for a specific subcarrier in the plurality of subcarriers.

The second device 3120 may include at least one processor such as a processor 3121, at least one memory device such as a memory 3122, and at least one transceiver such as a transceiver 3123. The processor 3121 may perform the above-described functions, procedures, and/or methods. The processor 3121 may implement one or more protocols. For example, the processor 3121 may implement one or more layers of a radio interface protocol. The memory 3122 may be connected to the processor 3121 and store various types of information and/or commands. The transceiver 3123 may be connected to the processor 3121 and be controlled to transmit and receive wireless signals.

As a specific example, the processor 3121 may control to transmit a synchronization signal (e.g., (N)PSS, (N)SSS, etc.) to the UE using the transceiver 3123 based on a preset channel raster (e.g., 100 kHz) (S3010). For example, as in the above-described methods, when the BS transmits a synchronization signal, the UE may be configured to monitor the synchronization signal for each channel raster.

The processor 3121 may control to transmit information on the channel raster offset to the UE through a physical broadcast channel (e.g., PBCH) using the transceiver 3123 (S3020). For example, the processor 3121 may transmit information on the channel raster offset to the UE through the MIB and/or SIB. For example, the channel raster offset value may be configured with the above-described 1-bit information (i.e., 1-bit field) or 2-bit information. Alternatively, the channel raster offset value may be transmitted using a field configuration (e.g., reserved state, etc.) included in the existing MIB and/or SIB.

The processor 3121 may control to transmit and receive the signal and/or the channel to and from the UE using the transceiver 3123 in a narrowband in which a center frequency is adjusted by applying the channel raster offset (S3030).

In this case, a specific subcarrier among a plurality of subcarriers (e.g., 73 subcarriers in the case of an eMTC system, as described above) included in the narrowband may be punched (or dropped) or rate-matched. For example, as in the above-described fifth embodiment, when the eMTC system and the NR system coexist, one remaining subcarrier due to mismatch of the PRB grid of the NR system may be punched (or dropped) or rate-matched. In this case, the specific subcarrier may be limited to that for a symbol allocated for transmission of a specific signal and/or channel (e.g., PBCH).

Further, as described above, the specific subcarrier may be determined according to a position of the narrowband DC subcarrier. For example, as illustrated in FIGS. 24 to 26, a position of the specific subcarrier, that is, one remaining subcarrier may be changed according to a position of the DC subcarrier in the narrowband of the eMTC system.

As a specific example, when the position of the DC subcarrier is mapped to that of a 0th subcarrier of a physical resource block constituting a system bandwidth of the other wireless communication system, the specific subcarrier may be a subcarrier having a last index among the plurality of subcarriers. Alternatively, when the position of the DC subcarrier is mapped to that of an 11th subcarrier of a physical resource block constituting a system bandwidth of the other wireless communication system, the specific subcarrier may be a subcarrier having a first index among the plurality of subcarriers.

Further, as described above (e.g., the fifth embodiment), when the specific subcarrier is punctured, coded bit generation and resource element mapping for the signal and the channel may be performed for all of the plurality of subcarriers (e.g., 73 subcarriers). Alternatively, when the specific subcarrier is rate-matched, coded bit generation and resource element mapping for the signal and the channel may be performed for subcarriers (e.g., 72 subcarriers) except for a specific subcarrier in the plurality of subcarriers.

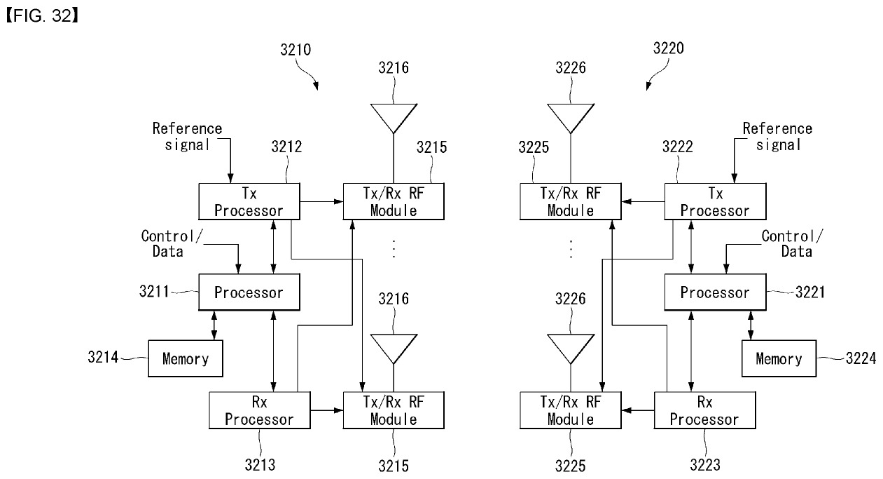

FIG. 32 illustrates another example of a block diagram of a wireless communication device to which methods proposed in the present disclosure can be applied.

Referring to FIG. 32, a wireless communication system includes a BS 3210 and a plurality of UEs 3220 positioned within a BS area. The BS may be represented as a transmitting device, and the UE may be represented as a receiving device, and vice versa. The BS and the UE include processors 3211 and 3221, memories 3214 and 3224, one or more Tx/Rx radio frequency modules (RF modules) 3215 and 3225, Tx processors 3212 and 3222, Rx processors 3213 and 3223, and antennas 3216 and 3226. The processor implements the previously described functions, processes, and/or methods. More specifically, in DL (communication from the BS to the UE), higher layer packets from a core network are provided to the processor 3211. The processor implements functions of an L2 layer. In the DL, the processor provides multiplexing between logical channels and transport channels and radio resource allocation to the UE 3220, and is responsible for signaling to the UE. The transmission (TX) processor 3212 implements various signal processing functions for an L1 layer (i.e., physical layer). The signal processing function facilitates forward error correction (FEC) in the UE, and includes coding and interleaving. The coded and modulated symbols are divided into parallel streams, each stream is mapped to an OFDM subcarrier, is multiplexed with a reference signal (RS) in the time and/or frequency domain, and is combined together using inverse fast Fourier transform (IFFT) to generate a physical channel carrying the time domain OFDMA symbol stream. The OFDM stream is spatially precoded to generate multiple spatial streams. Each spatial stream may be provided to a different antenna 3216 through a separate Tx/Rx module (or the transceiver 3215). Each Tx/Rx module may modulate an RF carrier with each spatial stream for transmission. In the UE, each Tx/Rx module (or the transceiver 3225) receives a signal through each antenna 3226 of each Tx/Rx module. Each Tx/Rx module restores information modulated by an RF carrier to provide the information to the reception (RX) processor 3223. The RX processor implements various signal processing functions of a layer 1. The RX processor may perform spatial processing in information in order to recover an arbitrary spatial stream directed to the UE. When multiple spatial streams are directed to the UE, they may be combined into a single OFDMA symbol stream by multiple RX processors. The RX processor converts the OFDMA symbol stream from a time domain to a frequency domain using Fast Fourier Transform (FFT). The frequency domain signal includes a separate OFDMA symbol stream for each subcarrier of the OFDM signal. Symbols and a reference signal on each subcarrier are restored and demodulated by determining the most probable signal disposition points transmitted by the BS. These soft decisions may be based on channel estimate values. The soft decisions are decoded and deinterleaved to restore data and control signal originally transmitted by the BS on the physical channel. Corresponding data and control signals are provided to the processor 3221.

UL (communication from the UE to BS) is handled at the BS 3210 in a manner similar to that described in relation to a receiver function at the UE 3220. Each Tx/Rx module 3225 receives a signal through each antenna 3226. Each Tx/Rx module provides an RF carrier and information to the RX processor 3223. The processor 3221 may be associated with the memory 3224 that stores program codes and data. The memory may be referred to as a computer readable medium.

FIG. 33 illustrates an AI device 3300 according to an embodiment of the present disclosure.

The AI device 3300 may be implemented into a fixed device or a movable device such as a TV, a projector, a mobile phone, a smartphone, a desktop computer, a laptop computer, a digital broadcasting UE, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 33, the UE 3300 may include a communication unit 3310, an input unit 3320, a learning processor 3330, a sensing unit 3340, an output unit 3350, a memory 3370, a processor 3380, and the like.

The communication unit 3310 may transmit and receive data to and from external devices such as other AI devices 3500a to 3500e or an AI server 3400 by using wired/wireless communication technology. For example, the communication unit 3310 may transmit and receive sensor information, a user input, a learning model, and a control signal to and from external devices.

In this case, communication technologies used by the communication unit 3310 may include Global System for Mobile communication (GSM), Code Division Multi Access (CDMA), Long Term Evolution (LTE), 5G, Wireless LAN (WLAN), and Wireless-Fidelity (Wi-Fi), Bluetooth™, Radio Frequency Identification (RFID), Infrared Data Association (IrDA), ZigBee, and Near Field Communication (NFC).

The input unit 3320 may obtain various types of data.

In this case, the input unit 3320 may include a camera for inputting an image signal, a microphone for receiving an audio signal, and a user input unit for receiving an input of information from a user. Here, by treating a camera or a microphone as a sensor, a signal obtained from the camera or the microphone may be referred to as sensing data or sensor information.

The input unit 3320 may obtain training data for training a model and input data to be used when obtaining an output by using the training model. The input unit 3320 may obtain unprocessed input data, and in this case, the processor 3380 or the learning processor 3330 may extract an input feature as preprocessing for the input data.

The learning processor 3330 may train a model configured with an ANN using the training data. Here, the learned ANN may be referred to as a learning model. The learning model may be used for inferring a result value for new input data other than the training data, and the inferred value may be used as a basis of determination for performing a certain operation.

In this case, the learning processor 3330 may perform AI processing together with a learning processor 3440 of the AI server 3400.

In this case, the learning processor 3330 may include a memory integrated or implemented in the AI device 3300. Alternatively, the learning processor 3330 may be implemented using the memory 3370, an external memory directly coupled to the AI device 3300, or a memory maintained in an external device.

The sensing unit 3340 may obtain at least one of internal information of the AI device 3300, information on a peripheral environment of the AI device 3300, and user information by using various sensors.

In this case, sensors included in the sensing unit 3340 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, lidar, radar, etc.

The output unit 3350 may generate an output related to visual, auditory, or tactile sense.

In this case, the output unit 3350 may include a display unit that outputs visual information, a speaker that outputs auditory information, a haptic module that outputs tactile information, and the like.

The memory 3370 may store data supporting various functions of the AI device 3300. For example, the memory 3370 may store input data, training data, training models, training history, and the like obtained in the input unit 3320.

The processor 3380 may determine at least one executable operation of the AI device 3300 based on information determined or generated using a data analysis algorithm or a machine learning algorithm. The processor 3380 may control the components of the AI device 3300 to perform a determined operation.

To this end, the processor 3380 may request, search for, receive, or utilize data of the learning processor 3330 or the memory 3370, and control components of the AI device 3300 to perform a predicted or desirable operation among the at least one executable operation.

In this case, when connection of an external device is required to perform the determined operation, the processor 3380 may generate a control signal for controlling the corresponding external device and transmit the generated control signal to the corresponding external device.

The processor 3380 may obtain intention information for a user input and determine a user's requirement based on the obtained intention information.

In this case, the processor 3380 may obtain intention information corresponding to the user input using at least one of a speech to text (STT) engine for converting a speech input into a character string or a natural language processing (NLP) engine for obtaining intention information of a natural language.

In this case, at least one of the STT engine and the NLP engine may be configured with an ANN at least partially trained according to a machine learning algorithm. At least one of the STT engine or the NLP engine may be learned by the learning processor 3330, learned by the learning processor 3440 of the AI server 3400, or learned by distributed processing thereof.

The processor 3380 may collect history information including an operation content or a user's feedback on an operation of the AI device 3300 to store the history information in the memory 3370 or the learning processor 3330, or transmit the history information to an external device such as the AI server 3400. The collected history information may be used for updating the learning model.

The processor 3380 may control at least some of the components of the AI device 3300 to drive an application program stored in the memory 3370. Further, in order to drive the application program, the processor 3380 may operate by combining two or more of the components included in the AI device 3300.

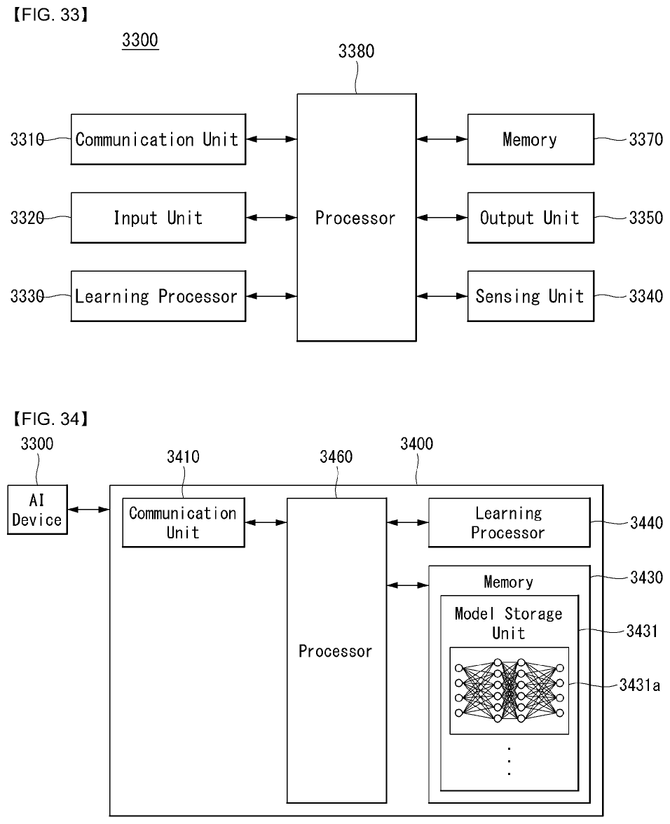

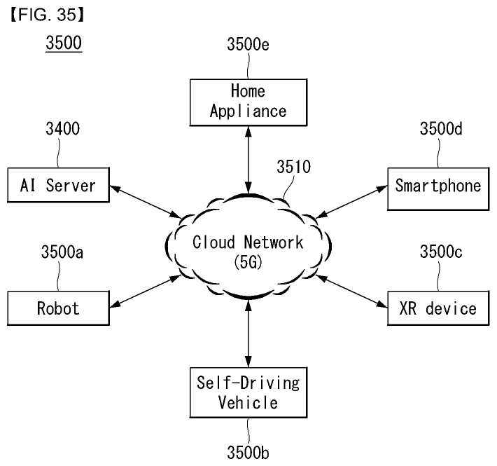

FIG. 34 illustrates an AI server 3400 according to an embodiment of the present disclosure.

Referring to FIG. 34, the AI server 3400 may refer to a device that trains an ANN using a machine learning algorithm or that uses the learned ANN. Here, the AI server 3400 may be configured with a plurality of servers to perform distributed processing, or may be defined as a 5G network. In this case, the AI server 3400 may be included as a part of the AI device 1900 to together perform at least part of AI processing.

The AI server 3400 may include a communication unit 3410, a memory 3430, a learning processor 3440, and a processor 3460.

The communication unit 3410 may transmit and receive data to and from an external device such as the AI device 3300.

The memory 3430 may include a model storage unit 3431. The model storage unit 3431 may store a model (or ANN 3431a) being trained or trained through the learning processor 3440.

The learning processor 3440 may train the ANN 3431a using training data. The learning model may be used in a state mounted in the AI server 3400 of the ANN, or may be mounted and used in an external device such as the AI device 3300.

The learning model may be implemented in hardware, software, or a combination of hardware and software. When some or all of the learning model is implemented in software, one or more instructions constituting the learning model may be stored in the memory 3430.

The processor 3460 may infer a result value for new input data using the learning model, and generate a response or a control command based on the inferred result value.

FIG. 35 illustrates an AI system 3500 according to an embodiment of the present disclosure.

Referring to FIG. 35, in the AI system 3500, at least one of an AI server 3400, a robot 3500a, a self-driving vehicle 3500b, an XR device 3500c, a smartphone 3500d, or a home appliance 3500e is connected to a cloud network 3510. Here, the robot 3500a, the self-driving vehicle 3500b, the XR device 3500c, the smartphone 3500d, or the home appliance 3500e to which AI technology is applied may be referred to as AI devices 3500a to 3500e.

The cloud network 3510 may constitute a part of a cloud computing infrastructure or may mean a network that exists in the cloud computing infrastructure. Here, the cloud network 3510 may be configured using a 3G network, a 4G or Long Term Evolution (LTE) network, or a 5G network.

That is, the devices 3500a to 3500e and 2000 constituting the AI system 3500 may be connected to each other through the cloud network 3510. In particular, the devices 3500a to 3500e and 3400 may communicate with each other through a BS, but may directly communicate with each other without through a BS.

The AI server 3400 may include a server that performs AI processing and a server that performs an operation on big data.

The AI server 3400 is connected to at least one of the robot 3500a, the self-driving vehicle 3500b, the XR device 3500c, the smart phone 3500d, or the home appliance 3500e, which are AI devices constituting the AI system 3500 through the cloud network 3510 and may help at least part of AI processing of the connected AI devices 3500a to 3500e.

In this case, the AI server 3400 may train an ANN according to a machine learning algorithm instead of the AI devices 3500a to 3500e, and may directly store the learning model or transmit the learning model to the AI devices 3500a to 3500e.

In this case, the AI server 3400 may receive input data from the AI devices 3500a to 3500e, infer a result value for the received input data using a learning model, generate a response or a control command based on the inferred result value, and transmit the response or the control command to the AI devices 3500a to 3500e.

Alternatively, the AI devices 3500a to 3500e may infer a result value of input data directly using a learning model, and generate a response or a control command based on the inferred result value.

Hereinafter, various embodiments of the AI devices 3500a to 3500e to which the above-described technology is applied will be described. Here, the AI devices 3500a to 3500e illustrated in FIG. 35 may be regarded as a specific example of the AI device 3300 illustrated in FIG. 33.

(AI+Robot)

By applying AI technology, the robot 3500a may be implemented into a guide robot, a transport robot, a cleaning robot, a wearable robot, an entertainment robot, a pet robot, an unmanned flying robot, or the like.

The robot 3500a may include a robot control module for controlling an action, and the robot control module may mean a software module or a chip in which the software module is implemented into hardware.

The robot 3500a may obtain status information of the robot 3500a using sensor information obtained from various types of sensors, detect (recognize) peripheral environments and objects, generate map data, determine a moving route and a driving plan, determine a response to a user's interaction, or determine an action.

Here, in order to determine a moving route and a driving plan, the robot 3500a may use sensor information obtained from at least one sensor of a lidar, a radar, and a camera.

The robot 3500a may perform the above actions using a learning model configured with at least one ANN. For example, the robot 3500a may recognize a peripheral environment and an object using a learning model, and determine an action using the recognized peripheral environment information or object information. Here, the learning model may be directly trained by the robot 3500a or may be trained by an external device such as the AI server 3400.

In this case, the robot 3500a may perform an action by generating a result directly using a learning model, but transmit sensor information to an external device such as the AI server 3400 and receive the result generated accordingly to perform the action.

The robot 3500a may determine a moving route and a driving plan using at least one of map data, object information detected from sensor information, or object information obtained from an external device, and control a driving unit to drive the robot 3500a according to the determined moving route and driving plan.

The map data may include object identification information on various objects disposed in a space in which the robot 3500a moves. For example, the map data may include object identification information on fixed objects such as walls and doors and movable objects such as flower pots and desks. The object identification information may include a name, a type, a distance, and a position.

Further, the robot 3500a may control a driving unit based on a user's control/interaction to perform an action or travel. In this case, the robot 3500a may obtain intention information of an interaction according to a user's motion or voice speech, and determine a response based on the obtained intention information to perform an action.

(AI+Autonomous Driving)

By applying AI technology, the self-driving vehicle 3500b may be implemented into a mobile robot, a vehicle, or an unmanned aerial vehicle.

The self-driving vehicle 3500b may include an autonomous driving control module for controlling an autonomous driving function, and the autonomous driving control module may refer to a software module or a chip in which the software module is implemented into hardware. The autonomous driving control module may be included inside as a configuration of the self-driving vehicle 3500b, but may be configured as and connected to separate hardware outside the self-driving vehicle 3500b.

The self-driving vehicle 3500b may obtain status information of the self-driving vehicle 3500b using sensor information obtained from various types of sensors, detect (recognize) peripheral environments and objects, or generate map data, determine a moving route and a driving plan, or determine an action.

Here, in order to determine a moving route and a driving plan, the self-driving vehicle 3500b may use sensor information obtained from at least one sensor of a lidar, a radar, and a camera, similar to the robot 3500a.

In particular, the self-driving vehicle 3500b may recognize an environment or object in an area where the view is obscured or an area greater than a certain distance by receiving sensor information from external devices, or receive information directly recognized from external devices.

The self-driving vehicle 3500b may perform the above operations using a learning model configured with at least one ANN. For example, the self-driving vehicle 3500b may recognize a peripheral environment and an object using a learning model, and determine a driving path using the recognized peripheral environment information or object information. Here, the learning model may be directly trained by the self-driving vehicle 3500b or may be trained by an external device such as the AI server 3400.

In this case, the self-driving vehicle 3500b may perform an operation by generating a result directly using a learning model, but it may perform an operation by transmitting sensor information to an external device such as the AI server 3400 and receiving the result generated accordingly.

The self-driving vehicle 3500b may determine a moving route and a driving plan using at least one of map data, object information detected from sensor information, or object information obtained from an external device, and control the driving unit to drive the self-driving vehicle 3500b according to the determined moving route and driving plan.

The map data may include object identification information on various objects disposed in a space (e.g., road) in which the self-driving vehicle 3500b travels. For example, the map data may include object identification information on fixed objects such as streetlights, rocks, and buildings and movable objects such as vehicles and pedestrians. The object identification information may include a name, type, distance, and position.

Further, the self-driving vehicle 3500b may control a driving unit based on a user's control/interaction to perform an operation or drive. In this case, the self-driving vehicle 3500b may obtain intention information of an interaction according to a user's action or voice speech, and determine a response based on the obtained intention information to perform the operation.

(AI+XR)

By applying AI technology, the XR device 3500c may be implemented into a Head-Mount Display (HMD), a Head-Up Display (HUD) installed in a vehicle, a television, a mobile phone, a smart phone, a computer, a wearable device, a home appliance, a digital signage, a vehicle, a fixed robot, or a mobile robot.

The XR device 3500c may analyze 3D point cloud data or image data obtained through various sensors or from an external device to generate position data and attribute data for 3D points, thereby obtaining information on peripheral spaces or real objects and rendering and outputting an XR object to be output. For example, the XR device 3500c may output an XR object including additional information on the recognized object to correspond to the recognized object.

The XR device 3500c may perform the above operations using a learning model configured with at least one ANN. For example, the XR device 3500c may recognize a real object from 3D point cloud data or image data using a learning model, and provide information corresponding to the recognized real object. Here, the learning model may be directly trained in the XR device 3500c or may be trained in an external device such as the AI server 3400.

In this case, the XR device 3500c may generate a result and perform an operation directly using a learning model, but it may transmit sensor information to an external device such as the AI server 3400 and receive the generated result to perform an operation.

(AI+Robot+Autonomous Driving)

By applying AI technology and autonomous driving technology, the robot 3500a may be implemented into a guide robot, a transport robot, a cleaning robot, a wearable robot, an entertainment robot, a pet robot, an unmanned flying robot, etc.

The robot 3500a to which AI technology and autonomous driving technology are applied may refer to a robot having an autonomous driving function or a robot 3500a that interacts with the self-driving vehicle 3500b.

The robot 3500a having an autonomous driving function may collectively refer to devices that move by themselves according to a given movement line without the user's control or that move by determining the movement line by themselves.

In order to determine one or more of a moving route or a driving plan, the robot 3500a having an autonomous driving function and the self-driving vehicle 3500b may use a common sensing method. For example, the robot 3500a having an autonomous driving function and the self-driving vehicle 3500b may determine one or more of a moving route or a driving plan using information sensed through a lidar, a radar, and a camera.

The robot 3500a interacting with the self-driving vehicle 3500b exists separately from the self-driving vehicle 3500b and may be linked to an autonomous driving function inside or outside the self-driving vehicle 3500b or may perform an operation linked to a user boarding on the self-driving vehicle 3500b.

In this case, the robot 3500a interacting with the self-driving vehicle 3500b may obtain sensor information instead of the self-driving vehicle 3500b to provide the sensor information to the self-driving vehicle 3500b, or obtain sensor information and generate information on a peripheral environment or object information to provide the information to the self-driving vehicle 3500b, thereby controlling or assisting an autonomous driving function of the self-driving vehicle 3500b.

Alternatively, the robot 3500a interacting with the self-driving vehicle 3500b may monitor a user boarding on the self-driving vehicle 3500b or control functions of the self-driving vehicle 3500b through interaction with the user. For example, when it is determined that a driver is in a drowsy state, the robot 3500a may activate an autonomous driving function of the self-driving vehicle 3500b or assist the control of a driving unit of the self-driving vehicle 3500b. Here, functions of the self-driving vehicle 3500b controlled by the robot 3500a may include not only an autonomous driving function, but also a function provided by a navigation system or an audio system provided inside the self-driving vehicle 3500b.

Alternatively, the robot 3500a interacting with the self-driving vehicle 3500b may provide information or assist a function to the self-driving vehicle 3500b from outside of the self-driving vehicle 3500b. For example, the robot 3500a may provide traffic information including signal information to the self-driving vehicle 3500b, such as a smart traffic light, or interact with the self-driving vehicle 3500b to automatically connect an electric charger to a charging port, as in an automatic electric charger for an electric vehicle.

(AI+Robot+Xr)

By applying AI technology and XR technology, the robot 3500a may be implemented into a guide robot, a transport robot, a cleaning robot, a wearable robot, an entertainment robot, a pet robot, an unmanned flying robot, a drone, etc.

The robot 3500a to which XR technology is applied may refer to a robot that is an object of control/interaction in an XR image. In this case, the robot 3500a is distinguished from the XR device 3500c and may be interlocked with each other.

When the robot 3500a, which is an object of control/interaction in the XR image, obtains sensor information from sensors including a camera, the robot 3500a or the XR device 3500c may generate an XR image based on the sensor information, and the XR device 3500c may output the generated XR image. The robot 3500a may operate based on a control signal input through the XR device 3500c or a user's interaction.

For example, the user may check an XR image corresponding to a viewpoint of the robot 3500a interlocked remotely through an external device such as the XR device 3500c, and adjust an autonomous driving path of the robot 3500a through an interaction, control a motion or driving, or check information on peripheral objects.

(AI+Autonomous Driving+XR)

By applying AI technology and XR technology, the self-driving vehicle 3500b may be implemented into a mobile robot, a vehicle, or an unmanned aerial vehicle.

The self-driving vehicle 3500b to which XR technology is applied may refer to an autonomous driving vehicle including a means for providing an XR image, or an autonomous driving vehicle that is an object of control/interaction within the XR image. In particular, the self-driving vehicle 3500b, which is an object of control/interaction in the XR image, is distinguished from the XR device 3500c and may be interlocked with each other.

The self-driving vehicle 3500b provided with a means for providing an XR image may obtain sensor information from sensors including a camera, and output an XR image generated based on the obtained sensor information. For example, the self-driving vehicle 3500b includes a HUD to output an XR image, thereby providing an XR object corresponding to a real object or an object in a screen to a passenger.

In this case, when the XR object is output to the HUD, at least a part of the XR object may be output to overlap an actual object facing an occupant's gaze. However, when the XR object is output to a display provided inside the self-driving vehicle 3500b, at least a part of the XR object may be output to overlap an object in the screen. For example, the self-driving vehicle 3500b may output XR objects corresponding to objects such as lanes, other vehicles, traffic lights, traffic signs, motorcycles, pedestrians, and buildings.

When the self-driving vehicle 3500b, which is an object of control/interaction in the XR image, obtains sensor information from sensors including a camera, the self-driving vehicle 3500b or the XR device 3500c may generate an XR image based on the sensor information, and the XR device 3500c may output the generated XR image. The self-driving vehicle 3500b may operate based on a control signal input through an external device such as the XR device 3500c or a user's interaction.

The above-described embodiments are those in which components and features of the present disclosure are combined in a predetermined form. Each component or feature should be considered optional unless explicitly stated otherwise. Each component or feature may be implemented in the form that is not combined with other components or features. Further, it is also possible to construct an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that claims that do not have an explicit citation relationship in the claims may be combined to constitute an embodiment or may be included as a new claim by amendment after filing.

The embodiment according to the present disclosure may be implemented by various means, for example, hardware, firmware, software, or a combination thereof. In the case of implementation by hardware, an embodiment of the present disclosure may be implemented by one or more application specific integrated circuits (ASICs), digital signal processors (DSPs), digital signal processing devices (DSPDs), programmable logic devices (PLDs), and field programmable gate arrays (FPGAs), processors, controllers, microcontrollers, microprocessors, etc.

In the case of implementation by firmware or software, an embodiment of the present disclosure may be implemented in the form of a module, procedure, or function that performs the above-described functions or operations. A software code may be stored in a memory to be driven by a processor. The memory may be positioned inside or outside the processor, and may exchange data with the processor through various known means.

It is obvious to a person skilled in the art that the present disclosure may be embodied in other specific forms without departing from essential features thereof. Therefore, the above detailed description should not be construed as restrictive in all respects and should be considered as illustrative. The scope of the present disclosure should be determined by reasonable interpretation of the appended claims, and all changes within the equivalent range of the present disclosure are included in the scope of the present disclosure.

### INDUSTRIAL APPLICABILITY

Although the present disclosure has been described centering on an example applied to a 3GPP LTE/LTE-A/NR system, the present disclosure may be applied to various wireless communication systems in addition to the 3GPP LTE/LTE-A/NR system.

1. A method of receiving, by a terminal, a physical downlink shared channel (PDSCH) in a wireless communication system supporting machine type communication (MTC), the method comprising:
receiving, from a base station, a synchronization signal including a primary synchronization signal and a secondary synchronization signal;
receiving, from the base station, a physical broadcast channel (PBCH);
receiving, from the base station based on the synchronization signal and the PBCH, a MTC physical downlink control channel (MPDCCH) scheduling the PDSCH in a narrowband; and
receiving, from the base station, the PDSCH in the narrowband,
wherein a specific subcarrier of a plurality of subcarriers included in the narrowband is punctured or rate-matched.

2. The method of claim 1, wherein the specific subcarrier is determined according to a position of a direct current subcarrier (DC subcarrier) of the narrowband.

3. The method of claim 2, wherein the specific subcarrier is a subcarrier having a last index among the plurality of subcarriers.

4. The method of claim 2, wherein the specific subcarrier is a subcarrier having a first index among the plurality of subcarriers.

5. The method of claim 1, wherein when the specific subcarrier is punctured, coded bit generation and resource element mapping for the channel are performed for all of the plurality of subcarriers.

6. The method of claim 1, wherein when the specific subcarrier is rate-matched, coded bit generation and resource element mapping for the channel are performed for subcarriers except for the specific subcarrier in the plurality of subcarriers.

7. The method of claim 2, wherein the narrowband is configured with 73 subcarriers comprising the DC subcarrier.

8. A device configured to receive a physical downlink shared channel (PDSCH) in a wireless communication system supporting machine type communication (MTC), the device comprising:
at least one transceiver for transmitting and receiving a radio signal; and
at least one processor for controlling the at least one transceiver,
wherein the at least one processor is configured to control to:
receive, from a base station, a synchronization signal including a primary synchronization signal and a secondary synchronization signal;
receive, from the base station, a physical broadcast channel (PBCH);
receive, from the base station based on the synchronization signal and the PBCH, a MTC physical downlink control channel (MPDCCH) scheduling the PDSCH in a narrowband; and
receive, from the base station, the PDSCH in the narrowband,
wherein a specific subcarrier of a plurality of subcarriers included in the narrowband is punctured or rate-matched.

9. The device of claim 8, wherein the specific subcarrier is determined according to a position of a direct current subcarrier (DC subcarrier) of the narrowband.

10. The device of claim 9, wherein the specific subcarrier is a subcarrier having a last index among the plurality of subcarriers.

11. The device of claim 9, wherein the specific subcarrier is a subcarrier having a first index among the plurality of subcarriers.

12. The device of claim 8, wherein when the specific subcarrier is punctured, coded bit generation and resource element mapping for the channel are performed for all of the plurality of subcarriers.

13. The device of claim 8, wherein when the specific subcarrier is rate-matched, coded bit generation and resource element mapping for the channel are performed for subcarriers except for the specific subcarrier in the plurality of subcarriers.

14. The device of claim 9, wherein the narrowband is configured with 73 subcarriers comprising the DC subcarrier.

15. A device configured to transmit, a physical downlink shared channel (PDSCH) in a wireless communication system supporting machine type communication (MTC), the device comprising:
at least one transceiver for transmitting and receiving a radio signal; and
at least one processor for controlling the at least one transceiver,
wherein the at least one processor is configured to control to:
transmit, to a terminal, a synchronization signal including a primary synchronization signal and a secondary synchronization signal;
transmit, to the terminal, a physical broadcast channel (PBCH);
transmit, to the terminal based on the synchronization signal and the PBCH, a MTC physical downlink control channel (MPDCCH) scheduling the PDSCH in a narrowband; and
transmit, to the terminal, the PDSCH in the narrowband,
wherein a specific subcarrier among a plurality of subcarriers included in the narrowband is punctured or rate-matched.

16. The method of claim 1, wherein the narrowband includes six consecutive physical resource blocks in a frequency domain.
